(19) United States
(12) Patent Application Publication
(10) Pub. No.: US 2026/0142171 A1
(43) Pub. Date: May 21, 2026

(54) SECONDARY BATTERY, ELECTRONIC DEVICE, VEHICLE, AND METHOD OF MANUFACTURING POSITIVE ELECTRODE ACTIVE MATERIAL

(71) Applicant: Semiconductor Energy Laboratory Co., Ltd., Atsugi-shi (JP)

(72) Inventors: Jo SAITO, Atsugi (JP); Yohei MOMMA, Isehara (JP); Teruaki OCHIAI, Atsugi (JP); Yusuke YOSHITANI, Isehara (JP); Kanta ABE, Atsugi (JP); Kazuki TANEMURA, Isehara (JP); Shunpei YAMAZAKI, Setagaya (JP)

(21) Appl. No.: 19/449,854

(22) Filed: Jan. 15, 2026

Related U.S. Application Data
(62) Division of application No. 18/017,893.

(30) Foreign Application Priority Data
Aug. 12, 2020 (JP) 2020-136360

(51) Int. Cl. H01M 4/525; H01M 4/02; H01M 4/04; H01M 4/505; H01M 4/62

(52) U.S. Cl. CPC H01M 4/525; H01M 4/0471; H01M 4/505; H01M 4/625; H01M 2004/021; H01M 2004/028; H01M 2220/20

(57) ABSTRACT

A positive electrode active material having a crystal structure that is unlikely to be broken by repeated charging and discharging is provided. A positive electrode active material with high charge and discharge capacity is provided. A projection is provided on the surface of the positive electrode active material. The projection preferably contains zirconium and yttrium and is a rectangular solid. The projection preferably has a crystal structure that is tetragonal, cubic, or a mixture of two phases, tetragonal and cubic. In the positive electrode active material, the transition metal is one or two or more selected from cobalt, nickel, and manganese, and the additive elements are at least two or more selected from magnesium, fluorine, aluminum, zirconium, and yttrium.

### TECHNICAL FIELD

Embodiments of the present invention relate to a secondary battery including a positive electrode active material and a manufacturing method thereof. Other embodiments of the present invention relate to an electronic device, a vehicle, and the like each including the secondary battery.

One embodiment of the present invention relates to an object, a method, or a manufacturing method. The present invention relates to a process, a machine, manufacture, or a composition of matter. One embodiment of the present invention relates to a semiconductor device, a display device, a light-emitting device, a power storage device, a lighting device, an electronic device, or a manufacturing method thereof.

Note that electronic devices in this specification mean all devices including power storage devices, and electro-optical devices including power storage devices, information terminal devices including power storage devices, and the like are all electronic devices.

Note that in this specification, a power storage device refers to every element and device having a function of storing power. For example, a power storage device (also referred to as a secondary battery) such as a lithium-ion secondary battery, a lithium-ion capacitor, and an electric double layer capacitor are included.

### BACKGROUND ART

In recent years, a variety of power storage devices such as lithium-ion secondary batteries, lithium-ion capacitors, and air batteries have been actively developed. In particular, demand for lithium-ion secondary batteries with high output and high energy density has rapidly grown with the development of the semiconductor industry, for portable information terminals such as mobile phones, smartphones, and laptop computers, portable music players, digital cameras, medical equipment, next-generation clean energy vehicles such as hybrid electric vehicles (HVs), electric vehicles (EVs), and plug-in hybrid electric vehicles (PHVs), and the like, and the lithium-ion secondary batteries are essential as rechargeable energy supply sources for today's information society.

Thus, improvement of positive electrode active materials has been studied to increase the cycle performance and the capacity of lithium-ion secondary batteries (e.g., Patent Document 1 and Non-Patent Document 1).

The performance required for a power storage device are safe operation and longer-term reliability under various environments, for example.

Meanwhile, yttria-stabilized zirconia (hereinafter referred to as YSZ in some cases), which has features such as high mechanical strength and excellent thermal stability, has been under study for some time. For example, Non-Patent Document 2 discloses a phase diagram of the system ZrO₂—Y₂O₃.

### REFERENCES

### Patent Document

[Patent Document 1] Japanese Published Patent Application No. 2018-206747

### Non-Patent Documents

[Non-Patent Document 1] Suppression of Cobalt Dissolution from the LiCoO₂ Cathodes with Various Metal-Oxide Coatings, Yong Jeong Kim et., al., Journal of The Electrochemical Society, 150 (12) A17233-A1725 (2003)
[Non-Patent Document 2] Subsolidus Phase Equilibria and Ordering in the System ZrO₂—Y₂O₃, C. Pascual and P. Duran, J. Am. Ceram. Soc., 66 [1] 23-27 (1983)
[Non-Patent Document 3] Motohashi, T. et al, “Electronic phase diagram of the layered cobalt oxide system LixCoO₂ (0.0≤x≤1.0)”, Physical Review B, 80 (16); 165114

### SUMMARY OF THE INVENTION

### Problems to be Solved by the Invention

There is room for improvements in a variety of aspects of lithium-ion secondary batteries, such as discharge capacity, charge and discharge characteristics, cycle performance, reliability, safety, and costs.

Therefore, positive electrode active materials that can improve discharge capacity, charge and discharge cycle performance, reliability, safety, cost, and the like when used in secondary batteries have been needed.

An object of one embodiment of the present invention is to provide a positive electrode active material with high discharge capacity. Another object is to provide a positive electrode active material with high discharge voltage. Another object is to provide a positive electrode active material that hardly deteriorates. Another object is to provide a secondary battery with high discharge capacity. Another object is to provide a secondary battery with high discharge voltage. Another object is to provide a highly safe or reliable secondary battery. Another object is to provide a secondary battery that hardly deteriorates. Another object is to provide a long-life secondary battery.

Another object of one embodiment of the present invention is to provide an active material, a composite oxide, a power storage device, or a manufacturing method thereof.

Note that the description of these objects does not preclude the existence of other objects. In one embodiment of the present invention, there is no need to achieve all these objects. Other objects can be derived from the description of the specification, the drawings, and the claims.

### Means for Solving the Problems

One embodiment of the present invention is a secondary battery comprising a positive electrode. The positive electrode includes a positive electrode active material and a projection on a surface of the positive electrode active material, and the shape of the projection is a part of a rectangular solid.

In the above, the projection preferably includes a crystal structure that is tetragonal, cubic, or a mixture of two phases, tetragonal and cubic.

In the above, the positive electrode active material preferably has a layered rock-salt crystal structure and includes lithium, a transition metal, oxygen, and a plurality of additive elements.

In the above, preferably, the positive electrode active material includes a surface portion and an inner portion, and the concentration of at least one of the additive elements is higher in the surface portion than in the inner portion.

In the above, preferably, the positive electrode active material includes a plurality of crystal grains and a crystal grain boundary between the plurality of crystal grains, and the concentration of at least one of the additive elements is higher in a vicinity of the crystal grain boundary than in the inner portion.

In the above, preferably, the positive electrode active material includes a crack, and the concentration of at least one of the additive elements is higher in a vicinity of the crack than in the inner portion.

In the above, preferably, the positive electrode active material includes a defect, and the concentration of at least one of the additive elements is higher in a vicinity of the defect than in the inner portion.

In the above, preferably, the transition metal is one or two or more selected from cobalt, nickel, and manganese, and the additive elements are at least two or more selected from magnesium, fluorine, aluminum, zirconium, and yttrium.

In the above, the projection preferably includes zirconium and yttrium.

In the above, preferably, the positive electrode active material includes an element A and an element B as the additive elements, and a concentration peak of the element B is located in a region deeper than a region of a concentration peak of the element A.

In the above, preferably, the transition metal includes cobalt, and the proportion of the number of cobalt atoms to the sum of the number of atoms of the transition metal included in the positive electrode active material is higher than or equal to 90 atomic %.

Another embodiment of the present invention is a secondary battery including a positive electrode. The positive electrode includes a positive electrode active material and a projection on a surface of the positive electrode active material. The positive electrode active material includes lithium, cobalt, and oxygen. The projection includes zirconium, yttrium, and oxygen, and the projection has crystallinity.

Another embodiment of the present invention is a secondary battery including a positive electrode. The positive electrode includes a positive electrode active material and a projection on a surface of the positive electrode active material. Any of the positive electrode active material and the projection includes lithium, cobalt, nickel, magnesium, aluminum, zirconium, yttrium, fluorine, and oxygen. The positive electrode active material includes a surface portion and an inner portion. Concentrations of magnesium and aluminum are higher in the surface portion than in the inner portion.

In the above, preferably, the positive electrode includes graphene or a graphene compound, and the graphene or the graphene compound is located along the surface of the positive electrode active material.

Another embodiment of the present invention is an electronic device including the above-described secondary battery.

Another embodiment of the present invention is a vehicle including the above-described secondary battery.

Another embodiment of the present invention is a method of manufacturing a positive electrode active material, which includes: a first step of forming a first composite oxide by mixing a lithium source and a cobalt source and performing first heating; a second step of forming a second composite oxide by mixing the first composite oxide, a magnesium source, and a fluorine source and performing second heating; a third step of forming a third composite oxide by mixing the second composite oxide, a nickel source, and an aluminum source and performing third heating; and a fourth step of forming a positive electrode active material by mixing the third composite oxide, a zirconium source, and an yttrium source with use of alcohol as a solvent, and performing fourth heating. Each of the second heating, the third heating, and the fourth heating is performed at a heating temperature higher than or equal to 720° C. and lower than or equal to 950° C. for longer than or equal to 2 hours and shorter than or equal to 10 hours.

In the above, each of the zirconium source and the yttrium source is preferably an alkoxide.

### Effect of the Invention

One embodiment of the present invention can provide a positive electrode active material with high discharge capacity. A positive electrode active material with high discharge voltage can be provided. A positive electrode active material that hardly deteriorates can be provided. A secondary battery with high discharge capacity can be provided. A secondary battery with high discharge voltage can be provided. A highly safe or reliable secondary battery can be provided. A secondary battery that hardly deteriorates can be provided. A long-life secondary battery can be provided.

One embodiment of the present invention can provide an active material, a composite oxide, a power storage device, or a manufacturing method thereof.

Note that effects other than these will be apparent from the description of the specification, the drawings, the claims, and the like and effects other than these can be derived from the description of the specification, the drawings, the claims, and the like.

### BRIEF DESCRIPTION OF THE DRAWINGS

FIG. 1A is a top view of a positive electrode active material, and FIG. 1B is a cross-sectional view of a positive electrode active material.

FIG. 2A to FIG. 2D are each a cross-sectional view of a positive electrode active material.

FIG. 3 is a diagram illustrating the charge depth and crystal structures of a positive electrode active material.

FIG. 4 is a diagram showing XRD patterns calculated from crystal structures.

FIG. 5 is a diagram illustrating the charge depth and crystal structures of a positive electrode active material of a comparison example.

FIG. 6 is a diagram showing XRD patterns calculated from crystal structures.

FIG. 7 is a diagram showing a method of manufacturing a positive electrode active material.

FIG. 8 is a diagram showing a method of manufacturing a positive electrode active material.

FIG. 9 is a diagram showing a method of manufacturing a positive electrode active material.

FIG. 10 is a diagram showing a method of manufacturing a positive electrode active material.

FIG. 11A to FIG. 11D are cross-sectional views showing examples of a positive electrode of a secondary battery.

FIG. 12A is an exploded perspective view of a coin-type secondary battery, FIG. 12B is a perspective view of a coin-type secondary battery, and FIG. 12C is a cross-sectional perspective view thereof.

FIG. 13A shows an example of a cylindrical secondary battery. FIG. 13B shows an example of a cylindrical secondary battery. FIG. 13C shows an example of a plurality of cylindrical secondary batteries. FIG. 13D shows an example of a power storage system including a plurality of cylindrical secondary batteries.

FIG. 14A and FIG. 14B are diagrams showing examples of a secondary battery, and FIG. 14C is a diagram illustrating the internal state of a secondary battery.

FIG. 15A to FIG. 15C are diagrams showing an example of a secondary battery.

FIG. 16A and FIG. 16B are diagrams illustrating external views of secondary batteries.

FIG. 17A to FIG. 17C are diagrams showing a method of manufacturing a secondary battery.

FIG. 18A to FIG. 18C are diagrams illustrating structure examples of a battery pack.

FIG. 19A and FIG. 19B are diagrams showing examples of a secondary battery.

FIG. 20A to FIG. 20C are diagrams showing an example of a secondary battery.

FIG. 21A and FIG. 21B are diagrams showing an example of a secondary battery.

FIG. 22A is a perspective view of a power storage device of one embodiment of the present invention, FIG. 22B is a block diagram of a power storage device, and FIG. 22C is a block diagram of a vehicle having a motor.

FIG. 23A to FIG. 23D are diagrams showing examples of transport vehicles.

FIG. 24A and FIG. 24B are diagrams illustrating a power storage device of one embodiment of the present invention.

FIG. 25A is a diagram illustrating an electric bicycle, FIG. 25B is a diagram illustrating a secondary battery of the electric bicycle, and FIG. 25C is a diagram illustrating an electric motorcycle.

FIG. 26A to FIG. 26D are diagrams showing examples of electronic devices.

FIG. 27A shows examples of wearable devices, FIG. 27B is a perspective view of a watch-type device, FIG. 27C is a diagram illustrating a side surface of a watch-type device, and FIG. 27D is a diagram showing an example of wireless earphones.

FIG. 28A to FIG. 28C show XRD patterns of composite oxides.

FIG. 29A and FIG. 29B are surface SEM images of a positive electrode active material and a projection.

FIG. 30A and FIG. 30B are surface SEM images of a positive electrode active material and a projection.

FIG. 31A and FIG. 31B are surface SEM images of a positive electrode active material and a projection.

FIG. 32A to FIG. 32C are cross-sectional STEM images of a positive electrode active material and a projection.

FIG. 33A and FIG. 33B are graphs of linear EDX analysis of a positive electrode active material and a projection.

FIG. 34A to FIG. 34H are EDX mapping images of a positive electrode active material and a projection.

FIG. 35A, FIG. 35B, and FIG. 35C are cross-sectional STEM images of a positive electrode active material and a projection.

FIG. 36A and FIG. 36B are graphs of linear EDX analysis of a positive electrode active material and a projection.

FIG. 37A to FIG. 37H are EDX mapping images of a positive electrode active material and a projection.

FIG. 38A to FIG. 38C are cross-sectional STEM images of a positive electrode active material and a projection.

FIG. 39A and FIG. 39B are graphs of linear EDX analysis of a positive electrode active material and a projection.

FIG. 40A to FIG. 40H are EDX mapping images of a positive electrode active material and a projection.

FIG. 41A shows an electron diffraction pattern of a projection, and FIG. 41B shows an electron diffraction pattern of a positive electrode active material.

FIG. 42A shows an electron diffraction pattern of a projection, and FIG. 42B shows an electron diffraction pattern of a positive electrode active material.

FIG. 43A shows an electron diffraction pattern of a projection, and FIG. 43B shows an electron diffraction pattern of a positive electrode active material.

FIG. 44A and FIG. 44B are graphs showing charge and discharge cycle performance of secondary batteries.

FIG. 45A and FIG. 45B are graphs showing charge and discharge cycle performance of secondary batteries.

### MODE FOR CARRYING OUT THE INVENTION

Embodiments of the present invention are described in detail below with reference to the drawings. Note that the present invention is not limited to the following descriptions, and it is readily understood by those skilled in the art that modes and details of the present invention can be modified in various ways. In addition, the present invention should not be construed as being limited to the descriptions of the embodiments below.

A secondary battery includes a positive electrode and a negative electrode, for example. A positive electrode active material is a material included in the positive electrode. The positive electrode active material is a material that performs a reaction contributing to the charge and discharge capacity, for example. Note that the positive electrode active material may partly include a material that does not contribute to the charge and discharge capacity.

In this specification and the like, the positive electrode active material of one embodiment of the present invention is expressed as a positive electrode material, a secondary battery positive electrode material, a composite oxide, or the like in some cases. In this specification and the like, the positive electrode active material of one embodiment of the present invention preferably contains a compound. In this specification and the like, the positive electrode active material of one embodiment of the present invention preferably contains a composition. In this specification and the like, the positive electrode active material of one embodiment of the present invention preferably contains a composite.

In this specification and the like, segregation refers to a phenomenon in which in a solid made of a plurality of elements (e.g., A, B, and C), a certain element (e.g., B) is spatially non-uniformly distributed.

In this specification and the like, a surface portion of a particle of an active material or the like refers to a region that is within 50 nm, preferably within 35 nm, further preferably within 20 nm, and most preferably within 10 nm from the surface toward the center, for example. A plane generated by a split and a crack may also be referred to as a surface. In addition, an inner portion refers to a region that is closer to the center than the surface portion. In addition, the simple term “particle” includes not only a primary particle but also a secondary particle. A secondary particle refers to a particle in which primary particles adhere or aggregate. In this case, there is no limitation on the bonding force acting between secondary particles. The bonding force may be any of covalent bonding, ionic bonding, a hydrophobic interaction, the Van der Waals force, and other molecular interactions.

In this specification, the term “crack” refers to not only a crack caused in the manufacturing process of a positive electrode active material, but also a crack caused by application of pressure, charge and discharge, and the like after the manufacturing process.

In this specification and the like, a crystal grain boundary refers to a portion where particles adhere to each other, a portion where crystal orientation changes inside a particle (including a central portion), a portion including many defects, a portion with a disordered crystal structure, or the like. The crystal grain boundary is one of plane defects. The vicinity of a crystal grain boundary refers to a region positioned within 10 nm from the crystal grain boundary. In a secondary particle, a portion between primary particles may also be referred to as a crystal grain boundary. In this specification and the like, the term “defect” refers to a crystal defect or a lattice defect. Defects include a point defect, a dislocation, a stacking fault, which is a two-dimensional defect, and a void, which is a three-dimensional defect.

In this specification and the like, particles are not necessarily spherical (with a circular cross section). Other examples of the cross-sectional shapes of particles include an ellipse, a rectangle, a trapezoid, a pyramid, a quadrilateral with rounded corners, and an asymmetrical shape, and a particle may have an indefinite shape.

In this specification and the like, a space group is represented using the short symbol of the international notation (or the Hermann-Mauguin notation). In addition, the Miller index is used for the expression of crystal planes and crystal orientations. An individual plane that shows a crystal plane is denoted by “( )”. An orientation is denoted by “[ ]”. A reciprocal lattice point is represented using a similar index without parentheses or brackets. In the crystallography, a bar is placed over a number in the expression of crystal planes, orientations, and space groups; in this specification and the like, because of application format limitations, crystal planes, orientations, and space groups are sometimes expressed by placing a minus sign (−) in front of the number instead of placing a bar over the number. Furthermore, an individual direction which shows an orientation in a crystal is denoted with “[ ]”, a set direction which shows all of the equivalent orientations is denoted with “< >”, an individual plane which shows a crystal plane is denoted with “( )”, and a set plane having equivalent symmetry is denoted with “{ }”. A trigonal system represented by the space group R-3m is generally represented by a composite hexagonal lattice for easy understanding of the structure and, in some cases, not only (hkl) but also (hkil) is used as the Miller index. Here, i is −(h+k).

Note that in this specification and the like, a layered rock-salt crystal structure of a composite oxide containing lithium and a transition metal refers to a crystal structure in which a rock-salt ion arrangement where cations and anions are alternately arranged is included and lithium and the transition metal are regularly arranged to form a two-dimensional plane, so that lithium can diffuse two-dimensionally. Note that a defect such as a cation or anion vacancy may partly exist. In the layered rock-salt crystal structure, strictly, a lattice of a rock-salt crystal is distorted in some cases.

In this specification and the like, a rock-salt crystal structure refers to a structure in which cations and anions are alternately arranged. Note that a cation or anion vacancy may exist.

Anions of a layered rock-salt crystal and anions of a rock-salt crystal have cubic closest packed structures (face-centered cubic lattice structures). Anions of an O3′ crystal described later are presumed to form a cubic close-packed structure. When the pseudo-spinel crystal is in contact with the layered rock-salt crystal and the rock-salt crystal, there is a crystal plane at which orientations of cubic closest packed structures composed of anions are aligned. Note that a space group of the layered rock-salt crystal and the O3′ type crystal is R-3m, which is different from the space group Fm-3m of a rock-salt crystal (a space group of a general rock-salt crystal) and the space group Fd-3m of a rock-salt crystal (a space group of a rock-salt crystal having the simplest symmetry); thus, the Miller index of the crystal plane satisfying the above conditions in the layered rock-salt crystal and the O3′ type crystal is different from that in the rock-salt crystal. In this specification, a state where the orientations of the cubic closest packed structures composed of anions in the layered rock-salt crystal, the O3′ type crystal, and the rock-salt crystal are aligned is referred to as a state where crystal orientations are substantially aligned in some cases.

Substantial alignment of the crystal orientations in two regions can be judged from a TEM (transmission electron microscopy) image, a STEM (scanning transmission electron microscopy) image, a HAADF-STEM (high-angle annular dark-field scanning transmission electron microscopy) image, an ABF-STEM (annular bright-field scanning transmission electron microscopy) image, or the like. X-ray diffraction (XRD), electron diffraction, neutron diffraction, and the like can also be used for judging. In the HAADF-STEM image and the like, alignment of cations and anions can be observed as repetition of bright lines and dark lines. When the orientations of cubic closest packed structures in the layered rock-salt crystal and the rock-salt crystal are aligned, a state where the angle made by the repetition of bright lines and dark lines in the layered rock-salt crystal and the rock-salt crystal is less than or equal to 5°, further preferably less than or equal to 2.5° can be observed. Note that in the TEM image and the like, a light element such as oxygen or fluorine cannot be clearly observed in some cases; however, in such a case, alignment of orientations can be judged by arrangement of metal elements.

In this specification and the like, the theoretical capacity of a positive electrode active material refers to the amount of electricity for the case where all the lithium that can be inserted and extracted in the positive electrode active material is extracted. For example, the theoretical capacity of LiCoO₂ is 274 mAh/g, the theoretical capacity of LiNiO₂ is 274 mAh/g, and the theoretical capacity of LiMn₂O₄ is 148 mAh/g.

In this specification and the like, the charge depth obtained when all the lithium that can be inserted and extracted is inserted is 0, and the charge depth obtained when all the lithium that can be inserted and extracted in a positive electrode active material is extracted is 1. A positive electrode active material with a charge depth of greater than or equal to 0.7 and less than or equal to 0.9 may be referred to as a positive electrode active material charged with high voltage. Furthermore, a positive electrode active material with a charge depth of less than or equal to 0.06 or a positive electrode active material from which more than or equal to 90% of the charge capacity is discharged from a state where the positive electrode active material is charged with high voltage is referred to as a sufficiently discharged positive electrode active material.

The discharge rate refers to the relative ratio of a current at the time of discharging to battery capacity and is expressed in a unit C. A current corresponding to 1 C in a battery with a rated capacity X (Ah) is X (A). The case where discharging is performed with a current of 2X (A) is rephrased as to perform discharging at 2 C, and the case where discharging is performed with a current of X/5 (A) is rephrased as to perform discharging at 0.2 C. The same applies to the charge rate; the case where charging is performed with a current of 2X (A) is rephrased as to perform charging at 2 C, and the case where charging is performed with a current of X/5 (A) is rephrased as to perform charging at 0.2 C.

Constant current charging refers to a charging method with a fixed charge rate, for example. Constant voltage charging refers to a charging method in which voltage is fixed when reaching the upper voltage limit, for example. Constant current discharging refers to a discharging method with a fixed discharge rate, for example.

In this specification and the like, an approximate value of a given value A refers to a value greater than or equal to 0.94 and less than or equal to 1.1A.

In this specification and the like, an example in which a lithium metal is used for a counter electrode in a secondary battery including a positive electrode and a positive electrode active material of one embodiment of the present invention is described in some cases; however, the secondary battery of one embodiment of the present invention is not limited to this example. Another material such as graphite or lithium titanate may be used as a negative electrode, for example. The properties of the positive electrode and the positive electrode active material of one embodiment of the present invention, such as a crystal structure unlikely to be broken by repeated charging and discharging and excellent charge and discharge cycle performance, are not affected by the material of the negative electrode. The secondary battery of one embodiment of the present invention using a lithium counter electrode is charged and discharged at a voltage higher than a general charge voltage of approximately 4.7 V in some cases; however, charging and discharging may be performed at a lower voltage. Charging and discharging at a lower voltage may lead to the charge and discharge cycle performance better than that described in this specification and the like.

In this specification and the like, a charge voltage and a discharge voltage are voltages in the case of using a lithium counter electrode, unless otherwise specified. Note that even when the same positive electrode is used, the charge and discharge voltages of a secondary battery vary depending on the material used for the negative electrode. For example, the potential of graphite is approximately 0.1 V (vs Li/Li⁺); hence, the charge and discharge voltages in the case of using a negative electrode of graphite are lower than those in the case of using a counter electrode of lithium by approximately 0.1 V. In this specification, even in the case where the charge voltage of a secondary battery is, for example, 4.7 V or higher, it is not necessary that only a discharge voltage of 4.7 V or higher be included as the plateau region.

### Embodiment 1

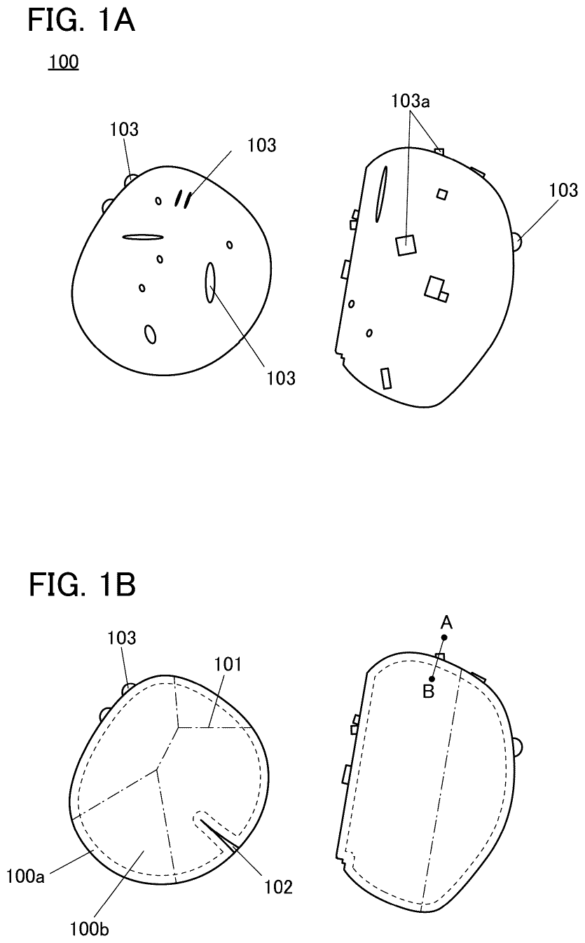

In this embodiment, a positive electrode active material of one embodiment of the present invention will be described with reference to FIG. 1 to FIG. 6.

FIG. 1A is a top view of a positive electrode active material 100 of one embodiment of the present invention. The positive electrode active material 100 preferably has a projection 103 on its surface. The projection 103 can also be regarded as a particle that is fixed or attached to the surface of the positive electrode active material 100 and thus may be referred to as a second particle. When the projection 103 is referred to as a second particle, the positive electrode active material 100 may be referred to as a first particle. A fixed state refers to a state where the projection 103 is not detached from the surface of the positive electrode active material 100 even by irradiation with ultrasonic waves, for example. The number, shape, and size of the projection are not limited to those illustrated in FIG. 1A and may be variable. The shape of the positive electrode active material 100 is not limited to that illustrated in FIG. 1A.

The projection provided on part of the surface of the positive electrode active material 100 can inhibit dissolution of a transition metal M contained in the positive electrode active material 100. Alternatively, the projection can reduce the reaction area of the positive electrode active material 100 and the electrolyte solution to inhibit decomposition of the electrolyte solution or reduction of the positive electrode active material 100. Alternatively, the projection can inhibit generation of a crack 102 in the positive electrode active material 100. These effects improve the charge and discharge cycle performance of a secondary battery using the positive electrode active material 100.

The projection 103 is preferably a composite oxide. In addition, the projection 103 does not necessarily include a lithium site that contributes to charging and discharging.

The projection 103 preferably has crystallinity. In particular, the projection 103 preferably has a crystal structure that is tetragonal, cubic, or a mixture of two phases, tetragonal and cubic. Further preferably, such a crystal structure shapes the projection 103 into a part of a rectangular solid like a projection 103a shown in FIG. 1A.

The term “rectangular solid” refers to a hexahedron whose surfaces are all rectangular. A rectangular solid includes a cube. In this specification and the like, the expression “being a part of a rectangular solid” refers to having at least one right angle. It is not necessary that, in an exactly mathematical perspective, the two segments forming the right angle be segments and the angle between the segments be 90°. As a segment, for example, a boundary with a margin of error of 5 nm or less is observed over a range of 50 nm or larger in a microscope image such as a surface SEM image or a cross-sectional SEM image. In a similar microscope image, the angle between the segments is greater than or equal to 85° and less than or equal to 95°. Such a shape is referred to as a substantially rectangular solid in some cases.

FIG. 1B is a cross-sectional view of the positive electrode active material 100. The positive electrode active material 100 includes an inner portion 100b and a surface portion 100a. In the drawing, the dashed line represents a boundary between the inner portion 100b and the surface portion 100a. The positive electrode active material 100 may include a plurality of crystal grains and may include a crystal grain boundary 101 between the crystal grains. In FIG. 1B, the dashed-dotted line represents a part of the crystal grain boundary 101.

### <Contained Element>

The positive electrode active material 100 contains lithium, the transition metal M, oxygen, and a plurality of additive elements. The projection 103 preferably contains oxygen and at least one of the plurality of additive elements common to that in the positive electrode active material 100. In other words, one or more of the additive elements contained in the positive electrode active material 100 is preferably common to an element contained in the projection 103.

The positive electrode active material 100 is synonymous with a material obtained by addition of a plurality of additive elements to a composite oxide represented by LiMO₂. Note that the composition is not strictly limited to Li:M:O=1:1:2 as long as the positive electrode active material 100 of one embodiment of the present invention has a crystal structure of a lithium composite oxide represented by LiMO₂.

As the transition metal M contained in the positive electrode active material 100, a metal which together with lithium can form a layered rock-salt composite oxide that belongs to the space group R-3m is preferably used. As the transition metal M, one or two or more selected from manganese, cobalt, and nickel can be used, for example. That is, as the transition metal M contained in the positive electrode active material 100, cobalt may be used alone, nickel may be used alone, cobalt and manganese may be used, cobalt and nickel may be used, or cobalt, manganese, and nickel may be used. In other words, the positive electrode active material 100 can contain a composite oxide containing lithium and the transition metal M, such as lithium cobalt oxide, lithium nickel oxide, lithium cobalt oxide in which manganese is substituted for part of cobalt, lithium cobalt oxide in which nickel is substituted for part of cobalt, or lithium nickel-manganese-cobalt oxide.

Using cobalt at greater than or equal to 75 atomic %, preferably greater than or equal to 90 atomic %, further preferably greater than or equal to 95 atomic % as the transition metal M contained in the positive electrode active material 100 brings many advantages such as relatively easy synthesis, easy handling, and excellent charge and discharge cycle performance.

When nickel is contained as part of the metal M in addition to cobalt, a shift in a layered structure formed of octahedrons of cobalt and oxygen is sometimes inhibited. This is preferable because the crystal structure becomes more stable particularly in a charged state at a high temperature in some cases. This is probably because nickel is easily diffused into the inside of lithium cobalt oxide, and can be located in lithium sites due to cation mixing at charging while existing in cobalt sites at discharging. Nickel existing in lithium sites at charging functions as a column that supports the layered structure formed of octahedrons of cobalt and oxygen, and contributes to stabilization of the crystal structure.

Note that manganese is not necessarily contained as the transition metal M. In addition, nickel is not necessarily contained.

As the additive elements, one or two or more selected from magnesium, fluorine, aluminum, zirconium, yttrium, titanium, vanadium, iron, chromium, niobium, lanthanum, yttrium, hafnium, zinc, silicon, sulfur, phosphorus, boron, and arsenic are preferably used, and two or more of the elements are further preferably used. Note that these additive elements may be present only in the positive electrode active material 100, only in the projection 103, or in both of them.

The projection 103 preferably contains zirconium and yttrium. In particular, the proportion of the number of yttrium atoms to the sum of the number of zirconium and yttrium atoms is preferably within the range such that the crystal structure is tetragonal or cubic at a temperature higher than or equal to 720° C. and lower than or equal to 950° C. in the phase diagram of the system ZrO₂—Y₂O₃ (Non-Patent Document 2). Specifically, the proportion of the number of yttrium atoms to the sum of the number of zirconium and yttrium atoms is preferably as follows: when Y/(Zr+Y)×100=x, 3.9≤x<57.1. In particular, the proportion of the number of yttrium atoms to the sum of the number of zirconium and yttrium atoms is preferably within the range such that the crystal structure is tetragonal at a temperature higher than or equal to 720° C. and lower than or equal to 950° C. Specifically, preferably, 3.9≤x<14.5 when Y/(Zr+Y)×100=x.

In particular, addition of phosphorus to the positive electrode active material 100 is preferable because the continuous charge tolerance can be improved and thus a highly safe secondary battery can be provided.

In some cases, manganese, titanium, vanadium, and chromium in the positive electrode active material 100 are likely to have a valence of four stably and thus contribute highly to a stable structure.

Such additive elements further stabilize the crystal structure of the positive electrode active material 100 in some cases as described later. In other words, the positive electrode active material 100 can contain lithium cobalt oxide to which zirconium and yttrium are added, lithium cobalt oxide to which zirconium, yttrium, magnesium, and fluorine are added, lithium cobalt oxide to which magnesium and fluorine are added, lithium nickel-cobalt oxide to which magnesium and fluorine are added, lithium cobalt-aluminum oxide to which magnesium and fluorine are added, lithium nickel-cobalt-aluminum oxide, lithium nickel-cobalt-aluminum oxide to which magnesium and fluorine are added, lithium nickel-manganese-cobalt oxide to which magnesium and fluorine are added, or the like. Note that in this specification and the like, the additive element may be rephrased as an additive, a mixture, a constituent of a material, an impurity, or the like. The additive element in the positive electrode active material 100 is preferably added at a concentration that does not largely change the crystallinity of the composite oxide represented by LiMO₂. For example, the additive element is preferably added at an amount that does not cause the Jahn-Teller effect described later.

Note that the positive electrode active material 100 does not necessarily contain all of magnesium, fluorine, aluminum, zirconium, yttrium, titanium, vanadium, iron, chromium, niobium, lanthanum, yttrium, hafnium, zinc, silicon, sulfur, phosphorus, boron, and arsenic as the additive elements.

### <Element Distribution>

Preferably, at least one of the additive elements is unevenly distributed in the projection 103. Preferably, zirconium and yttrium, in particular, are unevenly distributed in the projection 103. When zirconium and yttrium are unevenly distributed in the projection 103 and the ratio between the numbers of atoms is in the range where Y/(Zr+Y)×100=x (3.9≤x<57.1), further preferably Y/(Zr+Y)×100=x (3.9≤x<14.5), as described above, the projection 103 is likely to have a crystal structure that is tetragonal, cubic, or a mixture of two phases, tetragonal and cubic. Yttria-stabilized zirconium with tetragonal crystal is known for its high intensity and high strength owing to the crystal structure. Therefore, when the projection 103 has a crystal structure that is tetragonal, cubic, or a mixture of two phases, tetragonal and cubic, it shows the effect of inhibiting the development of a crack on the surface of the positive electrode active material 100. This can contribute to an improvement of the charge and discharge cycle performance of the positive electrode active material 100.

Here, preferably, the projection 103 further contains aluminum, in which case the strength of the projection 103 might be increased.

At least one of the additive elements in the positive electrode active material 100 preferably has a concentration gradient. For example, the concentration of the additive element is preferably higher in the surface portion 100a than in the inner portion 100b. In this case, the peak position of the concentration preferably differs between the additive elements.

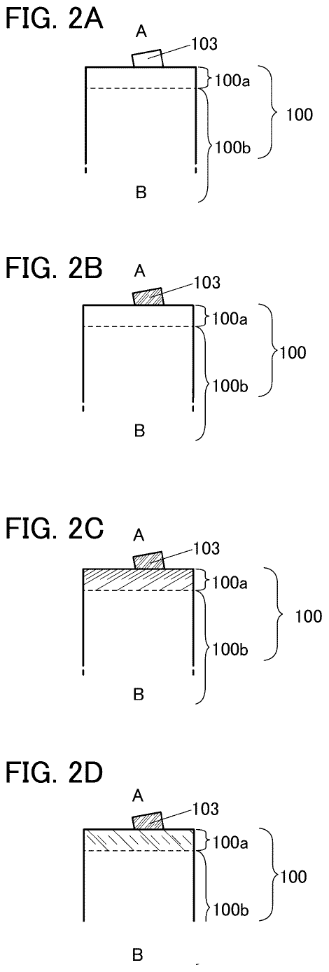

FIG. 2A shows an enlarged view of the portion near A-B in FIG. 1B. FIG. 2B to FIG. 2D are diagrams each illustrating the distribution of different elements in the area that is the same as that in FIG. 2A. In FIG. 2B to FIG. 2D, the dark hatching means a high concentration of a certain element, and the light hatching means a low concentration of the element.

For example, preferably, a certain additive element is unevenly distributed in the projection 103, as illustrated in FIG. 2B. Examples of the additive element that is preferably distributed as above include zirconium and yttrium.

Preferably, an additive element A, which is a different additive element, is unevenly distributed in the projection 103 and the surface portion 100a, as illustrated in FIG. 2C. Examples of the additive element A that preferably has such a concentration gradient increasing from the inner portion 100b toward the surface include magnesium, fluorine, and titanium.

Preferably, an additive element B, which is a further different additive element, is unevenly distributed in the projection 103 and the surface portion 100a, as illustrated in FIG. 2D. In the positive electrode active material 100, the concentration peak of the additive element B is preferably in a region closer to the inner portion 100b than the region of the concentration peak of the additive element A of FIG. 2C. An example of the additive element B that is preferably distributed as above is aluminum. The concentration peak may be located in the surface portion or located deeper than the surface portion. For example, the concentration peak is preferably located in a region that is 5 nm to 30 nm inclusive in depth from the surface.

Note that the positive electrode active material 100 of one embodiment of the present invention is not limited to the above. An additive element that is not distributed in the projection 103 may be included. An additive element that does not have a concentration gradient may be included.

Note that the transition metal M, especially cobalt and nickel, is preferably dissolved uniformly in the entire positive electrode active material 100. In the case where the concentration of a kind of transition metal M, e.g., nickel, is low, the concentration is sometimes lower than or equal to the lower detection limit of the analysis of X-ray photoelectron spectroscopy (XPS), energy dispersive X-ray spectroscopy (EDX), or the like.

For example, when the proportion of the number of nickel atoms to the number of cobalt atoms is lower than or equal to 2% (Ni/Co×100≤2), nickel in a lithium composite oxide accounts for lower than or equal to 0.5 atomic %. The lower detection limit of XPS and EDX is approximately 1 atomic %. In that case, when nickel is dissolved uniformly in the entire positive electrode active material 100, the concentration can be below the detection limit of the analyzing method such as XPS or EDX. In this case, the concentration below the detection limit indicate that the nickel concentration is lower than or equal to 1 atomic % or that nickel is dissolved in the entire positive electrode active material 100.

Meanwhile, even when the nickel concentration is lower than or equal to 1 atomic %, nickel can be quantified by inductively coupled plasma mass spectrometry (ICP-MS), glow discharge mass spectrometry (GDMS), or the like.

Note that a kind of the metal M, e.g., manganese, included in the positive electrode active material 100 may have a concentration gradient in which the concentration increases from the inner portion 100b to the surface.

### <Crystal Structure>

A material with a layered rock-salt crystal structure, such as lithium cobalt oxide (LiCoO₂), is known to have a high discharge capacity and excel as a positive electrode active material of a secondary battery.

It is known that the Jahn-Teller effect in a transition metal compound varies in degree according to the number of electrons in the d orbital of the transition metal.

In a compound containing nickel, distortion is likely to be caused because of the Jahn-Teller effect in some cases. Accordingly, when charging and discharging with high voltage are performed on LiNiO₂, the crystal structure might be broken because of the distortion. The influence of the Jahn-Teller effect is suggested to be small in LiCoO₂; hence, LiCoO₂ is preferable because the tolerance at the time of high voltage charging is higher in some cases.

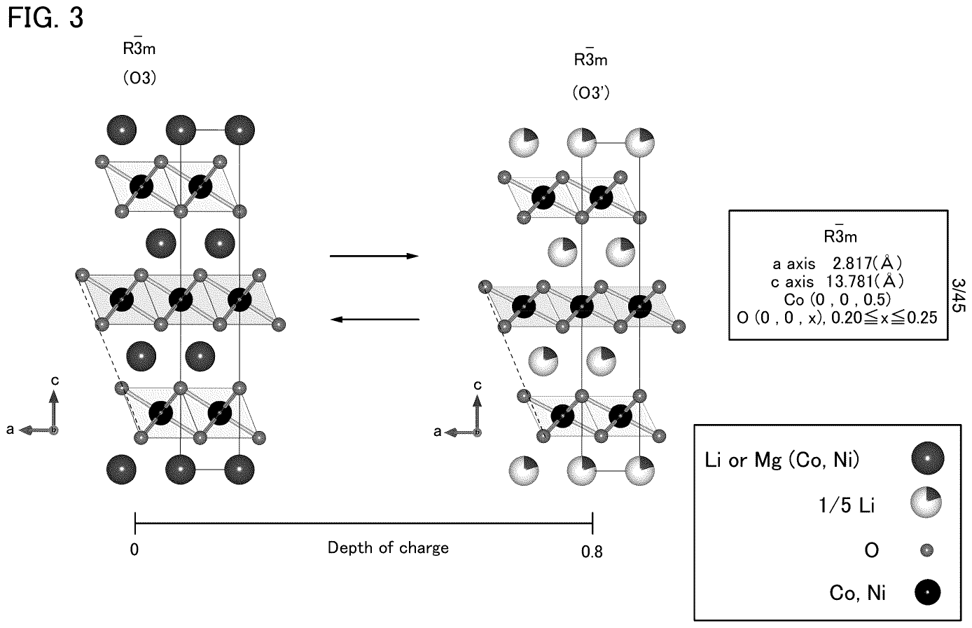

Positive electrode active materials are described with reference to FIG. 3 to FIG. 6. In FIG. 3 to FIG. 6, the case where cobalt is used as the transition metal M contained in the positive electrode active material is described.

### <Conventional Positive Electrode Active Material>

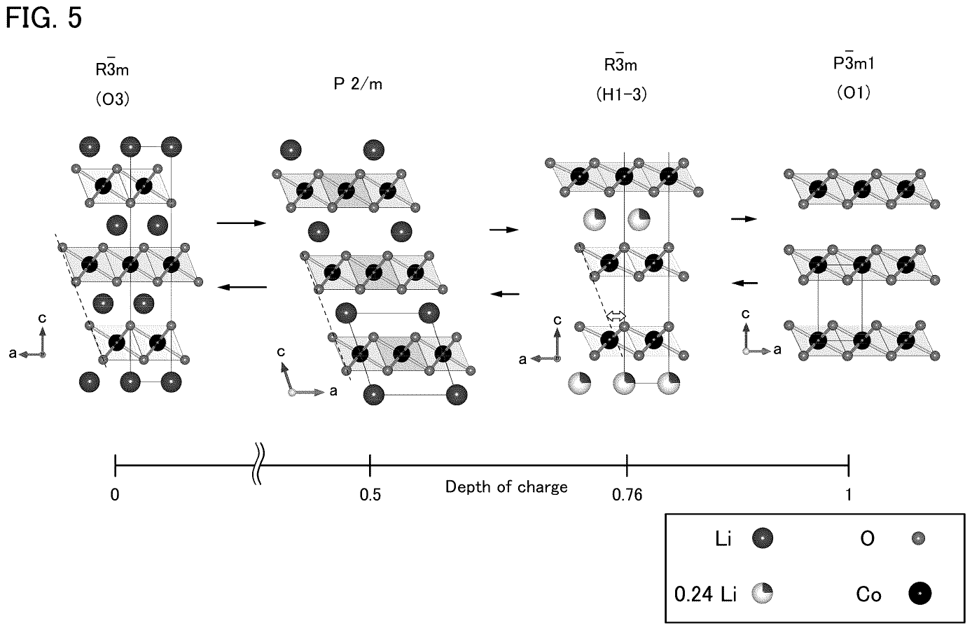

A positive electrode active material shown in FIG. 5 is lithium cobalt oxide (LiCoO₂) to which fluorine and magnesium are not added in a formation method described later. The crystal structure of the lithium cobalt oxide shown in FIG. 5 changes with the charge depth.

As shown in FIG. 5, in lithium cobalt oxide with a charge depth of 0 (discharged state), there is a region having a crystal structure belonging to the space group R-3m, and a unit cell includes three CoO₂ layers. Thus, this crystal structure is referred to as an O3 type crystal structure in some cases. Note that here, the CoO₂ layer has a structure in which an octahedral structure with cobalt coordinated to six oxygen atoms continues on a plane in an edge-shared state.

Lithium cobalt oxide with a charge depth of 1 has the crystal structure belonging to the space group P-3 ml and includes one CoO₂ layer in a unit cell. Hence, this crystal structure is referred to as an O1 type crystal structure in some cases.

Lithium cobalt oxide with a charge depth of approximately 0.88 has the crystal structure belonging to the space group R-3m. This structure can also be regarded as a structure in which CoO₂ structures such as a structure belonging to P-3 ml (O1) and LiCoO₂ structures such as a structure belonging to R-3m (O3) are alternately stacked. Thus, this crystal structure is referred to as an H1-3 type crystal structure in some cases. Note that the number of cobalt atoms per unit cell in the actual H1-3 type crystal structure is twice that in other structures. However, in this specification, FIG. 5, and other drawings, the c-axis of the H1-3 type crystal structure is half that of the unit cell for easy comparison with the other structures.

For the H1-3 type crystal structure, as disclosed in Non-Patent Document 3, the coordinates of cobalt and oxygen in the unit cell can be expressed as follows, for example: Co (0, 0, 0.42150±0.00016), O1 (0, 0, 0.27671±0.00045), and O2 (0, 0, 0.11535±0.00045). Note that O1 and O2 are each an oxygen atom. In this manner, the H1-3 type crystal structure is represented by a unit cell including one cobalt atom and two oxygen atoms. Meanwhile, the O3′ type crystal structure of embodiments of the present invention are preferably represented by a unit cell including one cobalt atom and one oxygen atom, as described later. This means that the symmetry of cobalt and oxygen differs between the O3′ structure and the H1-3 type structure, and the amount of change from the O3 structure is smaller in the O3′ structure than in the H1-3 type structure. A preferred unit cell for representing a crystal structure in a positive electrode active material can be selected by Rietveld analysis of XRD, for example. In this case, a unit cell is selected such that the value of GOF (goodness of fit) is small.

When charging at a high charge voltage of 4.6 V or more with reference to the redox potential of a lithium metal or charging with a large charge depth of 0.8 or more and discharging are repeated, the crystal structure of lithium cobalt oxide changes (i.e., an unbalanced phase change occurs) repeatedly between the H1-3 type crystal structure and the structure belonging to R-3m (O3) in a discharged state.

However, there is a large shift in the CoO₂ layers between these two crystal structures. As denoted by the dotted lines and the arrow in FIG. 5, the CoO₂ layer in the H1-3 type crystal structure largely shifts from R-3m (O3). Such a dynamic structural change can adversely affect the stability of the crystal structure.

A difference in volume is also large. The H1-3 type crystal structure and the O3 type crystal structure in a discharged state that contain the same number of cobalt atoms have a difference in volume of 3.0% or more.

In addition, a structure in which CoO₂ layers are arranged continuously, such as P-3 ml (O1), included in the H1-3 type crystal structure is highly likely to be unstable.

Accordingly, the repeated charging and discharging with high voltage gradually break the crystal structure of lithium cobalt oxide. The broken crystal structure triggers deterioration of the charge and discharge cycle performance. This is because the broken crystal structure has a smaller number of sites where lithium can exist stably and makes it difficult to insert and extract lithium.

### <Positive Electrode Active Material of One Embodiment of the Present Invention>

In the positive electrode active material 100 of one embodiment of the present invention, the shift in CoO₂ layers can be small in repeated charging and discharging with high voltage. Furthermore, the change in the volume can be small. Accordingly, the positive electrode active material of one embodiment of the present invention can achieve excellent charge and discharge cycle performance. In addition, the positive electrode active material of one embodiment of the present invention can have a stable crystal structure in a high voltage charged state. Thus, in the positive electrode active material of one embodiment of the present invention, a short circuit is unlikely to occur while the high voltage charged state is maintained, in some cases. This is preferable because the safety is further improved.

The positive electrode active material of one embodiment of the present invention has a small crystal-structure change and a small volume difference per the same number of atoms of the transition metal between a sufficiently discharged state and a high-voltage charged state.

FIG. 3 illustrates the crystal structures of the positive electrode active material 100 before and after being charged and discharged. The positive electrode active material 100 is a composite oxide containing lithium, cobalt as the transition metal M, and oxygen. In addition to the above, the positive electrode active material 100 preferably contains magnesium as an additive element. Furthermore, fluorine is preferably contained.

The crystal structure with a charge depth of 0 (in the discharged state) in FIG. 3 is R-3m (O3) as in FIG. 5. Meanwhile, the inner portion 100b of the positive electrode active material 100 with a charge depth in a sufficiently charged state includes a crystal whose structure is different from the H1-3 type crystal structure. This structure belongs to the space group R-3m and is a structure in which an ion of cobalt, magnesium, or the like occupies a site coordinated to six oxygen atoms. Furthermore, the symmetry of CoO₂ layers of this structure is the same as that in the O3 type structure. This structure is thus referred to as the O3′ type crystal structure in this specification and the like. Although a chance of the existence of lithium is the same in all lithium sites in FIG. 3, the positive electrode active material of one embodiment of the present invention is not limited thereto. Lithium may exist unevenly in only some of the lithium sites. For example, lithium may exist in some lithium sites that are aligned, as in Li_{0.5}CoO₂ belonging to the space group P2/m. Distribution of lithium can be analyzed by neutron diffraction, for example. In both the O3 type crystal structure and the O3′ type crystal structure, a slight amount of magnesium preferably exists between the CoO₂ layers, i.e., in lithium sites. In addition, a slight amount of fluorine preferably exists at random in oxygen sites.

Note that in the O3′ type crystal structure, a light element such as lithium sometimes occupies a site coordinated to four oxygen atoms.

The O3′ type crystal structure can be regarded as a crystal structure that contains Li between layers randomly and is similar to a CdCl₂ type crystal structure. The crystal structure similar to the CdCl₂ type crystal structure is close to a crystal structure of lithium nickel oxide (Li_{0.06}NiO₂) charged to a charge depth of 0.94; however, pure lithium cobalt oxide or a layered rock-salt positive electrode active material containing a large amount of cobalt is known not to have such a crystal structure generally.

In the positive electrode active material 100 of one embodiment of the present invention, a change in the crystal structure caused when a large amount of lithium is extracted by charging with high voltage is smaller than that in a conventional positive electrode active material. As denoted by the dotted lines in FIG. 3, for example, the CoO₂ layers hardly shift between the crystal structures.

Specifically, the crystal structure of the positive electrode active material 100 of one embodiment of the present invention is highly stable even when charge voltage is high. For example, at a charge voltage that makes a conventional positive electrode active material have the H1-3 type crystal structure, for example, at a voltage of approximately 4.6 V with reference to the potential of a lithium metal, the crystal structure belonging to R-3m (O3) can be maintained. Moreover, in a higher charge voltage range, for example, at voltages of approximately 4.65 V to 4.7 V with reference to the potential of a lithium metal, the O3′ type crystal structure can be obtained. At a much higher charge voltage, a H1-3 type crystal is eventually observed in some cases. Note that in the case where graphite, for instance, is used as a negative electrode active material in a secondary battery, a charge voltage region where the R-3m (O3) crystal structure can be maintained exists when the voltage of the secondary battery is, for example, higher than or equal to 4.3 V and lower than or equal to 4.5 V; in a higher charge voltage region, for example, at a voltage higher than or equal to 4.35 V and lower than or equal to 4.55 V with reference to the potential of a lithium metal, there is a region within which the O3′ type crystal structure can be obtained.

Thus, in the positive electrode active material 100 of one embodiment of the present invention, the crystal structure is unlikely to be broken even when charging and discharging with high voltage are repeated.

Note that in the unit cell of the O3′ type crystal structure, the coordinates of cobalt and oxygen can be represented by Co (0, 0, 0.5) and O (0, 0, x) within the range of 0.20≤x≤0.25.

A slight amount of the additive element such as magnesium randomly existing between the CoO₂ layers, i.e., in lithium sites, can suppress a shift in the CoO₂ layers at the time of charging with high voltage. Thus, magnesium between the CoO₂ layers makes it easier to obtain the O3′ type crystal structure. For this reason, magnesium is preferably distributed throughout the positive electrode active material 100 of one embodiment of the present invention (i.e., the surface portion 100a and the inner portion 100b) at an appropriate concentration. To distribute magnesium throughout the whole, heat treatment is preferably performed in the formation process of the positive electrode active material 100 of one embodiment of the present invention.

However, heat treatment at an excessively high temperature may cause cation mixing, which increases the possibility of entry of the additive element such as magnesium into the cobalt sites. Magnesium in the cobalt sites does not have the effect of maintaining the structure belonging to R-3m at the time of charging with high voltage. Furthermore, heat treatment at an excessively high temperature might have an adverse effect; for example, cobalt might be reduced to have a valence of two or lithium might be evaporated.

In view of the above, a fluorine compound such as a halogen compound is preferably added to lithium cobalt oxide before the heat treatment for distributing magnesium throughout the whole. The addition of the halogen compound decreases the melting point of lithium cobalt oxide. The decreased melting point makes it easier to distribute magnesium throughout the particle at a temperature at which the cation mixing is unlikely to occur. Furthermore, the fluorine compound probably increases corrosion resistance to hydrofluoric acid generated by decomposition of an electrolyte solution.

When the magnesium concentration is higher than or equal to a desired value, the effect of stabilizing a crystal structure becomes small in some cases. This is probably because magnesium enters the cobalt sites in addition to the lithium sites. The proportion of magnesium to the sum of the transition metal M (Mg/Co) in the positive electrode active material 100 of one embodiment of the present invention is preferably higher than or equal to 0.25% and lower than or equal to 5%, further preferably higher than or equal to 0.5% and lower than or equal to 2%, still further preferably approximately 1%. The magnesium concentration described here may be a value obtained by element analysis on the whole particles of the positive electrode active material using ICP-MS or the like, or may be a value based on the ratio of the raw materials mixed in the process of forming the positive electrode active material, for example.

As shown in introductory remarks in FIG. 3, aluminum and the transition metal typified by nickel and manganese preferably exist in cobalt sites, but part of them may exist in lithium sites. Magnesium preferably exists in lithium sites. Fluorine may be substituted for part of oxygen.

As the magnesium concentration in the positive electrode active material 100 of one embodiment of the present invention increases, the charge and discharge capacity of the positive electrode active material 100 decreases in some cases. As an example, one possible reason is that the amount of lithium that contributes to charging and discharging decreases when magnesium enters the lithium sites. Another possible reason is that excess magnesium generates a magnesium compound that does not contribute to charging and discharging. When the positive electrode active material 100 of one embodiment of the present invention contains nickel, the crystal structure is stabilized even with an increased charge and discharge voltage and the charge and discharge capacity per weight and per volume can be increased in some cases. When the positive electrode active material 100 of one embodiment of the present invention contains aluminum, the crystal structure is stabilized even with an increased charge and discharge voltage and the charge and discharge capacity per weight and per volume can be increased in some cases. When the positive electrode active material 100 of one embodiment of the present invention contains nickel and aluminum, the crystal structure is stabilized even with an increased charge and discharge voltage and the charge and discharge capacity per weight and per volume can be increased in some cases.

The concentrations of the nickel and aluminum elements contained in the positive electrode active material 100 of one embodiment of the present invention are described below using the number of atoms.

The proportion of nickel to cobalt (Ni/Co×100) in the positive electrode active material 100 of one embodiment of the present invention is preferably higher than 0% and lower than or equal to 7.5%, further preferably higher than or equal to 0.05% and lower than or equal to 4%, still further preferably higher than or equal to 0.1% and lower than or equal to 2%. Alternatively, it is preferably higher than 0% and lower than or equal to 4%. Alternatively, it is preferably higher than 0% and lower than or equal to 2%. Alternatively, it is preferably higher than or equal to 0.05% and lower than or equal to 7.5%. Alternatively, it is preferably higher than or equal to 0.05% and lower than or equal to 2%. Alternatively, it is preferably higher than or equal to 0.1% and lower than or equal to 7.5%. Alternatively, it is preferably higher than or equal to 0.1% and lower than or equal to 4%. The nickel concentration described here may be a value obtained by element analysis on the entire particle of the positive electrode active material using ICP-MS or the like, or may be a value based on the ratio of the raw materials mixed in the forming process of the positive electrode active material, for example.

When the number of cobalt atoms is regarded as 100%, the proportion of aluminum to cobalt (Al/Co×100) in the positive electrode active material of one embodiment of the present invention is preferably higher than or equal to 0.05% and lower than or equal to 4%, further preferably higher than or equal to 0.1% and lower than or equal to 2% of the number of cobalt atoms. Alternatively, it is preferably higher than or equal to 0.05% and lower than or equal to 2%. Alternatively, it is preferably higher than or equal to 0.1% and lower than or equal to 4%. The aluminum concentration described here may be a value obtained by element analysis on the entire particle of the positive electrode active material using ICP-MS or the like, or may be a value based on the ratio of the raw materials mixed in the forming process of the positive electrode active material, for example.

Magnesium is preferably distributed throughout the positive electrode active material 100 of one embodiment of the present invention (i.e., the surface portion 100a and the inner portion 100b), and in addition to this, the concentration of the additive element in the surface portion 100a are preferably higher than the average in the whole particle as described above. More specifically, the concentration of the additive element in the surface portion 100a measured by XPS or the like are preferably higher than the average concentration of the additive element in the whole particle measured by ICP-MS or the like.

It is further preferable that at least one additive element contained in the positive electrode active material 100 of one embodiment of the present invention be segregated in the vicinity of the crystal grain boundary 101.

In other words, the concentration of the additive element at the crystal grain boundary 101 and the vicinity thereof in the positive electrode active material 100 of one embodiment of the present invention are preferably higher than those in the other regions in the inner portion.

The crystal grain boundary 101 is a plane defect, and thus tends to be unstable and suffer a change in the crystal structure like the surface of the particle. Thus, the higher the concentration of the additive element at the crystal grain boundary 101 and the vicinity thereof are, the more effectively the change in the crystal structure can be reduced.

When the concentration of the additive element are high at the crystal grain boundary and the vicinity thereof, the concentration of the additive element in the vicinity of a surface generated by a crack 102 are also high even when the crack 102 is generated along the crystal grain boundary 101 of the particle of the positive electrode active material 100 of one embodiment of the present invention. Thus, the positive electrode active material can have an increased corrosion resistance to hydrofluoric acid even after the crack 102 is generated.

In other words, the concentration of the additive element in the vicinity of the crack 102 is preferably higher than that in the inner portion in the positive electrode active material 100 of one embodiment of the present invention. It is not necessary that the concentration of the additive element in every crack 102 be higher than that in the inner portion.

### <<Particle Diameter>>

When the particle diameter of the positive electrode active material 100 of one embodiment of the present invention is too large, there are problems such as difficulty in lithium diffusion and large surface roughness of an active material layer at the time when the material is applied to a current collector. By contrast, too small a particle diameter causes problems such as difficulty in loading of the active material layer at the time when the material is applied to the current collector and overreaction with the electrolyte solution. Therefore, an average particle diameter (D50, also referred to as median diameter) obtained with a particle size distribution analyzer using a laser diffraction and scattering method is preferably greater than or equal to 1 μm and less than or equal to 100 μm, further preferably greater than or equal to 2 μm and less than or equal to 40 μm, still further preferably greater than or equal to 5 μm and less than or equal to 30 μm. Alternatively, the median diameter (D50) is preferably greater than or equal to 1 μm and less than or equal to 40 μm, greater than or equal to 1 μm and less than or equal to 30 μm, greater than or equal to 2 μm and less than or equal to 100 μm, greater than or equal to 2 μm and less than or equal to 30 μm, greater than or equal to 5 μm and less than or equal to 100 μm, or greater than or equal to 5 μm and less than or equal to 40 μm.

Alternatively, the positive electrode active materials 100 having two or more different particle diameters may be mixed and used. In other words, the positive electrode active materials which have a plurality of peaks when the particle size distribution is measured by a laser diffraction and scattering method may be used. At this time, the mixing ratio is preferably set such that the powder packing density becomes large, in which case the capacity per volume of the secondary battery can be improved.

### <Analysis Method>

Whether or not a given positive electrode active material is the positive electrode active material 100 of one embodiment of the present invention, which has the O3′ type crystal structure at the time of high voltage charging, can be judged by analyzing a positive electrode charged with high voltage by XRD, electron diffraction, neutron diffraction, electron spin resonance (ESR), nuclear magnetic resonance (NMR), or the like. XRD is particularly preferable because the symmetry of a transition metal such as cobalt contained in the positive electrode active material can be analyzed with high resolution, the degrees of crystallinity and the crystal orientations can be compared, the distortion of lattice periodicity and the crystallite size can be analyzed, and a positive electrode itself obtained by disassembling a secondary battery can be measured with sufficient accuracy, for example.

As described above, the positive electrode active material 100 of one embodiment of the present invention features in a small change in the crystal structure between a high voltage charged state and a discharged state. A material where 50 wt % or more of the crystal structure largely changes between the high-voltage charged state and the discharged state is not preferable because the material cannot withstand the high-voltage charging and discharging. It should be noted that the intended crystal structure is not obtained in some cases only by addition of the additive element. For example, in a high voltage charged state, some lithium cobalt oxides containing magnesium and fluorine have an area intensity I_{H1-3} of H1-3 type exceeding 70% and other lithium cobalt oxides containing magnesium and fluorine have an area intensity I_{H1-3} not exceeding 70%. In some cases, lithium cobalt oxide containing magnesium and fluorine may have the O3′ type crystal structure at almost 100 wt % at a predetermined voltage, and increasing the voltage to be higher than the predetermined voltage may cause the H1-3 type crystal structure. Thus, to determine whether or not a positive electrode active material is the positive electrode active material 100 of one embodiment of the present invention, the crystal structure should be analyzed by XRD or other methods.

However, the crystal structure of a positive electrode active material in a high voltage charged state or a discharged state may be changed with exposure to the air. For example, the O3′ type crystal structure changes into the H1-3 type crystal structure in some cases. For that reason, all samples are preferably handled in an inert atmosphere such as an argon atmosphere.

### <<Charging Method>>

Whether or not a certain composite oxide is the positive electrode active material 100 of one embodiment of the present invention can be determined by high-voltage charging. For example, the high-voltage charging is performed on a coin cell (CR2032 type with a diameter of 20 mm and a height of 3.2 mm) formed using the composite oxide for a positive electrode and a lithium counter electrode for a negative electrode.

More specifically, a positive electrode can be formed by application of a slurry in which the positive electrode active material, a conductive material, and a binder are mixed to a positive electrode current collector made of aluminum foil.

A lithium metal can be used for a counter electrode. Note that when the counter electrode is formed using a material other than the lithium metal, the voltage of a secondary battery differs from the potential of the positive electrode. Unless otherwise specified, the voltage and the potential in this specification and the like refer to the potential of a positive electrode.

As an electrolyte contained in an electrolyte solution, 1 mol/L lithium hexafluorophosphate (LiPF₆) can be used. As the electrolyte solution, a solution in which ethylene carbonate (EC) and diethyl carbonate (DEC) at EC:DEC=3:7 (volume ratio) and vinylene carbonate (VC) at 2 wt % are mixed can be used.

As a separator, a 25-μm-thick polypropylene porous film can be used.

Stainless steel (SUS) can be used for a positive electrode can and a negative electrode can.

The coin cell fabricated under the above conditions is subjected to constant current charging at 4.6 V and 0.5 C and then to constant voltage charging until the current value reaches 0.01 C. Note that here, 1 C is 137 mA/g. Thus, when the amount of a positive electrode active material per coin cell is 10 mg, the charging corresponds to 0.685 mA. To observe a phase change of the positive electrode active material, charge with such a small current value is preferably performed. The temperature is set to 25° C. After the charging is performed in this manner, the coin cell is disassembled in a glove box with an argon atmosphere to take out the positive electrode, whereby the positive electrode active material charged with high voltage can be obtained. In order to inhibit a reaction with components in the external environment, the taken positive electrode is preferably enclosed in an argon atmosphere in performing various analyses later. For example, XRD can be performed on the positive electrode enclosed in an airtight container for XRD measurement with an argon atmosphere.

### <<XRD>>

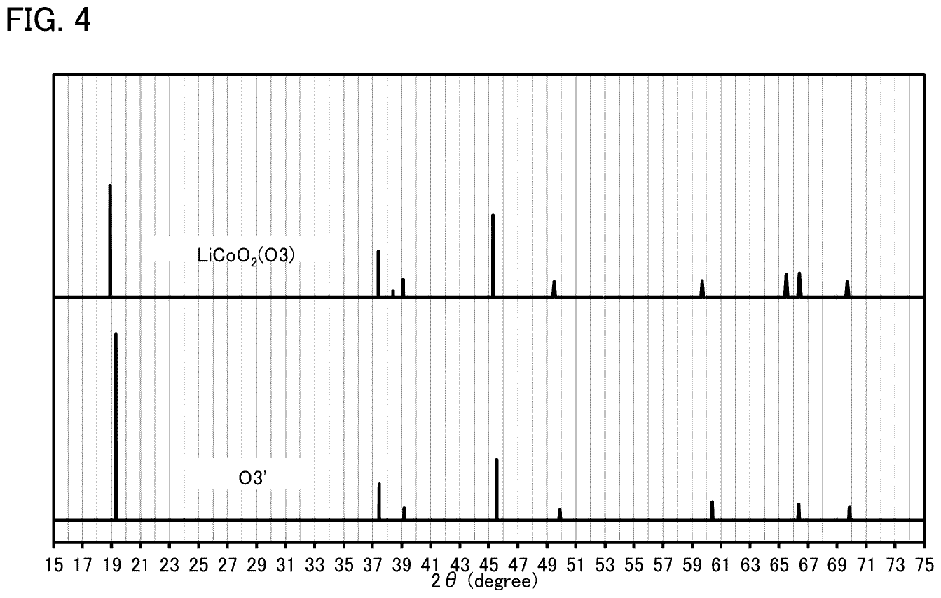

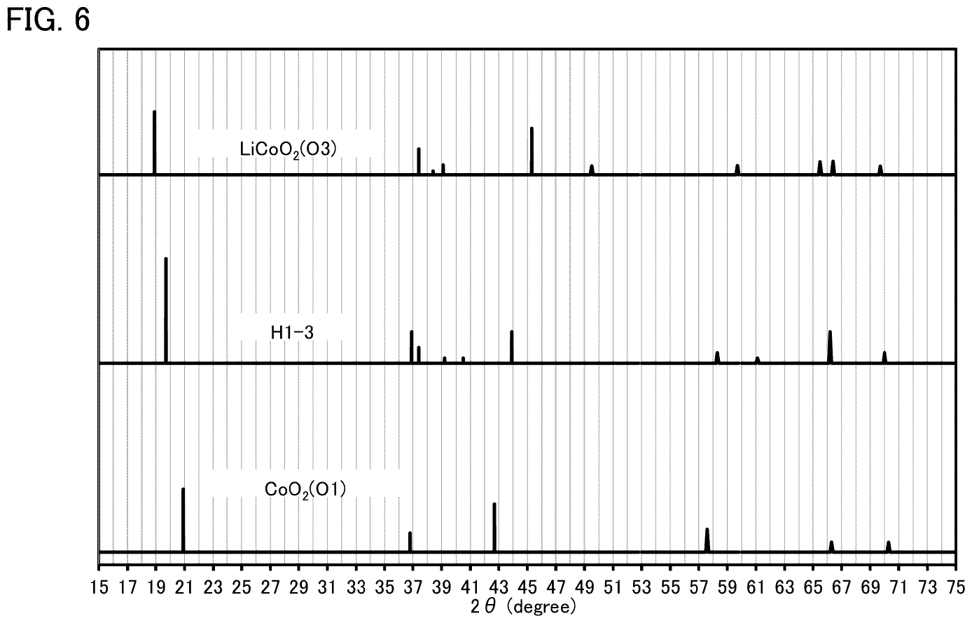

FIG. 4 and FIG. 6 show ideal powder XRD patterns with CuKα1 radiation that are calculated from models of the O3′ type crystal structure and the H1-3 type crystal structure. For comparison, ideal XRD patterns calculated from the crystal structure of LiCoO₂ (O3) with a charge depth of 0 and the crystal structure of CoO₂ (O1) with a charge depth of 1 are also shown. Note that the patterns of LiCoO₂ (O3) and CoO₂ (O1) were made from crystal structure data obtained from the Inorganic Crystal Structure Database (ICSD) (see Non-Patent Document 5) with Reflex Powder Diffraction, which is a module of Materials Studio (BIOVIA). The range of 20 was from 15° (degree) to 75°, the step size was 0.01, the wavelength λ1 was 1.540562×10⁻¹⁰ m, the wavelength 22 was not set, and a single monochromator was used. The pattern of the H1-3 type crystal structure was similarly made from the crystal structure data disclosed in Non-Patent Document 3. The O3′ type crystal structure was estimated from the XRD pattern of the positive electrode active material of one embodiment of the present invention, the crystal structure was fitted with TOPAS Version 3 (crystal structure analysis software produced by Bruker AXS), and the XRD pattern of the O3′ type crystal structure was made in a similar manner to O3, O1, H1-3.

As shown in FIG. 4, the O3′ type crystal structure exhibits diffraction peaks at 2θ of 19.30±0.20° (greater than or equal to 19.10° and less than or equal to 19.50°) and 2θ of 45.55±0.10° (greater than or equal to 45.45° and less than or equal to 45.65°). More specifically, the O3′ type crystal structure exhibits sharp diffraction peaks at 2θ of 19.30±0.10° (greater than or equal to 19.20° and less than or equal to 19.40°) and 2θ of 45.55±0.05° (greater than or equal to 45.50° and less than or equal to 45.60°). By contrast, as shown in FIG. 6, the H1-3 type crystal structure and CoO₂ (P-3m1, O1) do not exhibit peaks at these positions. Thus, the peaks at 2θ of 19.30±0.20° and 20 of 45.55±0.10° in a high voltage charged state can be the features of the positive electrode active material 100 of one embodiment of the present invention.

It can be said that the positions of the XRD diffraction peaks exhibited by the crystal structure with a charge depth of 0 are close to those of the XRD diffraction peaks exhibited by the crystal structure at the time of high voltage charging. More specifically, it can be said that a difference in the positions of two or more, preferably three or more of the main diffraction peaks between the crystal structures is 2θ=0.7° or less, preferably 2θ=0.5° or less.

Sharpness of a diffraction peak in an XRD pattern indicates the degree of crystallinity. It is thus preferable that the diffraction peaks after charge be sharp, in other words, have a small half width. Even peaks that are derived from the same crystal phase have different half widths depending on the XRD measurement conditions and/or the 20 value. In the case of the above-described measurement conditions, the peak observed at 2θ of greater than or equal to 43° and less than or equal to 46° preferably has a small half width of less than or equal to 0.2°, further preferably less than or equal to 0.15°, still further preferably less than or equal to 0.12°. Note that not all peaks need to fulfill the requirement. A crystal phase can be regarded as having high crystallinity when one or more peaks derived from the crystal phase fulfill the requirement. Such high crystallinity efficiently contributes to stability of the crystal structure after charge. Although the positive electrode active material 100 of one embodiment of the present invention has the O3′ type crystal structure at the time of high voltage charging, not all the particles necessarily have the O3′ type crystal structure. Some of the particles may have another crystal structure or be amorphous.

The crystallite size of the O3′ type crystal structure of the positive electrode active material particle is only decreased to approximately one-tenth that of LiCoO₂ (O3) in a discharged state. Thus, the peak of the O3′ type crystal structure can be clearly observed after high-voltage charging even under the same XRD measurement conditions as those of a positive electrode before charging and discharging. By contrast, simple LiCoO₂ has a small crystallite size due to high-voltage charging and exhibits a broad and small XRD peak although it can partly have a structure similar to the O3′ type crystal structure. The crystallite size can be calculated from the half width of the XRD peak.

As described above, the influence of the Jahn-Teller effect is preferably small in the positive electrode active material of one embodiment of the present invention. It is preferable that the positive electrode active material of one embodiment of the present invention have a layered rock-salt crystal structure and mainly contain cobalt as a transition metal. The positive electrode active material of one embodiment of the present invention may contain the above-described additive element, nickel, and manganese in addition to cobalt as long as the influence of the Jahn-Teller effect is small.

Note that the peaks appearing in the powder XRD patterns reflect the crystal structure of the inner portion 100b of the positive electrode active material 100, which accounts for the majority of the volume of the positive electrode active material 100. The crystal structure of the surface portion 100a can be analyzed by electron diffraction of a cross section of the positive electrode active material 100, for example.

### <<XPS>>

In an inorganic oxide, a region that is approximately 2 to 8 nm (normally, approximately 5 nm) in depth from a surface can be analyzed by X-ray photoelectron spectroscopy (XPS) using monochromated aluminum Kα radiation as an X-ray source; thus, the concentrations of elements in approximately half the depth of the surface portion 100a can be quantitatively analyzed. The bonding states of the elements can be analyzed by narrow scanning. Note that the quantitative accuracy of XPS is approximately +1 atomic % in many cases. The lower detection limit is approximately 1 atomic % but depends on the element.

When XPS analysis is performed on the positive electrode active material 100 of one embodiment of the present invention, the number of magnesium atoms is preferably 0.4 times or more and 1.2 times or less, further preferably 0.65 times or more and 1.0 times or less the number of cobalt atoms. The number of nickel atoms is preferably 0.15 times or less, further preferably 0.03 times or more and 0.13 times or less the number of cobalt atoms. The number of aluminum atoms is preferably 0.12 times or less, further preferably 0.09 times or less the number of cobalt atoms. The number of fluorine atoms is preferably 0.3 times or more and 0.9 times or less, further preferably 0.1 times or more and 1.1 times or less the number of cobalt atoms.

In the XPS analysis, monochromatic aluminum (1486.6 eV) can be an X-ray source, for example. An extraction angle is, for example, 45°. With such measurement conditions, a region from the surface to a depth of approximately 2 to 8 nm inclusive (typically, approximately 5 nm) can be analyzed, as mentioned above.

In addition, when the positive electrode active material 100 of one embodiment of the present invention is analyzed by XPS, a peak indicating the bonding energy of fluorine with another element is preferably at greater than or equal to 682 eV and less than 685 eV, further preferably approximately 684.3 eV. This bonding energy is different from that of lithium fluoride (685 eV) and that of magnesium fluoride (686 eV). That is, the positive electrode active material 100 of one embodiment of the present invention containing fluorine is preferably in the bonding state other than lithium fluoride and magnesium fluoride.

Furthermore, when the positive electrode active material 100 of one embodiment of the present invention is analyzed by XPS, a peak indicating the bonding energy of magnesium with another element is preferably at greater than or equal to 1302 eV and less than 1304 eV, further preferably approximately 1303 eV. This bonding energy is different from that of magnesium fluoride (1305 eV) and is close to that of magnesium oxide. That is, the positive electrode active material 100 of one embodiment of the present invention containing magnesium is preferably in the bonding state other than magnesium fluoride.

The concentration of the additive element that preferably exists in the surface portion 100a in a large amount, such as magnesium and aluminum, measured by XPS or the like is preferably higher than the concentrations measured by inductively coupled plasma mass spectrometry (ICP-MS), glow discharge mass spectrometry (GD-MS), or the like.

When a cross section is exposed by processing and analyzed by TEM-EDX, the concentrations of magnesium and aluminum in the surface portion 100a are preferably higher than those in the inner portion 100b. For example, in the TEM-EDX analysis, the magnesium concentration preferably attenuates, at a depth of 1 nm from a point where the magnesium concentration reaches a peak, to less than or equal to 60% of the peak concentration. In addition, the magnesium concentration preferably attenuates, at a depth of 2 nm from the point where the concentration reaches the peak, to less than or equal to 30% of the peak concentration. An FIB (focused ion beam) can be used for the processing, for example.

In the XPS (X-ray photoelectron spectroscopy) analysis, the number of magnesium atoms is preferably greater than or equal to 0.4 times and less than or equal to 1.5 times the number of cobalt atoms. In the ICP-MS analysis, the ratio of the number of magnesium atoms to the number of cobalt atoms (Mg/Co) is preferably greater than or equal to 0.001 and less than or equal to 0.06.

By contrast, it is preferable that nickel, which is one of the transition metals M, not be unevenly distributed in the surface portion 100a but be distributed in the entire positive electrode active material 100.

### <<ESR>>

As described above, the positive electrode active material 100 of one embodiment of the present invention preferably contains cobalt and nickel as the transition metal M and magnesium as the additive element. It is preferable that Ni²⁺ be substituted for part of Co³⁺ and Mg²⁺ be substituted for part of Li⁺ accordingly. Accompanying the substitution of Mg²⁺ for Li⁺, the Ni³⁺ might be reduced to be Ni²⁺. Accompanying the substitution of Mg²⁺ for part of Lit, Co³⁺ in the vicinity of Mg²⁺ might be reduced to be Co²⁺. Accompanying the substitution of Mg²⁺ for part of Co³⁺, Co³⁺ in the vicinity of Mg²⁺ might be oxidized to be Co⁴⁺.

Thus, the positive electrode active material of one embodiment of the present invention preferably contains one or more of Ni²⁺, Ni³⁺, Co²⁺, and Co⁴⁺. Moreover, the spin density attributed to one or more of Ni²⁺, Ni³⁺, Co²⁺, and Co⁴⁺ per weight of the positive electrode active material is preferably higher than or equal to 2.0×10¹⁷ spins/g and less than or equal to 1.0×10²¹ spins/g. The positive electrode active material preferably has the above spin density, in which case the crystal structure can be stable particularly in a charged state. Note that too high a magnesium concentration might reduce the spin density attributed to one or more of Ni²⁺, Ni³⁺, Co²⁺, and Co⁴⁺.

The spin density of a positive electrode active material can be analyzed by electron spin resonance (ESR), for example.

### <<EPMA>>

Elements can be quantified by EPMA (electron probe microanalysis). In surface analysis, distribution of each element can be analyzed.

In EPMA, a region from a surface to a depth of approximately 1 μm is analyzed. Thus, the concentration of each element is sometimes different from measurement results obtained by other analysis methods. For example, when surface analysis is performed on the positive electrode active material 100, the concentration of the additive element existing in the surface portion 100a might be lower than the concentration obtained in XPS. The concentration of the additive element existing in the surface portion 100a might be higher than the concentration obtained in ICP-MS or a value based on the ratio of the raw materials mixed in the process of forming the positive electrode active material.

EPMA surface analysis of a cross section of the positive electrode active material 100 of one embodiment of the present invention preferably reveals a concentration gradient in which the concentration of the additive element increases from the inner portion toward the surface portion 100a. Specifically, each of magnesium, fluorine, and titanium preferably has a concentration gradient in which the concentration increases from the inner portion toward the surface as shown in FIG. 2C. The concentration of aluminum preferably has a peak in a region deeper than the region where the concentration of any of the above elements has a peak, as shown in FIG. 2D. The aluminum concentration peak may be located in the surface portion 100a or located deeper than the surface portion 100a.

Note that the surface and the surface portion 100a of the positive electrode active material 100 of one embodiment of the present invention do not contain a carbonic acid, a hydroxy group, or the like which is chemisorbed after formation of the positive electrode active material 100. Furthermore, an electrolyte solution, a binder, a conductive material, and a compound originating from any of these that are attached to the surface of the positive electrode active material 100 are not contained either. Thus, in quantification of the elements contained in the positive electrode active material 100, correction may be performed to exclude carbon, hydrogen, excess oxygen, excess fluorine, and the like that might be detected in surface analysis such as XPS and EPMA. For example, in XPS, the kinds of bonds can be identified by analysis, and a C—F bond originating from a binder may be excluded by correction.

Furthermore, before any of various kinds of analyses is performed, a sample such as a positive electrode active material 100 and a positive electrode active material layer may be washed, for example, to eliminate an electrolyte solution, a binder, a conductive material, and a compound originating from any of these that are attached to the surface of the positive electrode active material 100. Although lithium might be dissolved to a solvent or the like used in the washing at this time, the transition metal M and the additive element are not easily dissolved even in that case, which does not affect the proportions of atoms of the transition metal M and the additive element.

This embodiment can be implemented in combination with the other embodiments.

### Embodiment 2

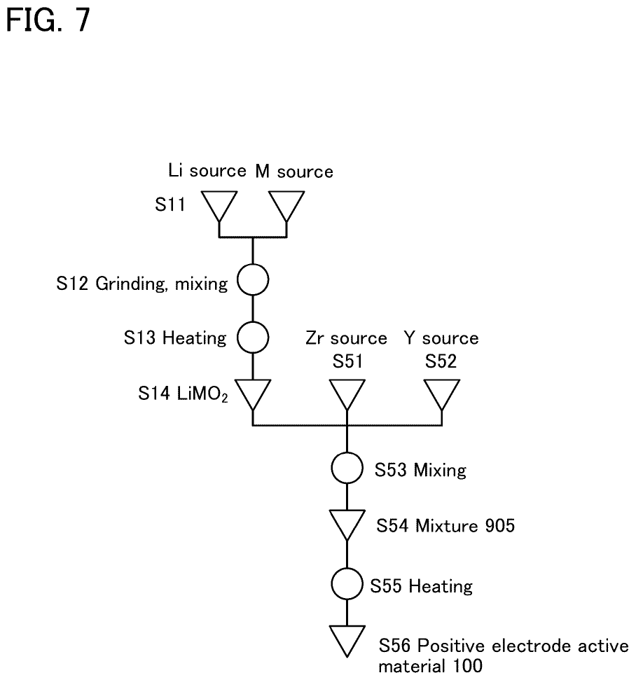

In this embodiment, an example of a method of manufacturing the positive electrode active material and the projection 103 according to one embodiment of the present invention will be described with reference to FIG. 7 to FIG. 10.

With reference to FIG. 7, an example of the manufacturing method in the case where the positive electrode active material 100 and the projection 103 contain zirconium and yttrium as the additive elements is first described.

### <Step S11>

First, in Step S11 in FIG. 7, a lithium source and a transition metal M source are prepared as materials of a composite oxide (LiMO₂) containing lithium, the transition metal M, and oxygen. As the lithium source, for example, lithium carbonate, lithium fluoride, or the like can be used.

As the transition metal M, a metal that can form, together with lithium, a composite oxide having the layered rock-salt structure belonging to the space group R-3m is preferably used. As the transition metal, one or two or more selected from manganese, cobalt, nickel, and the like can be used, for example. That is, as the transition metal M source, only cobalt may be used; only nickel may be used; two types of metals of cobalt and manganese or cobalt and nickel may be used; or three types of metals of cobalt, manganese, and nickel may be used.

When metals that can form a layered rock-salt composite oxide are used, cobalt, manganese, and nickel are preferably mixed at the ratio at which the composite oxide can have a layered rock-salt crystal structure. In addition, aluminum may be added to the transition metal as long as the composite oxide can have a layered rock-salt crystal structure.

As the transition metal M source, oxide or hydroxide of the metal described as an example of the transition metal M, or the like can be used. As a cobalt source, for example, cobalt oxide, cobalt hydroxide, or the like can be used. As a manganese source, manganese oxide, manganese hydroxide, or the like can be used. As a nickel source, nickel oxide, nickel hydroxide, or the like can be used. As an aluminum source, aluminum oxide, aluminum hydroxide, or the like can be used.

### <Step S12>

Next, in Step S12, the lithium source and the transition metal M source are ground and mixed. The mixing can be performed by a dry process or a wet process. For example, a ball mill, a bead mill, or the like can be used for the mixing. When the ball mill is used, a zirconia ball is preferably used as grinding media, for example.

### <Step S13>

Next, in Step S13, the materials mixed in the above manner are heated. This step is sometimes referred to as baking or first heating to distinguish this step from a heating step performed later. The heating is preferably performed at higher than or equal to 800° C. and lower than 1100° C., further preferably at higher than or equal to 900° C. and lower than or equal to 1000° C., still further preferably at approximately 950° C. Alternatively, the heating is preferably performed at higher than or equal to 800° C. and lower than or equal to 1000° C. Alternatively, the heating is preferably performed at higher than or equal to 900° C. and lower than or equal to 1100° C. An excessively low temperature might lead to insufficient decomposition and melting of the lithium source and the transition metal M source. An excessively high temperature, on the other hand, might cause a defect due to excessive reduction of the metal taking part in an oxidation-reduction reaction and used as the transition metal M, evaporation of lithium, or the like. The use of cobalt as the transition metal M, for example, may lead to a defect in which cobalt has divalence.

The heating time can be longer than or equal to 1 hour and shorter than or equal to 100 hours, for example, and is preferably longer than or equal to 2 hours and shorter than or equal to 20 hours. Alternatively, the heating time is preferably longer than or equal to 1 hour and shorter than or equal to 20 hours. Alternatively, the heating time is preferably longer than or equal to 2 hours and shorter than or equal to 100 hours. Baking is preferably performed in an atmosphere with few moisture, such as dry air (e.g., the dew point is lower than or equal to −50° C., further preferably lower than or equal to −100° C.). For example, it is preferable that the heating be performed at 1000° C. for 10 hours, the temperature rise be 200° C./h, and the flow rate of a dry atmosphere be 10 L/min. After that, the heated materials can be cooled to room temperature (25° C.). The temperature decreasing time from the specified temperature to room temperature is preferably longer than or equal to 10 hours and shorter than or equal to 50 hours, for example.

Note that the cooling to room temperature in Step S13 is not essential. As long as later steps of Step S41 to Step S44 are performed without problems, the cooling may be performed to a temperature higher than room temperature.

### <Step S14>

Next, in Step S14, the materials baked in the above manner are collected, whereby the composite oxide (LiMO₂) containing lithium, the transition metal M, and oxygen is obtained. Specifically, lithium cobalt oxide, lithium manganese oxide, lithium nickel oxide, lithium cobalt oxide in which manganese is substituted for part of cobalt, lithium cobalt oxide in which nickel is substituted for part of cobalt, lithium nickel-manganese-cobalt oxide, or the like is obtained.

Alternatively, a composite oxide containing lithium, the transition metal M, and oxygen that is synthesized in advance may be used in Step S14. In that case, Step S11 to Step S13 can be omitted.

For example, as a composite oxide synthesized in advance, a lithium cobalt oxide particle (product name: CELLSEED C-10N) manufactured by NIPPON CHEMICAL INDUSTRIAL CO., LTD. can be used. This is lithium cobalt oxide in which the average particle diameter (D50) is approximately 12 μm, and in the impurity analysis by a glow discharge mass spectroscopy method (GD-MS), the magnesium concentration and the fluorine concentration are less than or equal to 50 ppm wt, the calcium concentration, the aluminum concentration, and the silicon concentration are less than or equal to 100 ppm wt, the nickel concentration is less than or equal to 150 ppm wt, the sulfur concentration is less than or equal to 500 ppm wt, the arsenic concentration is less than or equal to 1100 ppm wt, and the concentrations of elements other than lithium, cobalt, and oxygen are less than or equal to 150 ppm wt.

Alternatively, a lithium cobalt oxide particle (product name: CELLSEED C-5H) manufactured by NIPPON CHEMICAL INDUSTRIAL CO., LTD. can be used. This is lithium cobalt oxide in which the average particle diameter (D50) is approximately 6.5 μm, and the concentrations of elements other than lithium, cobalt, and oxygen are approximately equal to or less than those of C-10N in the impurity analysis by GD-MS.

In this embodiment, cobalt is used as the metal M, and the lithium cobalt oxide particle synthesized in advance (Cellseed C-10N produced by NIPPON CHEMICAL INDUSTRIAL CO., LTD.) is used.

### <Steps S51 and S52>

Next, additive element sources are prepared. As the elements included in the additive element sources, one or more selected from zirconium, yttrium, aluminum, nickel, magnesium, fluorine, manganese, titanium, vanadium, iron, chromium, niobium, cobalt, arsenic, zinc, silicon, sulfur, phosphorus, and boron can be used, for example. In the example shown in FIG. 7, a zirconium source and an yttrium source are used as the additive element sources (Step S51 and Step S52).

Preferably, each of the additive element sources is one or more of an oxide, a hydroxide, a fluoride, and an alkoxide, for example. A phosphate compound such as lithium phosphate can also be used as a phosphorus source.

### <Step S53>

Next, Step S53 is to mix LiMO₂ and the additive element source. This may be rephrased as to make the additive element contained in the surface of LiMO₂.

For example, a solid phase method, a sol-gel method, a sputtering method, a CVD method, or the like can be used as a method for mixing. The solid phase method and the sol-gel method are preferable because these methods enable the additive element to be attached and included to/in the surface of LiMO₂ easily at the atmospheric pressure and room temperature.

Note that in this specification and the like, the sol-gel method refers to a method in which an organic compound solution of a metal as a starting material is turned into a sol where fine particles of an oxide or hydroxide of the metal is dissolved by hydrolysis or polymerization of the compound in the solution, and a film or crystalline body is formed by heating an amorphous porous gel obtained by further proceeding the reaction.

In a sol-gel method, an alcohol is preferably used as a solvent. In particular, an alcohol having an alkyl group that is the same as an alkoxy group of an alkoxide of the additive element source is preferably used. Water is contained in the solvent preferably at 3 vol % or less, further preferably at 0.3 vol % or less. The use of alcohol as the solvent can inhibit degradation of LiMO₂ in the formation process as compared with the case of using only water.

In the case where the sol-gel method is used, an alkoxide of an additive source dissolved in alcohol and LiMO₂ are mixed first.

When zirconium and yttrium are used as the additive element sources, for example, tetraisopropoxy zirconium and isopropoxy yttrium can be used. As an alcohol, for example, isopropanol (2-propanol) can be used.

Next, a mixed solution of an isopropanol solution of tetraisopropoxy zirconium and isopropoxy yttrium and LiMO₂ is stirred. The stirring can be performed with a magnetic stirrer, for example. The stirring can be performed for a time long enough for water in the atmosphere and tetraisopropoxy zirconium and isopropoxy yttrium to cause hydrolysis and a polycondensation reaction, e.g., for 60 hours, at 25° C.

After the above process, precipitate is collected from the mixed solution. As the collection method, filtration, centrifugation, evaporation to dryness, and the like can be used. In this embodiment, evaporation to dryness is used. In this embodiment, circulation drying at 95° C. is performed.

### <Step S54>

Next, in Step S54, the materials dried in the above manner are collected, whereby a mixture 905 is obtained.

### <Step S55>

Next, in Step S55, the mixture 905 is heated in an atmosphere containing oxygen. This step is referred to as annealing or second heating to be distinguish from the other heating step, in some cases. The heating further preferably has the adhesion preventing effect to prevent particles of the mixture 905 from adhering to one another.

Examples of the heating having the adhesion preventing effect are heating while the mixture 905 is being stirred and heating while a container containing the mixture 905 is being vibrated.

The heating temperature in Step S55 needs to be higher than or equal to the temperature at which a reaction between LiMO₂ and the mixture 905 proceeds. Here, the temperature at which the reaction proceeds is a temperature at which interdiffusion between elements included in LiMO₂ and the mixture 905 occurs. Thus, the heating temperature may be lower than the melting temperatures of these materials. For example, in salts and an oxide, solid-phase diffusion occurs at a temperature that is 0.757 times (Tamman temperature Td) the melting temperature Tₘ. Therefore, the temperature is preferably higher than or equal to 500° C., for example.

A higher annealing temperature is preferable because it facilitates the reaction, shortens the annealing time, and enables high productivity.

Note that the annealing temperature needs to be lower than or equal to a decomposition temperature of LiMO₂ (1130° C. in the case of LiCoO₂). At around the decomposition temperature, a slight amount of LiMO₂ might be decomposed. Thus, the annealing temperature is preferably lower than or equal to 1130° C., further preferably lower than or equal to 1000° C., further preferably lower than or equal to 950° C., and further preferably lower than or equal to 900° C.

In view of the above, the annealing temperature is preferably higher than or equal to 500° C. and lower than or equal to 1130° C., further preferably higher than or equal to 500° C. and lower than or equal to 1000° C., still further preferably higher than or equal to 500° C. and lower than or equal to 950° C., yet still further preferably higher than or equal to 500° C. and lower than or equal to 900° C.

The annealing is preferably performed for an appropriate time. The appropriate annealing time is changed depending on conditions, such as the annealing temperature, and the particle size and composition of LiMO₂ in Step S14. In the case where the particle size is small, the annealing is preferably performed at a lower temperature or for a shorter time than the case where the particle size is large, in some cases.

When the median diameter (D50) of the particles of LiMO₂ is approximately 12 μm, for example, the annealing temperature is preferably higher than or equal to 600° C. and lower than or equal to 950° C., for example. The annealing time is preferably longer than or equal to three hours, further preferably longer than or equal to 10 hours, still further preferably longer than or equal to 60 hours, for example.

On the other hand, when the median diameter (D50) of the particles of LiMO₂ is approximately 5 μm, the annealing temperature is preferably higher than or equal to 600° C. and lower than or equal to 950° C., for example. The annealing time is preferably longer than or equal to one hour and shorter than or equal to 10 hours, further preferably approximately two hours, for example.

The temperature decreasing time after the heating is, for example, preferably longer than or equal to 10 hours and shorter than or equal to 50 hours.

### <Step S56>

Next, in Step S56, the material ground in the above manner is collected, whereby the positive electrode active material 100 can be formed. Here, the collected particles are preferably made to pass through a sieve. Through the sieve, adhesion between the positive electrode active material particles can be solved.

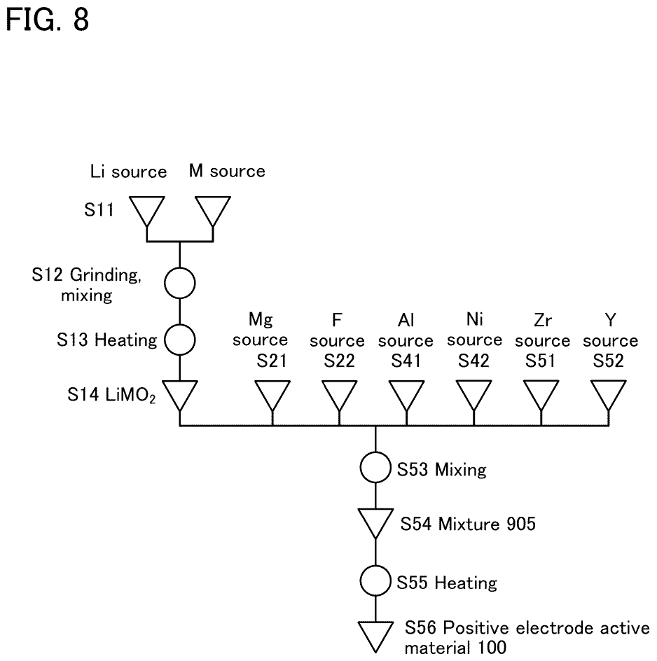

In this embodiment, an example of a manufacturing method in which the positive electrode active material 100 and the projection 103 includes magnesium, fluorine, aluminum, nickel, zirconium, and yttrium as the additive elements will be described with reference to FIG. 8. Many portions are common to FIG. 7; hence, different portions will be mainly described. The description of FIG. 7 can be referred to for the common portions.

### <Steps S21, S22, S41, S42, S51 and S52>

In the manufacturing method in FIG. 8, a magnesium source, a halogen source such as a fluorine source, an aluminum source, a nickel source, a zirconium source, and an yttrium source are prepared as the additive element sources (Step S21, S22, S41, S42, S51, and S52). In addition, although not illustrated, a lithium source is preferably prepared as well.

As the magnesium source, for example, magnesium fluoride, magnesium oxide, magnesium hydroxide, magnesium carbonate, or the like can be used.

As the fluorine source, for example, lithium fluoride (LiF), magnesium fluoride (MgF₂), aluminum fluoride (AlF₃), titanium fluoride (TiF₄ and TiF₃), cobalt fluoride (CoF₂ and CoF₃), nickel fluoride (NiF₂), zirconium fluoride (ZrF₄), vanadium fluoride (VFs), manganese fluoride (MnF₂ and MnF₃), iron fluoride (FeF₂ and FeF₃), chromium fluoride (CrF₂ and CrF₃), niobium fluoride (NbFs), zinc fluoride (ZnF₂), calcium fluoride (CaF₂), sodium fluoride (NaF), potassium fluoride (KF), barium fluoride (BaF₂), cerium fluoride (CeF₂), lanthanum fluoride (LaF₃), or sodium aluminum hexafluoride (Na₃AlF₆) can be used. A plurality of fluorine sources may be mixed to be used. Among them, lithium fluoride, which has a relatively low melting point of 848° C., is preferable because it is easily melted in an annealing step described later.

As the chlorine source, for example, lithium chloride, magnesium chloride, or the like can be used.

As the lithium source, for example, lithium fluoride, lithium carbonate, or the like can be used. That is, lithium fluoride can be used as both the lithium source and the fluorine source. In addition, magnesium fluoride can be used as both the fluorine source and the magnesium source.

In this embodiment, lithium fluoride LiF is prepared as the fluorine source, and magnesium fluoride MgF₂ is prepared as the fluorine source and the magnesium source. When lithium fluoride LiF and magnesium fluoride MgF₂ are mixed at a mole ratio of approximately LiF:MgF₂=65:35, the effect of lowering the melting point becomes the highest. On the other hand, when the amount of lithium fluoride increases, charge and discharge cycle performance might deteriorate because of a too large amount of lithium. Therefore, the mole ratio of lithium fluoride LiF to magnesium fluoride MgF₂ is preferably LiF:MgF₂=x:1 (0≤x≤1.9), further preferably LiF:MgF₂=x:1 (0.1≤x≤0.5), still further preferably LiF:MgF₂=x:1 (x=the vicinity of 0.33). Note that in this specification and the like, the vicinity means a value greater than 0.9 times and smaller than 1.1 times a certain value.

The aluminum source, the nickel source, the zirconium source, and the yttrium source are preferably one or more of an oxide, a hydroxide, a fluoride, and an alkoxide of them.

In addition, in the case where the following mixing and grinding steps are performed by a wet method, a solvent is prepared. As the solvent, ketone such as acetone; alcohol such as ethanol or isopropanol; ether such as diethyl ether; dioxane; acetonitrile; N-methyl-2-pyrrolidone (NMP); or the like can be used. An aprotic solvent that hardly reacts with lithium is further preferably used. In this embodiment, acetone is used.

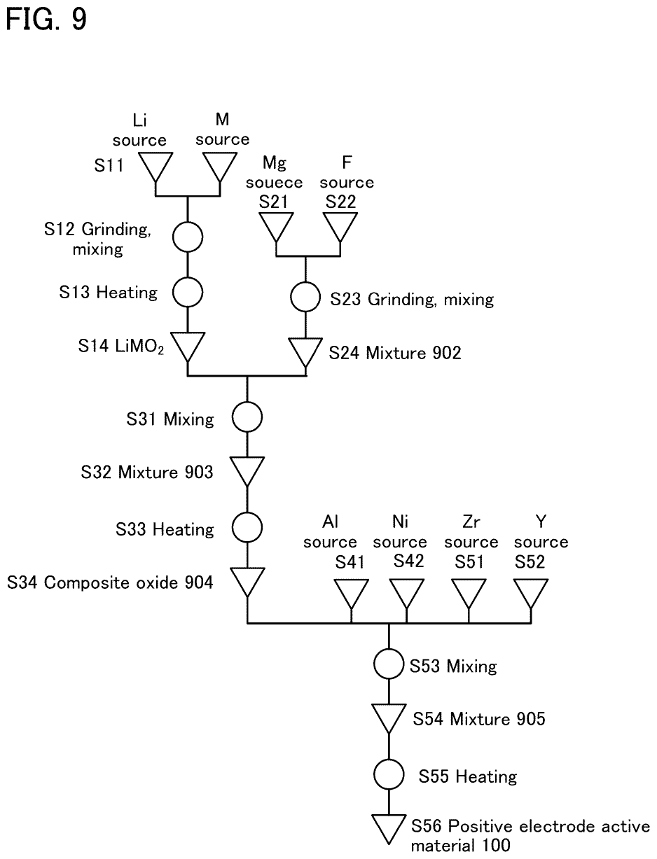

With reference to FIG. 9, an example of the manufacturing method in the case where the positive electrode active material 100 and the projection 103 contain magnesium, fluorine, aluminum, nickel, zirconium, and yttrium as the additive elements is described. Specifically, mixing of the additive elements is divided into two steps in this method. Many portions are common to FIG. 7 and FIG. 8; hence, different portions will be mainly described. The description of FIG. 7 and FIG. 8 can be referred to for the common portions.

### <Steps S21 and S22>

In the manufacturing method in FIG. 9, Steps S21 and S22 are to prepare a magnesium source and a halogen source such as a fluorine source.

### <Step S23>

Next, in Step S23, the magnesium source and the fluorine source are mixed and ground. Although the mixing can be performed by a dry method or a wet method, the wet method is preferable because the materials can be ground to a smaller size. For example, a ball mill, a bead mill, or the like can be used for the mixing. When the ball mill is used, a zirconia ball is preferably used as grinding media, for example. The mixing step and the grinding step are preferably performed sufficiently to pulverize the mixture 902.

### <Step S24>

Next, in Step S24, the materials mixed and ground in the above manner are collected, whereby the mixture 902 is obtained.

For example, the mixture 902 preferably has a D50 (median diameter) of greater than or equal to 600 nm and less than or equal to 20 μm, further preferably greater than or equal to 1 μm and less than or equal to 10 μm. Alternatively, the D50 is preferably greater than or equal to 600 nm and less than or equal to 10 μm. Alternatively, the D50 is preferably greater than or equal to 1 μm and less than or equal to 20 μm. When mixed with LiMO₂ in the later step, the mixture 902 pulverized to such a small size is likely to exist on surfaces of composite oxide particles uniformly.

### <Step S31>

Next, in Step S31, LiMO₂ obtained in Step S14 and the mixture 902 are mixed. The ratio of the number M of the transition metal atoms in the composite oxide containing lithium, the transition metal, and oxygen to the number Mg of magnesium atoms in the mixture 902 (M:Mg) is preferably 100:y (0.1≤y≤6), further preferably 100:y (0.3≤y≤3).

The conditions of the mixing in Step S31 are preferably milder than those of the mixing in Step S12 in order not to damage the particles of the composite oxide. For example, conditions with a lower rotation frequency or shorter time than the mixing in Step S12 are preferable. In addition, it can be said that conditions of the dry method are less likely to break the particles than those of the wet method. For example, a ball mill, a bead mill, or the like can be used for the mixing. When the ball mill is used, a zirconia ball is preferably used as grinding media, for example.

### <Step S32>

Next, in Step S32, the materials mixed in the above manner are collected, whereby a mixture 903 is obtained.

Note that this embodiment describes a method for adding the mixture of lithium fluoride and magnesium fluoride to lithium cobalt oxide with few impurities; however, one embodiment of the present invention is not limited thereto. A mixture obtained through baking after addition of a magnesium source, a fluorine source, and the like to the starting material of lithium cobalt oxide may be used instead of the mixture 903 in Step S42. In that case, there is no need to separate steps of Step S11 to Step S14 and steps of Step S21 to Step S23, which is simple and productive.

Alternatively, lithium cobalt oxide to which magnesium and fluorine are added in advance may be used. When lithium cobalt oxide to which magnesium and fluorine are added is used, the process can be simpler because steps up to Step S42 can be omitted.

In addition, a magnesium source and a fluorine source may be further added to the lithium cobalt oxide to which magnesium and fluorine are added in advance.

### <Step S33>

Next, in Step S33, the mixture 903 is heated in an atmosphere containing oxygen. This step is referred to as first annealing or second heating to be distinguish from the other heating step, in some cases. The heating further preferably has the adhesion preventing effect to prevent particles of the mixture 903 from adhering to one another.

The heating temperature in Step S33 needs to be higher than or equal to the temperature at which a reaction between LiMO₂ and the mixture 902 proceeds. Here, the temperature at which the reaction proceeds is a temperature at which interdiffusion between elements included in LiMO₂ and the mixture 902 occurs. Thus, the heating temperature may be lower than the melting temperatures of these materials. For example, in salts and an oxide, solid-phase diffusion occurs at a temperature that is 0.757 times (Tamman temperature Ta) the melting temperature Tₘ. Therefore, the temperature is preferably higher than or equal to 500° C., for example.

A temperature higher than or equal to the temperature at which at least part of the mixture 903 is melted is preferable because the reaction proceeds more easily. Accordingly, the heating temperature is preferably higher than or equal to the eutectic point of the mixture 902. In the case where the mixture 902 includes LiF and MgF₂, the temperature in Step S33 is preferably set to higher than or equal to 742° C. that is the eutectic point.

The mixture 903 obtained by mixing such that LiCoO₂:LiF:MgF₂=100:0.33:1 (mole ratio) exhibits an endothermic peak at around 830° C. in differential scanning calorimetry measurement (DSC measurement). Thus, the annealing temperature is further preferably higher than or equal to 830° C. The mixture 903 includes at least fluorine, lithium, cobalt, and magnesium.

A higher annealing temperature is preferable because it facilitates the reaction, shortens the annealing time, and enables high productivity.

Note that the annealing temperature needs to be lower than or equal to a decomposition temperature of LiMO₂ (1130° C. in the case of LiCoO₂). At around the decomposition temperature, a slight amount of LiMO₂ might be decomposed. Thus, the annealing temperature is preferably lower than or equal to 1130° C., further preferably lower than or equal to 1000° C., further preferably lower than or equal to 950° C., and further preferably lower than or equal to 900° C.

In view of the above, the annealing temperature is preferably higher than or equal to 500° C. and lower than or equal to 1130° C., further preferably higher than or equal to 500° C. and lower than or equal to 1000° C., still further preferably higher than or equal to 500° C. and lower than or equal to 950° C., yet still further preferably higher than or equal to 500° C. and lower than or equal to 900° C. Furthermore, the annealing temperature is preferably higher than or equal to 742° C. and lower than or equal to 1130° C., further preferably higher than or equal to 742° C. and lower than or equal to 1000° C., still further preferably higher than or equal to 742° C. and lower than or equal to 950° C., yet still further preferably higher than or equal to 742° C. and lower than or equal to 900° C. Furthermore, the annealing temperature is preferably higher than or equal to 830° C. and lower than or equal to 1130° C., further preferably higher than or equal to 830° C. and lower than or equal to 1000° C., still further preferably higher than or equal to 830° C. and lower than or equal to 950° C., yet still further preferably higher than or equal to 830° C. and lower than or equal to 900° C.

In addition, at the time of heating the mixture 903, the partial pressure of fluorine or a fluoride in the atmosphere is preferably controlled to be within an appropriate range.

In the manufacturing method described in this embodiment, some of the materials, e.g., LiF as the fluorine source, function as flux. Owing to this function, the annealing temperature can be lower than or equal to the decomposition temperature of LiMO₂, e.g., a temperature higher than or equal to 742° C. and lower than or equal to 950° C., which allows distribution of the additive element such as magnesium in the surface portion more densely than in the core portion and formation of the positive electrode active material having favorable performance.

However, LiF is lighter than an oxygen molecule and thus volatilized and dissipated by the heating. In that case, the amount of LiF in the mixture 903 is reduced, and the function as flux is lowered. Therefore, heating needs to be performed while volatilization of LiF is inhibited. Note that even when LiF is not used as the fluorine source or the like, there is a possibility in that Li and F at a surface of LiMO₂ react with each other to generate LiF and vaporize. Therefore, the volatilization needs to be inhibited also when a fluoride having a higher melting point than LiF is used.

In view of this, the mixture 903 is preferably heated in an atmosphere containing LiF, i.e., the mixture 903 is preferably heated in a state where the partial pressure of LiF in a heating furnace is high. Such heating can inhibit volatilization of LiF in the mixture 903.

### <Step S34>

Next, in Step S34, the material heated in the above manner is collected, whereby a composite oxide 904 is obtained. The composite oxide 904 through the above manufacturing method has the O3′ type crystal structure at the time of high-voltage charging.

### <Steps S41, S42, S51, S52, and S53>

Next, in Steps S41, S42, S51, and S52, an aluminum source, a nickel source, a zirconium source, and an yttrium source are prepared and mixed. Preferably, each of the additive element sources is an oxide, a hydroxide, a fluoride, an alkoxide, or the like. In addition, a plurality of mixing methods may be used in combination. For example, nickel hydroxide can be used as the nickel source, and as the aluminum source, the zirconium source, and the yttrium source, an alkoxide thereof can be used. In this case, for example, the composite oxide 904 and nickel hydroxide can be first mixed, and then the mixture of the composite oxide 904 and nickel hydroxide can be mixed with aluminum alkoxide, zirconium alkoxide, and yttrium alkoxide by a sol-gel method.

### <Step S54>

Next, in Step S54, the materials mixed in the above manner are collected, whereby the mixture 905 is obtained.

### <Step S55>

Then, the mixture 905 is heated in Step S55. (When S33 is referred to as first annealing, S55 may be referred to as second annealing; when S33 is referred to as second heating, S55 may be referred to as third heating.) The description with reference to FIG. 7 and FIG. 8 can be referred to for the heating conditions.

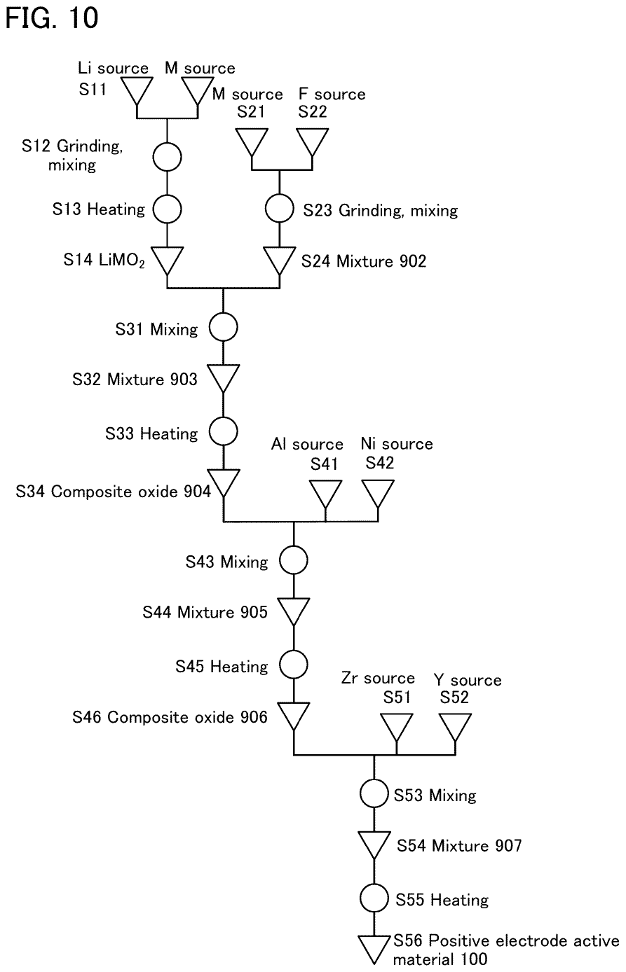

With reference to FIG. 10, an example of the manufacturing method in the case where the positive electrode active material 100 and the projection 103 contain magnesium, fluorine, aluminum, nickel, zirconium, and yttrium as the additive elements is described. Specifically, mixing of the additive elements is divided into three steps in this method. Many portions are common to FIG. 7 to FIG. 9; hence, different portions will be mainly described. The description of FIG. 7 to FIG. 9 can be referred to for the common portions.

### <Steps S41 and S42>

In the manufacturing method in FIG. 10, Steps S41 and S42 are to prepare an aluminum source and a nickel source.

### <Steps S43 and S44>

Next, in Step S43, the composite oxide 904, the aluminum source, and the nickel source are mixed, whereby the mixture 905 is obtained.

### <Step S45>

Then, the mixture 905 is heated in Step S45. When S33 is referred to as first annealing, S45 may be referred to as second annealing; when S33 is referred to as second heating, S45 may be referred to as third heating. The description with reference to FIG. 7 to FIG. 9 can be referred to for the heating conditions.

### <Step S46>

The material heated in Step S45 is collected, whereby a composite oxide 906 is obtained

### (Step S46).

<Steps S51 and S52>

Next, in Steps S51 and S52, a zirconium source and a yttrium source are prepared.

### <Steps S53 and S54>

Next, in Step S53, the composite oxide 906, the zirconium source, and the yttrium source are mixed, whereby a mixture 907 is obtained.

### <Step S55>

Then, the mixture 907 is heated in Step S55. (When S33 is referred to as first annealing and S45 is referred to as second heating, S55 may be referred to as third heating; when S33 is referred to as second heating and S45 is referred to as third heating, S55 may be referred to as fourth heating.) The description with reference to FIG. 7 to FIG. 9 can be referred to for the heating conditions.

When the step of introducing the transition metal M and the step of introducing the additive element are separately performed in such a manner, the profiles in the depth direction of the elements can be made different from each other in some cases. For example, the concentration of the additive element can be made higher in the surface portion than in the central portion of the particle. Furthermore, with the number of atoms of the transition metal M as a reference, the ratio of the number of atoms of the additive element with respect to the reference can be higher in the surface portion than in the central portion. The concentration of the additive element can be made high in the projection, in particular.

This embodiment can be used in combination with the other embodiments.

### Embodiment 3

In this embodiment, a lithium-ion secondary battery including a positive electrode active material of one embodiment of the present invention will be described. The secondary battery at least includes an exterior body, a current collector, an active material (a positive electrode active material or a negative electrode active material), a conductive material, and a binder. An electrolyte solution in which a lithium salt or the like is dissolved is also included. In the secondary battery using an electrolyte solution, a positive electrode, a negative electrode, and a separator between the positive electrode and the negative electrode are provided.

### [Positive Electrode]

The positive electrode includes a positive electrode active material layer and a positive electrode current collector. The positive electrode active material layer preferably includes the positive electrode active material described in Embodiment 1, and may further include a binder, a conductive material, or the like.

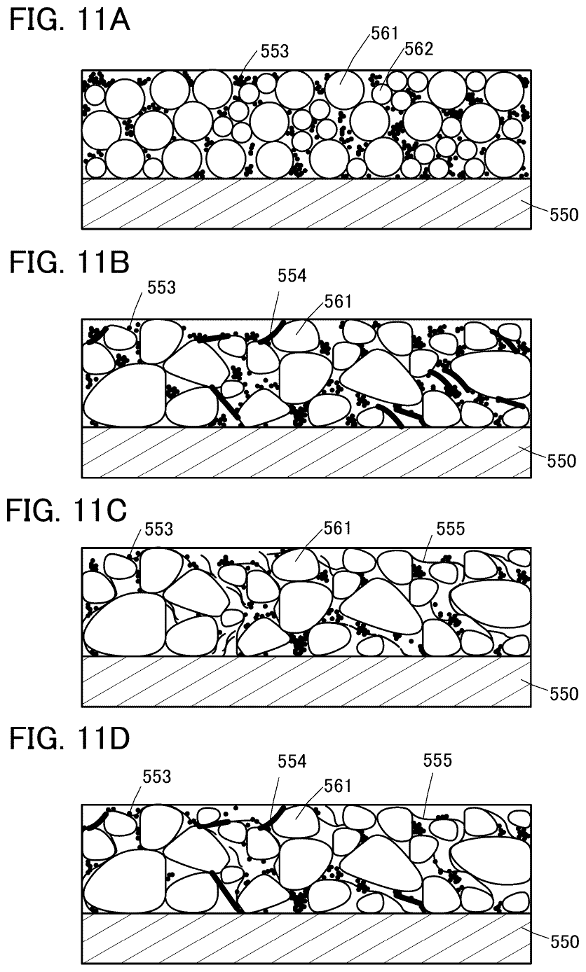

FIG. 11A shows an example of a schematic cross-sectional view of the positive electrode.

A current collector 550 is metal foil, and the positive electrode is formed by applying slurry onto the metal foil and drying the slurry. Pressing may be performed after drying. The positive electrode is a component obtained by forming an active material layer over the current collector 550.

Slurry refers to a material solution that is used to form an active material layer over the current collector 550 and includes an active material, a binder, and a solvent, preferably and also a conductive material mixed therewith. Slurry may also be referred to as slurry for an electrode or active material slurry; in some cases, slurry for forming a positive electrode active material layer is referred to as slurry for a positive electrode, and slurry for forming a negative electrode active material layer is referred to as slurry for a negative electrode.

A conductive material is also referred to as a conductivity-imparting agent or a conductive additive, and a carbon material is used as the conductive additive. A conductive material is attached between a plurality of active materials, whereby the plurality of active materials are electrically connected to each other, and the conductivity increases. Note that the term “attach” refers not only to a state where an active material and a conductive material are physically in close contact with each other, and includes, for example, the following concepts: the case where covalent bonding occurs, the case where bonding with the Van der Waals force occurs, the case where a conductive material covers part of the surface of an active material, the case where a conductive material is embedded in surface roughness of an active material, and the case where an active material and a conductive material are electrically connected to each other without being in contact with each other.

Typical examples of the carbon material used as the conductive material include carbon black (e.g., furnace black, acetylene black, and graphite).

In FIG. 11A, acetylene black 553 is shown as the conductive material. FIG. 11A shows an example in which second active materials 562 with a smaller particle diameter than the positive electrode active material 100 obtained in Embodiment 1 are mixed. The positive electrode active material layer in which particles with different particle sizes are mixed can have high density, which enables the charge and discharge capacity of the secondary battery to improve. Note that the positive electrode active material 100 described in Embodiment 1 corresponds to an active material 561 in FIG. 11A.

In the positive electrode of the secondary battery, a binder (a resin) is mixed in order to fix the current collector 550 such as metal foil and the active material. The binder is also referred to as a binding agent. Since the binder is a high molecular material, a large amount of binder lowers the proportion of the active material in the positive electrode, thereby reducing the discharge capacity of the secondary battery. Therefore, the amount of binder mixed is reduced to a minimum. In FIG. 11A, regions not filled with the active material 561, the second active material 562, or the acetylene black 553 indicate spaces or binders.

Although FIG. 11A shows an example in which the active material 561 has a spherical shape, there is no particular limitation and other various shapes can be employed. The cross-sectional shape of the active material 561 may be an ellipse, a rectangle, a trapezoid, a pyramid, a quadrilateral with rounded corners, or an asymmetrical shape.

FIG. 11B shows an example in which the active materials 561 have various shapes. FIG. 11B shows the example different from that in FIG. 11A.

In the positive electrode in FIG. 11B, graphene and a graphene compound 554 is used as a carbon material used as the conductive material.

Graphene, which has electrically, mechanically, or chemically remarkable characteristics, is a carbon material that is expected to be applied to a variety of fields, such as field-effect transistors and solar batteries.

A graphene compound in this specification and the like includes multilayer graphene, multi graphene, graphene oxide, multilayer graphene oxide, multi graphene oxide, reduced graphene oxide, reduced multilayer graphene oxide, reduced multi graphene oxide, or the like. A graphene compound contains carbon, has a plate-like shape, a sheet-like shape, or the like, and has a two-dimensional structure formed of a six-membered ring composed of carbon atoms. A graphene compound preferably has a curved shape. The reduced graphene oxide may also be referred to as a carbon sheet. A graphene compound preferably includes a functional group. A graphene compound may be rounded like carbon nanofiber.

The graphene and graphene compound may have excellent electrical characteristics of high conductivity and excellent physical properties of high flexibility and high mechanical strength. The graphene and graphene compound have a sheet-like shape. The graphene and graphene compound have a curved surface in some cases, thereby enabling low-resistant surface contact. Furthermore, the graphene and graphene compound have extremely high conductivity even with a small thickness in some cases and thus allow a conductive path to be formed in an active material layer efficiently even with a small amount. Hence, the use of the graphene and graphene compound as the conductive material can increase the area where the active material and the conductive material are in contact with each other. Note that a graphene compound preferably clings to at least a portion of an active material particle. The graphene compound preferably overlays at least a portion of the active material particles. The shape of the graphene compound preferably conforms to at least a portion of the shape of the active material particles. The shape of active material particles means, for example, an uneven surface of a single active material particle or an uneven surface formed by a plurality of active material particles. A graphene compound preferably surrounds at least a portion of an active material particle. A graphene compound may have a hole.

In FIG. 11B, a positive electrode active material layer containing the active material 561, the graphene and graphene compound 554, and the acetylene black 553 is formed over the current collector 550.

In the step of mixing the graphene and graphene compound 554 and the acetylene black 553 to obtain an electrode slurry, the weight of mixed carbon black is preferably 1.5 times to 20 times, further preferably 2 times to 9.5 times the weight of graphene.

When the graphene and graphene compound 554 and the acetylene black 553 are mixed in the above ratio range, the acetylene black 553 can be dispersed uniformly and less likely to be aggregated at the time of preparing the slurry. Furthermore, when the graphene and graphene compound 554 and the acetylene black 553 are mixed in the above ratio range, the electrode density can be higher than that of an electrode using only the acetylene black 553 as a conductive material. As the electrode density is higher, the capacity per unit weight can be higher. Specifically, the density of the positive electrode active material layer measured by gravimetry can be higher than 3.5 g/cc. In addition, it is preferable that the positive electrode active material 100 described in Embodiment 1 be used for the positive electrode and the graphene and graphene compound 554 and the acetylene black 553 be mixed in the above ratio range, in which case synergy for higher capacity of the secondary battery can be expected.

The electrode density is lower than that of a positive electrode containing only graphene as a conductive material, but when a first carbon material (graphene) and a second carbon material (acetylene black) are mixed in the above ratio range, fast charging can be achieved. The above features are advantageous for secondary batteries for vehicles.

When a vehicle becomes heavier with increasing number of secondary batteries, more energy is consumed to move the vehicle, which shortens the driving range. With the use of a high-density secondary battery, the driving range of the vehicle can be maintained with almost no change in the total weight of a vehicle including a secondary battery having the same weight.

Since power is needed to charge the secondary battery with higher capacity in the vehicle, it is desirable to end charging fast. What is called a regenerative charging, in which electric power is temporarily generated when the vehicle is braked and the electric power is used for charging, is performed under high rate charging conditions; thus, a secondary battery for a vehicle is desired to have favorable rate characteristics.

The positive electrode active material 100 described in Embodiment 1 is used in the positive electrode, whereby a secondary battery for a vehicle having a high energy density and favorable output characteristics can be obtained.

This structure is also effective in a portable information terminal, and using the positive electrode active material 100 described in Embodiment 1 for the positive electrode enables a small secondary battery with high capacity.

In FIG. 11B, a region that is not filled with the active material 561, the graphene and graphene compound 554, or the acetylene black 553 represents a space or the binder. A space is required for penetration of the electrolyte solution; too many spaces lower the electrode density and too few spaces do not allow penetration of the electrolyte solution, and when the region that is not filled with the acetylene black 553 remains as a space after the secondary battery is completed, the energy density is lowered.

The positive electrode active material 100 obtained in Embodiment 1 is used in the positive electrode, whereby a secondary battery having a high energy density and favorable output characteristics can be obtained.

FIG. 11C shows an example of a positive electrode in which a carbon nanotube 555 is used instead of graphene. FIG. 11C shows the example different from that in FIG. 11B. With the use of the carbon nanotube 555, aggregation of carbon black such as the acetylene black 553 can be prevented and the dispersibility can be increased.

In FIG. 11C, a region that is not filled with the active material 561, the carbon nanotube 555, or the acetylene black 553 represents a space or the binder.

FIG. 11D shows another example of a positive electrode. In the example shown in FIG. 11C, the carbon nanotube 555 is used in addition to the graphene and graphene compound 554. With the use of both the graphene and graphene compound 554 and the carbon nanotube 555, aggregation of carbon black such as the acetylene black 553 can be prevented and the dispersibility can be further increased.

In FIG. 11D, a region that is not filled with the active material 561, the carbon nanotube 555, the graphene and graphene compound 554, or the acetylene black 553 represents a space or the binder.

The positive electrode in any one of FIG. 11A to FIG. 11D is used, and a stack in which a separator is provided over the positive electrode and a negative electrode is provided over the separator is set in a container (e.g., an exterior body or a metal can) and the container is filled with an electrolyte solution, whereby a secondary battery can be fabricated.

Although the above structure is an example of a secondary battery using an electrolyte solution, one embodiment of the present invention is not limited thereto.

For example, a semi-solid-state battery or an all-solid-state battery can be fabricated using the positive electrode active material 100 described in Embodiment 1.

In this specification and the like, a semi-solid-state battery refers to a battery in which at least one of an electrolyte layer, a positive electrode, and a negative electrode includes a semi-solid-state material. The term “semi-solid-state” here does not mean that the proportion of a solid-state material is 50%. The term “semi-solid-state” means having properties of a solid, such as a small volume change, and also having some of properties close to those of a liquid, such as flexibility. A single material or a plurality of materials can be used to satisfy the above properties. For example, a porous solid-state material infiltrated with a liquid material may be used.

In this specification and the like, a polymer electrolyte secondary battery refers to a secondary battery in which an electrolyte layer between a positive electrode and a negative electrode includes a polymer. Polymer electrolyte secondary batteries include a dry (or true) polymer electrolyte battery and a polymer gel electrolyte battery. A polymer electrolyte secondary battery may be referred to as a semi-solid-state battery.

A semi-solid-state battery fabricated using the positive electrode active material 100 described in Embodiment 1 is a secondary battery having high charge and discharge capacity. The semi-solid-state battery can have high charge and discharge voltage. Alternatively, a highly safe or highly reliable semi-solid-state battery can be achieved.

The positive electrode active material described in Embodiment 1 and another positive electrode active material may be mixed to be used.

Examples of another positive electrode active material include composite oxides having an olivine crystal structure, a layered rock-salt crystal structure, and a spinel crystal structure. Examples include compounds such as LiFePO₄, LiFeO₂, LiNiO₂, LiMn₂O₄, V₂O₅, Cr₂O₅, and MnO₂.

As another positive electrode active material, it is preferable to mix lithium nickel oxide (LiNiO₂ or LiNi₁₋ₓMₓO₂ (0<x<1) (M=Co, Al, or the like)) with a lithium-containing material that has a spinel crystal structure and contains manganese, such as LiMn₂O₄. This composition can improve the characteristics of the secondary battery.

As another positive electrode active material, a lithium-manganese composite oxide that can be represented by a composition formula LiₐMn_{b}M2_{c}O_{d} can be used. Here, the element M2 is preferably silicon, phosphorus, or a metal element other than lithium and manganese, and further preferably nickel. When the whole particle of a lithium-manganese composite oxide is measured, it is preferable to satisfy 0<a/(b+c)<2; c 0; and 0.26≤(b+c)/d<0.5 at the time of discharging. Note that the proportions of metals, silicon, phosphorus, and the like in the whole particle of a lithium-manganese composite oxide can be measured with, for example, an ICP-MS (inductively coupled plasma-mass spectrometer). The proportion of oxygen in the whole particle of a lithium-manganese composite oxide can be measured by, for example, EDX (energy dispersive X-ray spectroscopy). Moreover, the proportion of oxygen can be measured using fusion gas analysis and valence evaluation with XAFS (X-ray absorption fine structure) spectroscopy in combination with ICPMS analysis. Note that a lithium-manganese composite oxide is an oxide containing at least lithium and manganese, and may contain one or more elements selected from a group consisting of chromium, cobalt, aluminum, nickel, iron, magnesium, molybdenum, zinc, indium, gallium, copper, titanium, niobium, silicon, phosphorus, and the like.

### <Binder>

As the binder, a rubber material such as styrene-butadiene rubber (SBR), styrene-isoprene-styrene rubber, acrylonitrile-butadiene rubber, butadiene rubber, or ethylene-propylene-diene copolymer is preferably used, for example. Alternatively, fluororubber can be used as the binder.

As the binder, for example, water-soluble polymers are preferably used. As the water-soluble polymers, a polysaccharide can be used, for example. As the polysaccharide, starch, a cellulose derivative such as carboxymethyl cellulose (CMC), methyl cellulose, ethyl cellulose, hydroxypropyl cellulose, diacetyl cellulose, or regenerated cellulose, or the like can be used. It is further preferable that such water-soluble polymers be used in combination with any of the above rubber materials.

Alternatively, as the binder, a material such as polystyrene, poly(methyl acrylate), poly(methyl methacrylate) (PMMA), sodium polyacrylate, polyvinyl alcohol (PVA), polyethylene oxide (PEO), polypropylene oxide, polyimide, polyvinyl chloride, polytetrafluoroethylene, polyethylene, polypropylene, polyisobutylene, polyethylene terephthalate, nylon, polyvinylidene fluoride (PVDF), polyacrylonitrile (PAN), ethylene-propylene-diene polymer, polyvinyl acetate, or nitrocellulose is preferably used.

At least two of the above materials may be used in combination for the binder.

For example, a material having a significant viscosity modifying effect and another material may be used in combination. For example, a rubber material or the like has high adhesion and high elasticity but may have difficulty in viscosity modification when mixed in a solvent. In such a case, a rubber material or the like is preferably mixed with a material having a significant viscosity modifying effect, for example. As a material having a significant viscosity modifying effect, for instance, a water-soluble polymer is preferably used. An example of a water-soluble polymer having a significant viscosity modifying effect is the above-mentioned polysaccharide; for instance, a cellulose derivative such as carboxymethyl cellulose (CMC), methyl cellulose, ethyl cellulose, hydroxypropyl cellulose, diacetyl cellulose, or regenerated cellulose, or starch can be used.

Note that a cellulose derivative such as carboxymethyl cellulose obtains a higher solubility when converted into a salt such as a sodium salt or an ammonium salt of carboxymethyl cellulose, and thus easily exerts an effect as a viscosity modifier. A high solubility can also increase the dispersibility of an active material and other components in the formation of slurry for an electrode. In this specification, cellulose and a cellulose derivative used as a binder of an electrode include salts thereof.

A water-soluble polymer stabilizes the viscosity by being dissolved in water and allows stable dispersion of the active material and another material combined as a binder, such as styrene-butadiene rubber, in an aqueous solution. Furthermore, a water-soluble polymer is expected to be easily and stably adsorbed onto an active material surface because it has a functional group. Many cellulose derivatives, such as carboxymethyl cellulose, have a functional group such as a hydroxyl group or a carboxyl group. Because of functional groups, polymers are expected to interact with each other and cover an active material surface in a large area.

In the case where the binder that covers the active material surface or is in contact with the surface forms a film, the film is expected to serve also as a passivation film to suppress the decomposition of the electrolyte solution. Here, a passivation film refers to a film without electric conductivity or a film with extremely low electric conductivity, and can inhibit the decomposition of an electrolyte solution at a potential at which a battery reaction occurs when the passivation film is formed on the active material surface, for example. It is preferred that the passivation film can conduct lithium ions while suppressing electrical conduction.

### <Positive Electrode Current Collector>

The current collector can be formed using a material that has high conductivity, such as a metal like stainless steel, gold, platinum, aluminum, or titanium, or an alloy thereof. It is preferred that a material used for the positive electrode current collector not dissolve at the potential of the positive electrode. It is also possible to use an aluminum alloy to which an element that improves heat resistance, such as silicon, titanium, neodymium, scandium, or molybdenum, is added. A metal element that forms silicide by reacting with silicon may be used. Examples of the metal element that forms silicide by reacting with silicon include zirconium, titanium, hafnium, vanadium, niobium, tantalum, chromium, molybdenum, tungsten, cobalt, and nickel. The current collector can have a foil-like shape, a plate-like shape, a sheet-like shape, a net-like shape, a punching-metal shape, an expanded-metal shape, or the like as appropriate. The current collector preferably has a thickness greater than or equal to 5 μm and less than or equal to 30 μm.

### [Negative Electrode]

The negative electrode includes a negative electrode active material layer and a negative electrode current collector. The negative electrode active material layer includes a negative electrode active material, and may also include a conductive material and a binder.

### <Negative Electrode Active Material>

As the negative electrode active material, an alloy-based material, a carbon-based material, or a mixture thereof can be used, for example.

As the negative electrode active material, an element that enables charge and discharge reactions by alloying and dealloying reactions with lithium can be used. For example, a material containing one or more selected from silicon, tin, gallium, aluminum, germanium, lead, antimony, bismuth, silver, zinc, cadmium, indium, and the like can be used. Such elements have higher capacity than carbon. In particular, silicon has a high theoretical capacity of 4200 mAh/g. For this reason, silicon is preferably used as the negative electrode active material. Alternatively, a compound containing any of the above elements may be used. For example, SiO, Mg₂Si, Mg₂Ge, SnO, SnO₂, Mg₂Sn, SnS₂, V₂Sn₃, FeSn₂, CoSn₂, Ni₃Sn₂, Cu₆Sn₅, Ag₃Sn, Ag₃Sb, Ni₂MnSb, CeSb₃, LaSn₃, La₃Co₂Sn₇, CoSb₃, InSb, and SbSn are given. Here, an element that enables charge and discharge reactions by alloying and dealloying reactions with lithium, a compound containing the element, and the like may be referred to as an alloy-based material.

In this specification and the like, SiO refers to silicon monoxide, for example. Note that SiO can alternatively be expressed as SiOₓ. Here, it is preferred that x be 1 or have an approximate value of 1. For example, x is preferably more than or equal to 0.2 and less than or equal to 1.5, and preferably more than or equal to 0.3 and less than or equal to 1.2.

As the carbon-based material, graphite, graphitizing carbon (soft carbon), non-graphitizing carbon (hard carbon), carbon nanotube, graphene, carbon black, or the like can be used.

Examples of graphite include artificial graphite and natural graphite. Examples of artificial graphite include mesocarbon microbeads (MCMB), coke-based artificial graphite, and pitch-based artificial graphite. Here, as artificial graphite, spherical graphite having a spherical shape can be used. For example, MCMB is preferable because it may have a spherical shape. Moreover, MCMB may be preferable because it can relatively easily have a small surface area. Examples of natural graphite include flake graphite and spherical natural graphite.

Graphite has a low potential substantially equal to that of a lithium metal (higher than or equal to 0.05 V and lower than or equal to 0.3 V vs. Li/Li⁺) when lithium ions are intercalated into the graphite (while a lithium-graphite intercalation compound is generated). For this reason, a lithium-ion secondary battery including graphite can have a high operating voltage. In addition, graphite is preferred because of its advantages such as a relatively high capacity per unit volume, relatively small volume expansion, low cost, and higher level of safety than that of a lithium metal.

As the negative electrode active material, an oxide such as titanium dioxide (TiO₂), lithium titanium oxide (Li₄Ti₅O₁₂), a lithium-graphite intercalation compound (LiₓC₆), niobium pentoxide (Nb₂O₅), tungsten oxide (WO₂), or molybdenum oxide (MoO₂) can be used.

Alternatively, as the negative electrode active material, Li₃₋ₓMₓN (M is Co, Ni, or Cu) with a Li₃N structure, which is a composite nitride containing lithium and a transition metal, can be used. For example, Li_{2.6}Co_{0.4}N₃ is preferable because of high charge and discharge capacity (900 mAh/g and 1890 mAh/cm³).

A composite nitride containing lithium and a transition metal is preferably used, in which case lithium ions are contained in the negative electrode active material and thus the negative electrode active material can be used in combination with a positive electrode active material that does not contain lithium ions, such as V₂O₅ or Cr₃O₈. Note that in the case of using a material containing lithium ions as a positive electrode active material, the composite nitride containing lithium and a transition metal can be used as the negative electrode active material by extracting the lithium ions contained in the positive electrode active material in advance.

Alternatively, a material that causes a conversion reaction can be used as the negative electrode active material. For example, a transition metal oxide that does not form an alloy with lithium, such as cobalt oxide (CoO), nickel oxide (NiO), and iron oxide (FeO), may be used as the negative electrode active material. Other examples of the material that causes a conversion reaction include oxides such as Fe₂O₃, CuO, Cu₂O, RuO₂, and Cr₂O₃, sulfides such as CoS_{0.89}, NiS, and CuS, nitrides such as Zn₃N₂, Cu₃N, and Ge₃N₄, phosphides such as NiP₂, FeP₂, and CoP₃, and fluorides such as FeF₃ and BiF₃.

For the conductive material and the binder that can be included in the negative electrode active material layer, materials similar to those for the conductive material and the binder that can be included in the positive electrode active material layer can be used.

### <Negative Electrode Current Collector>

For the negative electrode current collector, copper or the like can be used in addition to a material similar to that for the positive electrode current collector. Note that a material that is not alloyed with carrier ions of lithium or the like is preferably used for the negative electrode current collector.

### [Separator]

The separator is positioned between the positive electrode and the negative electrode. The separator can be formed using, for example, a fiber containing cellulose, such as paper, nonwoven fabric, glass fiber, ceramics, or synthetic fiber containing nylon (polyamide), vinylon (polyvinyl alcohol-based fiber), polyester, acrylic, polyolefin, or polyurethane. The separator is preferably processed into a bag-like shape to enclose one of the positive electrode and the negative electrode.

The separator may have a multilayer structure. For example, an organic material film of polypropylene, polyethylene, or the like can be coated with a ceramic-based material, a fluorine-based material, a polyamide-based material, a mixture thereof, or the like. Examples of the ceramic-based material include aluminum oxide particles and silicon oxide particles. Examples of the fluorine-based material include PVDF and polytetrafluoroethylene. Examples of the polyamide-based material include nylon and aramid (meta-based aramid and para-based aramid).

When the separator is coated with the ceramic-based material, the oxidation resistance is improved; hence, deterioration of the separator in charging and discharging at high voltage can be suppressed and thus the reliability of the secondary battery can be improved. When the separator is coated with the fluorine-based material, the separator is easily brought into close contact with an electrode, resulting in high output characteristics. When the separator is coated with the polyamide-based material, in particular, aramid, the safety of the secondary battery is improved because heat resistance is improved.

For example, both surfaces of a polypropylene film may be coated with a mixed material of aluminum oxide and aramid. Alternatively, a surface of a polypropylene film that is in contact with the positive electrode may be coated with a mixed material of aluminum oxide and aramid, and a surface of the polypropylene film that is in contact with the negative electrode may be coated with the fluorine-based material.

With the use of a separator having a multilayer structure, the capacity per volume of the secondary battery can be increased because the safety of the secondary battery can be maintained even when the total thickness of the separator is small.

### [Electrolyte Solution]

The electrolyte solution contains a solvent and an electrolyte. As the solvent of the electrolyte solution, an aprotic organic solvent is preferably used. For example, one of ethylene carbonate (EC), propylene carbonate (PC), butylene carbonate, chloroethylene carbonate, vinylene carbonate, γ-butyrolactone, γ-valerolactone, dimethyl carbonate (DMC), diethyl carbonate (DEC), ethyl methyl carbonate (EMC), methyl formate, methyl acetate, ethyl acetate, methyl propionate, ethyl propionate, propyl propionate, methyl butyrate, 1,3-dioxane, 1,4-dioxane, dimethoxyethane (DME), dimethyl sulfoxide, diethyl ether, methyl diglyme, acetonitrile, benzonitrile, tetrahydrofuran, sulfolane, and sultone can be used, or two or more of these solvents can be used in an appropriate combination in an appropriate ratio.

Alternatively, the use of one or more kinds of ionic liquids (room temperature molten salts) which have features of non-flammability and non-volatility as the solvent of the electrolyte solution can prevent a power storage device from exploding, catching fire, and the like even when the power storage device internally shorts out or the internal temperature increases owing to overcharging or the like. An ionic liquid contains a cation and an anion, specifically, an organic cation and an anion. Examples of the organic cation used for the electrolyte solution include aliphatic onium cations such as a quaternary ammonium cation, a tertiary sulfonium cation, and a quaternary phosphonium cation, and aromatic cations such as an imidazolium cation and a pyridinium cation. Examples of the anion used for the electrolyte solution include a monovalent amide-based anion, a monovalent methide-based anion, a fluorosulfonate anion, a perfluoroalkylsulfonate anion, a tetrafluoroborate anion, a perfluoroalkylborate anion, a hexafluorophosphate anion, and a perfluoroalkylphosphate anion.

As the electrolyte dissolved in the above-described solvent, one of lithium salts such as LiPF₆, LiClO₄, LiAsF₆, LiBF₄, LiAlCl₄, LiSCN, LiBr, LiI, Li₂SO₄, Li₂B₁₀Cl₁₀, Li₂B₁₂Cl₁₂, LiCF₃SO₃, LiC₄F₉SO₃, LiC(CF₃SO₂)₃, LiC(C₂FsSO₂)₃, LiN(CF₃SO₂)₂, LiN(C₄F₉SO₂)(CF₃SO₂), LiN(C₂F₅SO₂)₂, and lithium bis(oxalate) borate (Li(C₂O₄)₂, LiBOB) can be used, or two or more of these lithium salts can be used in an appropriate combination in an appropriate ratio.

The electrolyte solution used for the power storage device is preferably highly purified and contains a small amount of dust particles and elements other than the constituent elements of the electrolyte solution (hereinafter also simply referred to as “impurities”). Specifically, the weight ratio of impurities to the electrolyte solution is preferably less than or equal to 1%, further preferably less than or equal to 0.1%, still further preferably less than or equal to 0.01%.

Furthermore, an additive agent such as vinylene carbonate, propane sultone (PS), tert-butylbenzene (TBB), fluoroethylene carbonate (FEC), lithium bis(oxalate) borate (LiBOB), or a dinitrile compound like succinonitrile or adiponitrile may be added to the electrolyte solution. The concentration of such an additive agent in the whole solvent is, for example, higher than or equal to 0.1 wt % and lower than or equal to 5 wt %.

Alternatively, a polymer gel electrolyte obtained in such a manner that a polymer is swelled with an electrolyte solution may be used.

When a polymer gel electrolyte is used, safety against liquid leakage and the like is improved. Moreover, the secondary battery can be thinner and more lightweight.

As a polymer that undergoes gelation, a silicone gel, an acrylic gel, an acrylonitrile gel, a polyethylene oxide-based gel, a polypropylene oxide-based gel, a fluorine-based polymer gel, or the like can be used. For example, a polymer having a polyalkylene oxide structure, such as polyethylene oxide (PEO), PVDF, polyacrylonitrile, or a copolymer containing any of them can be used. For example, PVDF-HFP, which is a copolymer of PVDF and hexafluoropropylene (HFP), can be used. The formed polymer may be porous.

Instead of the electrolyte solution, a solid electrolyte including an inorganic material such as a sulfide-based or oxide-based inorganic material, and a solid electrolyte including a polymer material such as a PEO (polyethylene oxide)-based polymer material may alternatively be used. When the solid electrolyte is used, a separator or a spacer is not necessary. Furthermore, the battery can be entirely solidified; therefore, there is no possibility of liquid leakage and thus the safety is dramatically improved.

Accordingly, the positive electrode active material 100 obtained in Embodiment 1 can also be applied to all-solid-state batteries. By using the positive electrode slurry or the electrode in an all-solid-state battery, an all-solid-state battery with a high degree of safety and favorable characteristics can be obtained.

### [Exterior Body]

For the exterior body included in the secondary battery, a metal material such as aluminum or a resin material can be used, for example. A film-like exterior body can also be used. As the film, for example, it is possible to use a film having a three-layer structure in which a highly flexible metal thin film of aluminum, stainless steel, copper, nickel, or the like is provided over a film formed of polyethylene, polypropylene, polycarbonate, ionomer, polyamide, or the like and an insulating synthetic resin film of a polyamide-based resin, a polyester-based resin, or the like is provided over the metal thin film as the outer surface of the exterior body.

This embodiment can be used in combination with the other embodiments.

### Embodiment 4

This embodiment will describe examples of shapes of several types of secondary batteries including a positive electrode or a negative electrode formed by the manufacturing method described in the foregoing embodiment.

### [Coin-Type Secondary Battery]

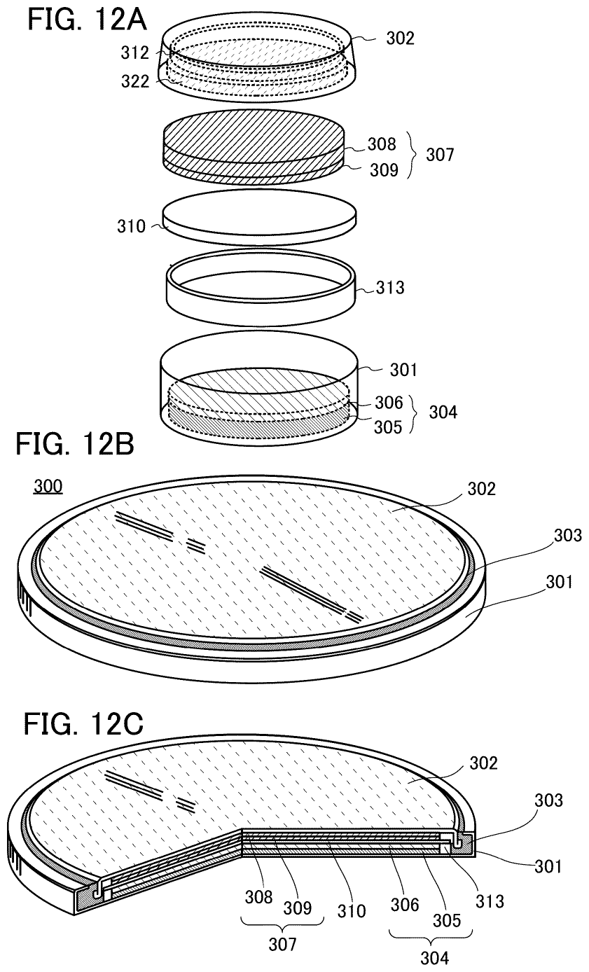

An example of a coin-type secondary battery will be described. FIG. 12A is an exploded perspective view of a coin-type (single-layer flat) secondary battery, FIG. 12B is an external view, and FIG. 12C is a cross-sectional view thereof. Coin-type secondary batteries are mainly used in small electronic devices. In this specification and the like, coin-type batteries include button-type batteries.

FIG. 12A is a schematic view showing overlap (a vertical relation and a positional relation) between components. Thus, FIG. 12A and FIG. 12B do not completely correspond with each other.

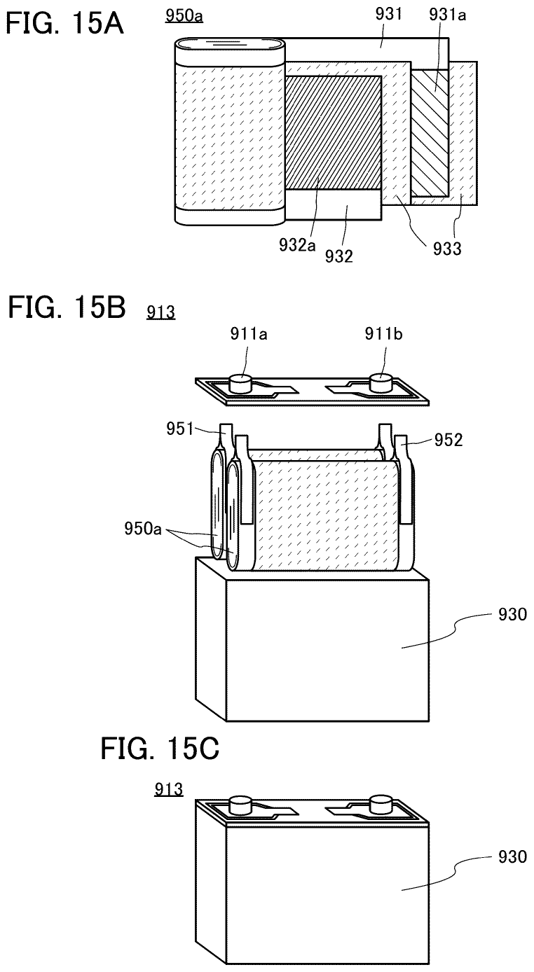

In FIG. 12A, a positive electrode 304, a separator 310, a negative electrode 307, a spacer 322, and a washer 312 are overlaid. They are sealed with a negative electrode can 302 and a positive electrode can 301. Note that a gasket for sealing is not illustrated in FIG. 15A. The spacer 322 and the washer 312 are used to protect the inside or fix the position of the components inside the cans at the time when the positive electrode can 301 and the negative electrode can 302 are bonded with pressure. For the spacer 322 and the washer 312, stainless steel or an insulating material is used.

The positive electrode 304 is a stack in which a positive electrode active material layer 306 is formed over a positive electrode current collector 305.

To prevent a short circuit between the positive electrode and the negative electrode, the separator 310 and a ring-shaped insulator 313 are provided to cover the side surface and top surface of the positive electrode 304. The separator 310 has a larger flat surface area than the positive electrode 304.

FIG. 12B is a perspective view of a completed coin-type secondary battery.

In a coin-type secondary battery 300, the positive electrode can 301 doubling as a positive electrode terminal and the negative electrode can 302 doubling as a negative electrode terminal are insulated from each other and sealed by a gasket 303 made of polypropylene or the like. The positive electrode 304 includes the positive electrode current collector 305 and the positive electrode active material layer 306 provided in contact with the positive electrode current collector 305. The negative electrode 307 includes a negative electrode current collector 308 and a negative electrode active material layer 309 provided in contact with the negative electrode current collector 308. The negative electrode 307 is not limited to having a stacked-layer structure, and lithium metal foil or lithium-aluminum alloy foil may be used.

Note that only one surface of each of the positive electrode 304 and the negative electrode 307 used for the coin-type secondary battery 300 is provided with an active material layer.

For the positive electrode can 301 and the negative electrode can 302, a metal having corrosion resistance to an electrolyte solution, such as nickel, aluminum, or titanium, an alloy of such a metal, or an alloy of such a metal and another metal (e.g., stainless steel) can be used. The positive electrode can 301 and the negative electrode can 302 are preferably covered with nickel, aluminum, or the like in order to prevent corrosion due to the electrolyte solution, for example. The positive electrode can 301 and the negative electrode can 302 are electrically connected to the positive electrode 304 and the negative electrode 307, respectively.

The negative electrode 307, the positive electrode 304, and the separator 310 are immersed in the electrolyte solution. Then, as illustrated in FIG. 12C, the positive electrode 304, the separator 310, the negative electrode 307, and the negative electrode can 302 are stacked in this order with the positive electrode can 301 positioned at the bottom, and the positive electrode can 301 and the negative electrode can 302 are bonded with pressure with the gasket 303 therebetween. In this manner, the coin-type secondary battery 300 is manufactured.

When the secondary battery includes the positive electrode active material described in the above embodiment, the coin-type secondary battery 300 with high charge and discharge capacity and excellent charge and discharge cycle performance can be obtained. Note that in the case of a secondary battery, the separator 310 is not necessarily provided between the negative electrode 307 and the positive electrode 304.

### [Cylindrical Secondary Battery]

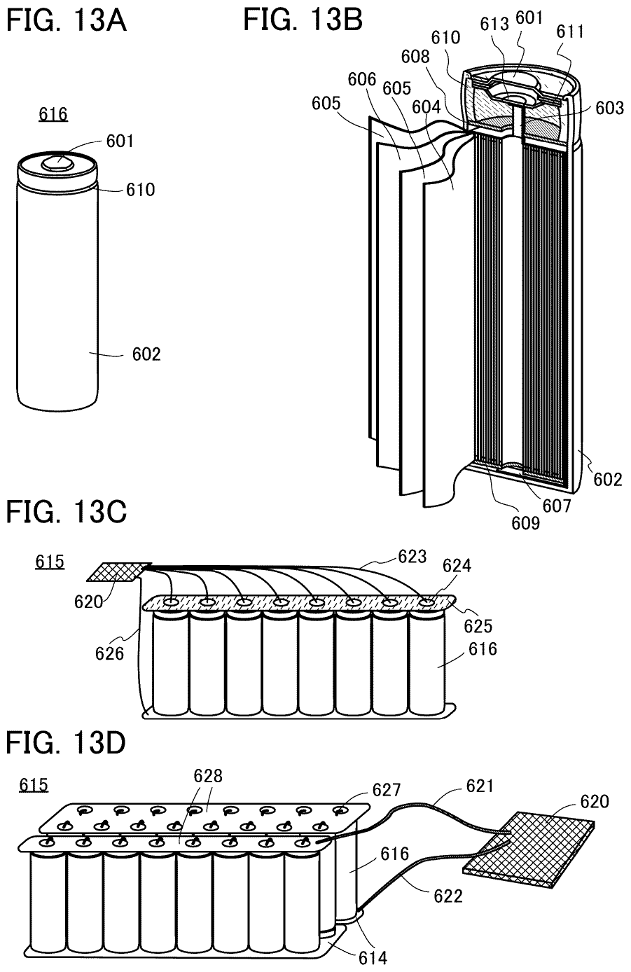

An example of a cylindrical secondary battery is described with reference to FIG. 13A. As illustrated in FIG. 13A, a cylindrical secondary battery 616 includes a positive electrode cap (battery cap) 601 on the top surface and a battery can (outer can) 602 on the side surface and bottom surface. The positive electrode cap 601 and the battery can (outer can) 602 are insulated from each other by a gasket (insulating gasket) 610.

FIG. 13B schematically illustrates a cross section of a cylindrical secondary battery. The cylindrical secondary battery illustrated in FIG. 13B includes the positive electrode cap (battery cap) 601 on the top surface and the battery can (outer can) 602 on the side and bottom surfaces. The positive electrode cap and the battery can (outer can) 602 are insulated from each other by the gasket (insulating gasket) 610.

Inside the battery can 602 having a hollow cylindrical shape, a battery element in which a strip-like positive electrode 604 and a strip-like negative electrode 606 are wound with a strip-like separator 605 located therebetween is provided. Although not illustrated, the battery element is wound around the central axis. One end of the battery can 602 is close and the other end thereof is open. For the battery can 602, a metal having corrosion resistance to an electrolyte solution, such as nickel, aluminum, or titanium, an alloy of such a metal, or an alloy of such a metal and another metal (e.g., stainless steel) can be used. The battery can 602 is preferably covered with nickel, aluminum, or the like in order to prevent corrosion due to the electrolyte solution. Inside the battery can 602, the battery element in which the positive electrode, the negative electrode, and the separator are wound is provided between a pair of insulating plates 608 and 609 that face each other. The inside of the battery can 602 provided with the battery element is filled with a nonaqueous electrolyte solution (not illustrated). As the nonaqueous electrolyte solution, an electrolyte solution similar to that for the coin-type secondary battery can be used.

Since a positive electrode and a negative electrode that are used for a cylindrical storage battery are wound, active materials are preferably formed on both surfaces of a current collector. Although FIGS. 13A to 13D each illustrate the secondary battery 616 in which the height of the cylinder is larger than the diameter of the cylinder, one embodiment of the present invention is not limited thereto. In a secondary battery, the diameter of the cylinder may be larger than the height of the cylinder. Such a structure can reduce the size of a secondary battery, for example.

The positive electrode active material 100 obtained in Embodiment 1 is used in the positive electrode 604, whereby the cylindrical secondary battery 616 can have high capacity, high charge and discharge capacity and excellent charge and discharge cycle performance.

A positive electrode terminal (positive electrode current collecting lead) 603 is connected to the positive electrode 604, and a negative electrode terminal (negative electrode current collecting lead) 607 is connected to the negative electrode 606. Both the positive electrode terminal 603 and the negative electrode terminal 607 can be formed using a metal material such as aluminum. The positive electrode terminal 603 and the negative electrode terminal 607 are resistance-welded to a safety valve mechanism 613 and the bottom of the battery can 602, respectively. The safety valve mechanism 613 is electrically connected to the positive electrode cap 601 through a PTC element (positive temperature coefficient) 611. The safety valve mechanism 613 cuts off electrical connection between the positive electrode cap 601 and the positive electrode 604 when the internal pressure of the battery exceeds a predetermined threshold. The PTC element 611, which is a thermally sensitive resistor whose resistance increases as temperature rises, limits the amount of current by increasing the resistance, in order to prevent abnormal heat generation. Barium titanate (BaTiO₃)-based semiconductor ceramic or the like can be used for the PTC element.

FIG. 13C illustrates an example of a power storage system 615. The power storage system 615 includes a plurality of secondary batteries 616. The positive electrodes of the secondary batteries are in contact with and electrically connected to conductors 624 isolated by an insulator 625. The conductor 624 is electrically connected to a control circuit 620 through a wiring 623. The negative electrodes of the secondary batteries are electrically connected to the control circuit 620 through a wiring 626. As the control circuit 620, a protection circuit for preventing overcharge or overdischarge or the like can be used, for example.

FIG. 13D illustrates an example of the power storage system 615. The power storage system 615 includes a plurality of secondary batteries 616, and the plurality of secondary batteries 616 are sandwiched between a conductive plate 628 and a conductive plate 614. The plurality of secondary batteries 616 are electrically connected to the conductive plate 628 and the conductive plate 614 through a wiring 627. The plurality of secondary batteries 616 may be connected in parallel or connected in series; alternatively, the plurality of secondary batteries 616 may be connected in parallel and then connected in series. With the power storage system 615 including the plurality of secondary batteries 616, large electric power can be extracted.

The plurality of secondary batteries 616 may be connected in series after being connected in parallel.

A temperature control device may be provided between the plurality of secondary batteries 616. The secondary batteries 616 can be cooled with the temperature control device when overheated, whereas the secondary batteries 616 can be heated with the temperature control device when cooled too much. Thus, the performance of the power storage system 615 is less likely to be influenced by the outside temperature.

In FIG. 13D, the power storage system 615 is electrically connected to the control circuit 620 through a wiring 621 and a wiring 622. The wiring 621 is electrically connected to the positive electrodes of the plurality of secondary batteries 616 through the conductive plate 628. The wiring 622 is electrically connected to the negative electrodes of the plurality of secondary batteries 616 through the conductive plate 614.

### [Other Structure Examples of Secondary Battery]

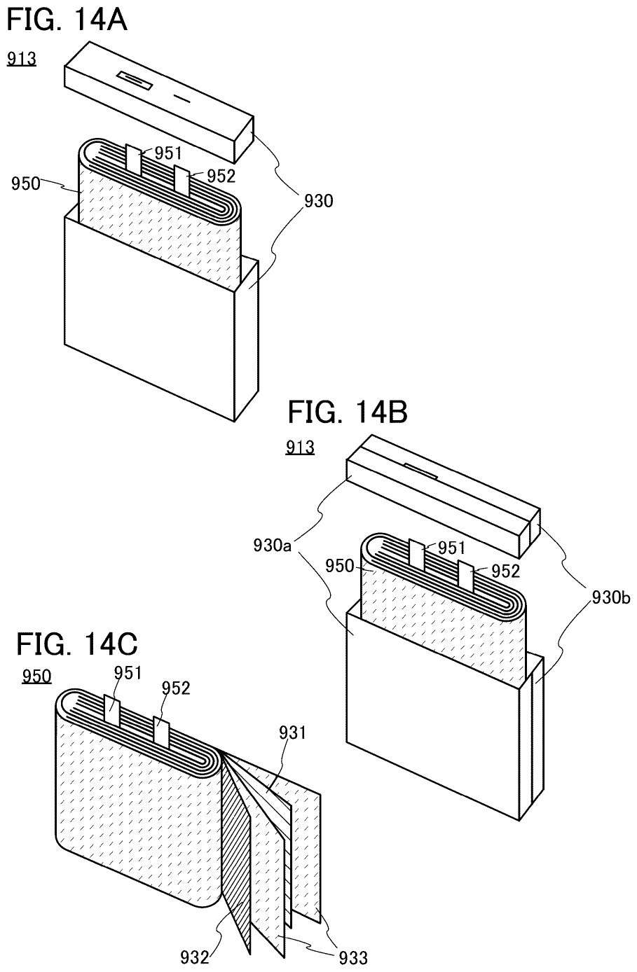

Structure examples of secondary batteries are described with reference to FIG. 14 and FIG. 15.

A secondary battery 913 illustrated in FIG. 14A includes a wound body 950 provided with a terminal 951 and a terminal 952 inside a housing 930. The wound body 950 is immersed in an electrolyte solution inside the housing 930. The terminal 952 is in contact with the housing 930. The use of an insulator or the like inhibits contact between the terminal 951 and the housing 930. Note that in FIG. 14A, the housing 930 divided into two pieces is illustrated for convenience; however, in the actual structure, the wound body 950 is covered with the housing 930, and the terminal 951 and the terminal 952 extend to the outside of the housing 930. For the housing 930, a metal material (e.g., aluminum) or a resin material can be used.

Note that as illustrated in FIG. 14B, the housing 930 in FIG. 14A may be formed using a plurality of materials. For example, in the secondary battery 913 in FIG. 14B, a housing 930a and a housing 930b are attached to each other, and the wound body 950 is provided in a region surrounded by the housing 930a and the housing 930b.

For the housing 930a, an insulating material such as an organic resin can be used. In particular, when a material such as an organic resin is used for the side on which an antenna is formed, blocking of an electric field by the secondary battery 913 can be inhibited. When an electric field is not significantly blocked by the housing 930a, an antenna may be provided inside the housing 930a. For the housing 930b, a metal material can be used, for example.

FIG. 14C illustrates the structure of the wound body 950. The wound body 950 includes a negative electrode 931, a positive electrode 932, and separators 933. The wound body 950 is obtained by winding a sheet of a stack in which the negative electrode 931 and the positive electrode 932 overlap with the separator 933 therebetween. Note that a plurality of stacks each including the negative electrode 931, the positive electrode 932, and the separators 933 may be overlaid.

As illustrated in FIG. 15, the secondary battery 913 may include a wound body 950a. The wound body 950a illustrated in FIG. 15A includes the negative electrode 931, the positive electrode 932, and the separators 933. The negative electrode 931 includes a negative electrode active material layer 931a. The positive electrode 932 includes a positive electrode active material layer 932a.

The positive electrode active material 100 obtained in Embodiment 1 is used in the positive electrode 932, whereby the secondary battery 913 can have high capacity, high charge and discharge capacity, and excellent charge and discharge cycle performance.

The separator 933 has a larger width than the negative electrode active material layer 931a and the positive electrode active material layer 932a, and is wound to overlap the negative electrode active material layer 931a and the positive electrode active material layer 932a. In terms of safety, the width of the negative electrode active material layer 931a is preferably larger than that of the positive electrode active material layer 932a. The wound body 950a having such a shape is preferable because of its high degree of safety and high productivity.

As illustrated in FIG. 15B, the negative electrode 931 is electrically connected to the terminal 951. The terminal 951 is electrically connected to a terminal 911a. The positive electrode 932 is electrically connected to the terminal 952. The terminal 952 is electrically connected to a terminal 911b.

As illustrated in FIG. 15C, the wound body 950a and an electrolyte solution are covered with the housing 930, whereby the secondary battery 913 is completed. The housing 930 is preferably provided with a safety valve, an overcurrent protection element, and the like. A safety valve is a valve to be released by a predetermined internal pressure of the housing 930 in order to prevent the battery from exploding.

As illustrated in FIG. 15B, the secondary battery 913 may include a plurality of wound bodies 950a. The use of the plurality of wound bodies 950a enables the secondary battery 913 to have higher charge and discharge capacity. The description of the secondary battery 913 in FIG. 14A to FIG. 14C can be referred to for the other components of the secondary battery 913 in FIG. 15A and FIG. 15B.

### <Laminated Secondary Battery>

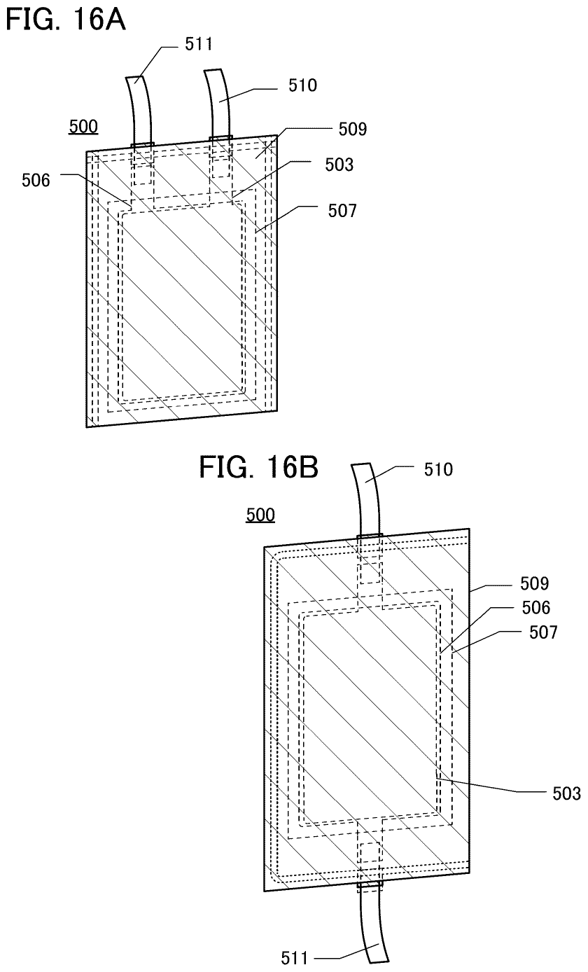

Next, examples of the appearance of a laminated secondary battery are shown in FIG. 16A and FIG. 16B. FIG. 16A and FIG. 16B each illustrate a positive electrode 503, a negative electrode 506, a separator 507, an exterior body 509, a positive electrode lead electrode 510, and a negative electrode lead electrode 511.

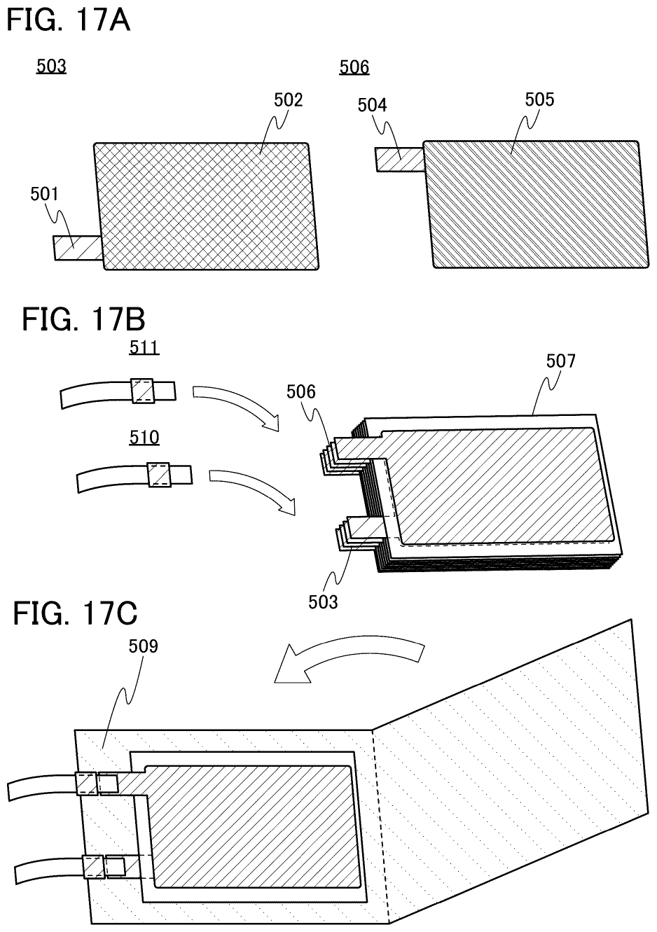

FIG. 17A illustrates the appearance of the positive electrode 503 and the negative electrode 506. The positive electrode 503 includes a positive electrode current collector 501, and a positive electrode active material layer 502 is formed on a surface of the positive electrode current collector 501. The positive electrode 503 also includes a region where the positive electrode current collector 501 is partly exposed (hereinafter referred to as a tab region). The negative electrode 506 includes a negative electrode current collector 504, and a negative electrode active material layer 505 is formed on a surface of the negative electrode current collector 504. The negative electrode 506 also includes a region where the negative electrode current collector 504 is partly exposed, that is, a tab region. The areas and the shapes of the tab regions included in the positive electrode and the negative electrode are not limited to those illustrated in FIG. 17A.

### <Method for Manufacturing Laminated Secondary Battery>

Here, an example of a method for manufacturing the laminated secondary battery having the appearance illustrated in FIG. 16A will be described with reference to FIG. 17B and FIG. 17C.

First, the negative electrode 506, the separator 507, and the positive electrode 503 are stacked. FIG. 17B illustrates the negative electrodes 506, the separators 507, and the positive electrodes 503 that are stacked. Here, an example in which 5 negative electrodes and 4 positive electrodes are used is shown. The component at this stage can also be referred to as a stack including the negative electrodes, the separators, and the positive electrodes. Next, the tab regions of the positive electrodes 503 are bonded to each other, and the positive electrode lead electrode 510 is bonded to the tab region of the positive electrode on the outermost surface. The bonding can be performed by ultrasonic welding, for example. In a similar manner, the tab regions of the negative electrodes 506 are bonded to each other, and the negative electrode lead electrode 511 is bonded to the tab region of the negative electrode on the outermost surface.

Then, the negative electrodes 506, the separators 507, and the positive electrodes 503 are placed over the exterior body 509.

Subsequently, the exterior body 509 is folded along a dashed line as illustrated in FIG. 17C. Then, the outer edges of the exterior body 509 are bonded to each other. The bonding can be performed by thermocompression, for example. At this time, a part (or one side) of the exterior body 509 is left unbonded (such part is hereinafter referred to as an inlet) so that an electrolyte solution can be introduced later.

Next, the electrolyte solution (not illustrated) is introduced into the exterior body 509 from the inlet of the exterior body 509. The electrolyte solution is preferably introduced in a reduced pressure atmosphere or in an inert atmosphere. Lastly, the inlet is sealed by bonding. In this manner, the laminated secondary battery 500 can be manufactured.

The positive electrode active material 100 obtained in Embodiment 1 is used in the positive electrodes 503, whereby the secondary battery 500 can have high capacity, high charge and discharge capacity, and excellent charge and discharge cycle performance.

### [Examples of Battery Pack]

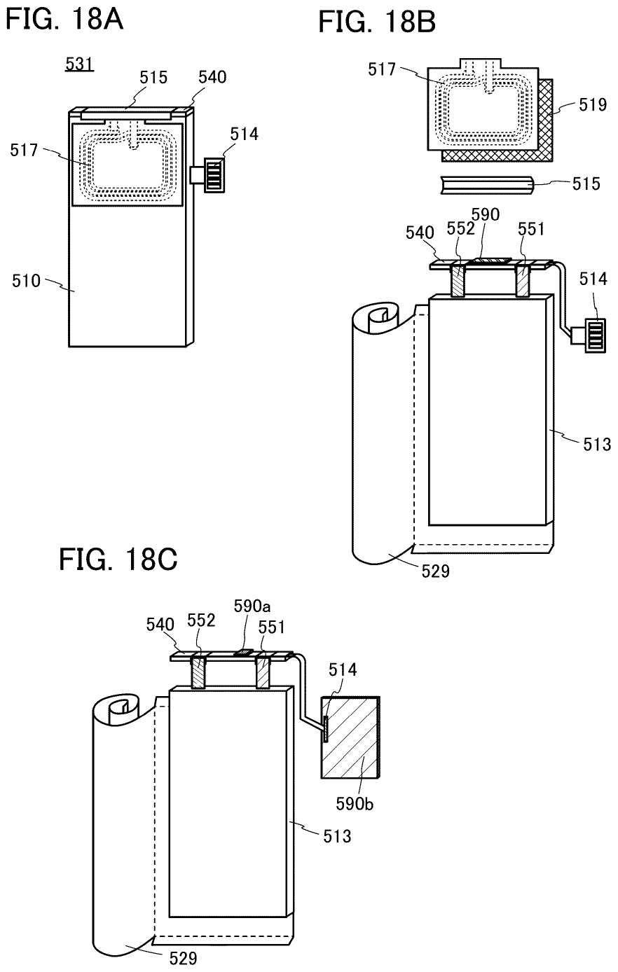

Examples of a secondary battery pack of one embodiment of the present invention that is capable of wireless charging using an antenna will be described with reference to FIG. 18.

FIG. 18A illustrates the appearance of a secondary battery pack 531 that has a rectangular solid shape with a small thickness (also referred to as a flat plate shape with a certain thickness). FIG. 18B illustrates the structure of the secondary battery pack 531. The secondary battery pack 531 includes a circuit board 540 and a secondary battery 513. A label 529 is attached to the secondary battery 513. The circuit board 540 is fixed by a sealant 515. The secondary battery pack 531 also includes an antenna 517.

As for the internal structure of the secondary battery 513, the secondary battery 513 may include a wound body or a stack.

In the secondary battery pack 531, a control circuit 590 is provided over the circuit board 540 as illustrated in FIG. 18B, for example. The circuit board 540 is electrically connected to a terminal 514. The circuit board 540 is electrically connected to the antenna 517 and a lead 551 and a lead 552 of the secondary battery 513. The lead 551 functions as one of the positive electrode lead and the negative electrode lead of the secondary battery 513, and the lead 552 functions as the other of the positive electrode lead and the negative electrode lead.

Alternatively, as illustrated in FIG. 18C, a circuit system 590a provided over the circuit board 540 and a circuit system 590b electrically connected to the circuit board 540 through the terminal 514 may be included.

Note that the shape of the antenna 517 is not limited to a coil shape and may be a linear shape or a plate shape, for example. Furthermore, a planar antenna, an aperture antenna, a traveling-wave antenna, an EH antenna, a magnetic-field antenna, a dielectric antenna, or the like may be used. Alternatively, the antenna 517 may be a flat-plate conductor. The flat-plate conductor can serve as one of conductors for electric field coupling. That is, the antenna 517 can function as one of two conductors of a capacitor. Thus, electric power can be transmitted and received not only by an electromagnetic field or a magnetic field but also by an electric field. The secondary battery pack 531 includes a layer 519 between the antenna 517 and the secondary battery 513. The layer 519 has a function of blocking an electromagnetic field from the secondary battery 513, for example. As the layer 519, a magnetic material can be used, for example.

This embodiment can be freely combined with the other embodiments.

### Embodiment 5

This embodiment will describe an example in which an all-solid-state battery is manufactured using the positive electrode active material 100 obtained in Embodiment 1.

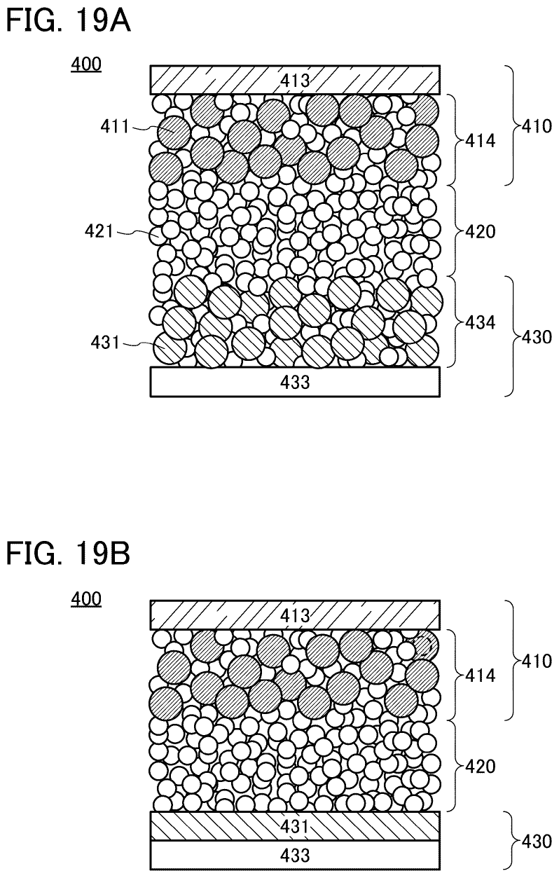

As illustrated in FIG. 19A, a secondary battery 400 of one embodiment of the present invention includes a positive electrode 410, a solid electrolyte layer 420, and a negative electrode 430.

The positive electrode 410 includes a positive electrode current collector 413 and a positive electrode active material layer 414. The positive electrode active material layer 414 includes a positive electrode active material 411 and a solid electrolyte 421. The positive electrode active material 100 obtained in Embodiment 1 is used as the positive electrode active material 411, and the boundary between the core region and the shell region is indicated by a dotted line. The positive electrode active material layer 414 may also include a conductive material and a binder.

The solid electrolyte layer 420 includes the solid electrolyte 421. The solid electrolyte layer 420 is positioned between the positive electrode 410 and the negative electrode 430 and is a region that includes neither the positive electrode active material 411 nor a negative electrode active material 431.

The negative electrode 430 includes a negative electrode current collector 433 and a negative electrode active material layer 434. The negative electrode active material layer 434 includes the negative electrode active material 431 and the solid electrolyte 421. The negative electrode active material layer 434 may also include a conductive material and a binder. Note that when metal lithium is used for the negative electrode 430, the negative electrode 430 that does not include the solid electrolyte 421 can be formed, as illustrated in FIG. 19B. The use of metal lithium for the negative electrode 430 is preferable, in which case the energy density of the secondary battery 400 can be increased.

As the solid electrolyte 421 included in the solid electrolyte layer 420, a sulfide-based solid electrolyte, an oxide-based solid electrolyte, or a halide-based solid electrolyte can be used, for example.

Examples of the sulfide-based solid electrolyte include a thio-silicon-based material (e.g., Li₁₀GeP₂S₁₂ and Li_{3.25}Ge_{0.25}P_{0.75}S₄), sulfide glass (e.g., 70Li₂S·30P₂S₅, 30Li₂S·26B₂S₃·44LiI, 63Li₂S·38SiS₂·1Li₃PO₄, 57Li₂S·38SiS₂·5Li₄SiO₄, and 50Li₂S·50GeS₂), and sulfide-based crystallized glass (e.g., Li₇P₃S₁₁ and Li_{3.25}P_{0.95}S₄). The sulfide-based solid electrolyte has advantages such as high conductivity of some materials, low-temperature synthesis, and ease of maintaining a path for electrical conduction after charging and discharging because of its relative softness.

Examples of the oxide-based solid electrolyte include a material with a perovskite crystal structure (e.g., La_{2/3-x}Li₃ₓTiO₃), a material with a NASICON crystal structure (e.g., Li_{1-Y}Al_{Y}Ti_{2-Y}(PO₄)₃), a material with a garnet crystal structure (e.g., Li₇La₃Zr₂O₁₂), a material with a LISICON crystal structure (e.g., Li₁₄ZnGe₄O₁₆), LLZO (Li₇La₃Zr₂O₁₂), oxide glass (e.g., Li₃PO₄—Li₄SiO₄ and 50Li₄SiO₄·50Li₃BO₃), and oxide-based crystallized glass (e.g., Li_{1.07}Al_{0.69}Ti_{1.46}(PO₄)₃ and Li_{1.5}Al_{0.5}Ge_{1.5}(PO₄)₃). The oxide-based solid electrolyte has an advantage of stability in the air.

Examples of the halide-based solid electrolyte include LiAlCl₄, Li₃InBr₆, LiF, LiCl, LiBr, and LiI. Moreover, a composite material in which pores of porous aluminum oxide or porous silica are filled with such a halide-based solid electrolyte can be used as the solid electrolyte.

Alternatively, different solid electrolytes may be mixed and used.

In particular, Li₁₊ₓAlₓTi₂₋ₓ(PO₄)₃ (0 [x [1) having a NASICON crystal structure (hereinafter LATP) is preferable because LATP contains aluminum and titanium, each of which is the element the positive electrode active material used in the secondary battery 400 of one embodiment of the present invention is allowed to contain, and thus a synergistic effect of improving the charge and discharge cycle performance is expected. Moreover, higher productivity due to the reduction in the number of steps is expected. Note that in this specification and the like, a material having a NASICON crystal structure refers to a compound that is represented by M₂(XO₄)₃ (M: transition metal; X: S, P, As, Mo, W, or the like) and has a structure in which MO₆ octahedra and XO₄ tetrahedra that share common corners are arranged three-dimensionally.

### [Exterior Body and Shape of Secondary Battery]

An exterior body of the secondary battery 400 of one embodiment of the present invention can employ a variety of materials and have a variety of shapes, and preferably has a function of applying pressure to the positive electrode, the solid electrolyte layer, and the negative electrode.

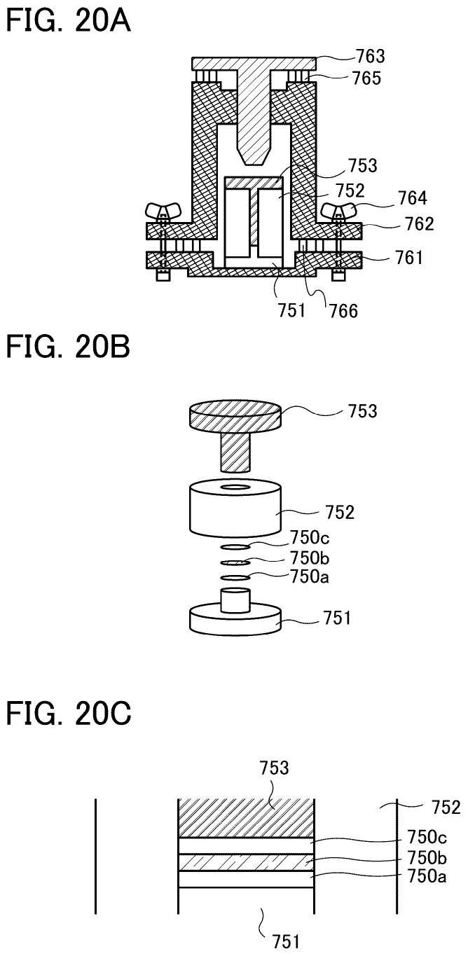

FIG. 20 show an example of a cell for evaluating materials of an all-solid-state battery.

FIG. 20A is a schematic cross-sectional view of the evaluation cell. The evaluation cell includes a lower component 761, an upper component 762, and a fixation screw or a butterfly nut 764 for fixing these components. By rotating a pressure screw 763, an electrode plate 753 is pressed to fix an evaluation material. An insulator 766 is provided between the lower component 761 and the upper component 762 that are made of a stainless steel material. An O ring 765 for hermetic sealing is provided between the upper component 762 and the pressure screw 763.

The evaluation material is placed on an electrode plate 751, surrounded by an insulating tube 752, and pressed from above by the electrode plate 753. FIG. 20B is an enlarged perspective view of the evaluation material and its vicinity.

A stack of a positive electrode 750a, a solid electrolyte layer 750b, and a negative electrode 750c is shown here as an example of the evaluation material, and its cross section is shown in FIG. 20C. Note that the same portions in FIG. 20A to FIG. 20C are denoted by the same reference numerals.

The electrode plate 751 and the lower component 761 that are electrically connected to the positive electrode 750a correspond to a positive electrode terminal. The electrode plate 753 and the upper component 762 that are electrically connected to the negative electrode 750c correspond to a negative electrode terminal. The electric resistance or the like can be measured while pressure is applied to the evaluation material through the electrode plate 751 and the electrode plate 753.

The exterior body of the secondary battery of one embodiment of the present invention is preferably a package having excellent airtightness. For example, a ceramic package or a resin package can be used. The exterior body is sealed preferably in a closed atmosphere where the outside air is blocked, for example, in a glove box.

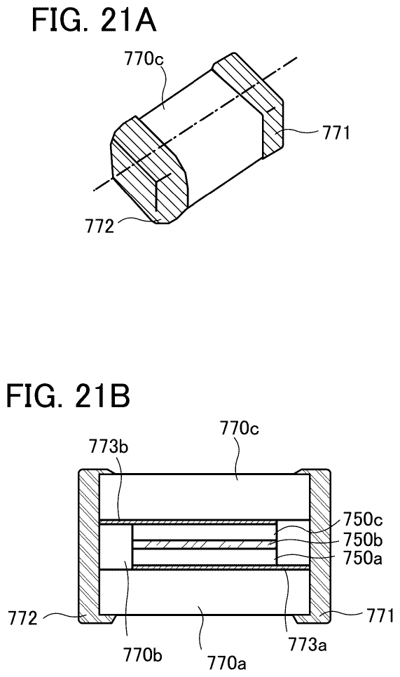

FIG. 21A is a perspective view of a secondary battery of one embodiment of the present invention that has an exterior body and a shape different from those in FIG. 20. The secondary battery in FIG. 21A includes an external electrode 771 and an external electrode 772 and is sealed with an exterior body including a plurality of package components.

FIG. 21B shows an example of a cross section along the dashed-dotted line in FIG. 21A. A stack including the positive electrode 750a, the solid electrolyte layer 750b, and the negative electrode 750c is surrounded and sealed by a package component 770a including an electrode layer 773a on a flat plate, a frame-like package component 770b, and a package component 770c including an electrode layer 773b on a flat plate. For the package components 770a, 770b, and 770c, an insulating material such as a resin material or ceramic can be used.

The external electrode 771 is electrically connected to the positive electrode 750a through the electrode layer 773a and functions as a positive electrode terminal. The external electrode 772 is electrically connected to the negative electrode 750c through the electrode layer 773b and functions as a negative electrode terminal.

The use of the positive electrode active material 100 obtained in Embodiment 1 achieves an all-solid-state secondary battery having high energy density and favorable output characteristics.

This embodiment can be implemented in appropriate combination with any of the other embodiments.

### Embodiment 6

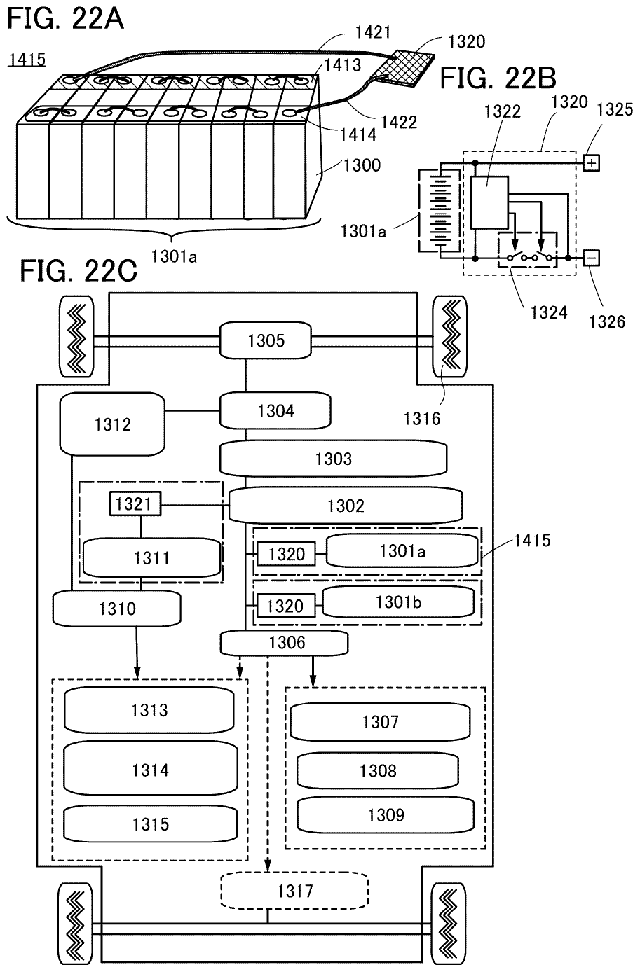

In this embodiment, an example of application to an electric vehicle (EV) will be described with reference to FIG. 22C which is an example different from the cylindrical secondary battery in FIG. 13D.

The electric vehicle is provided with first batteries 1301a and 1301b as main secondary batteries for driving and a second battery 1311 that supplies electric power to an inverter 1312 for starting a motor 1304. The second battery 1311 is also referred to as a cranking battery (also referred to as a starter battery). The second battery 1311 needs high output and high capacity is not so necessary, and the capacity of the second battery 1311 is lower than that of the first batteries 1301a and 1301b.

The internal structure of the first battery 1301a may be the wound structure illustrated in FIG. 14A or FIG. 15C or the stacked structure illustrated in FIG. 16A or FIG. 16B. Alternatively, the first battery 1301a may be the all-solid-state battery in Embodiment 5. Using the all-solid-state battery in Embodiment 5 as the first battery 1301a achieves high capacity, a high degree of safety, reduction in size, and reduction in weight.

Although this embodiment describes an example in which two first batteries 1301a and 1301b are connected in parallel, three or more first batteries may be connected in parallel. When the first battery 1301a is capable of storing sufficient electric power, the first battery 1301b may be omitted. With a battery pack including a plurality of secondary batteries, large electric power can be extracted. The plurality of secondary batteries may be connected in parallel, connected in series, or connected in series after being connected in parallel. The plurality of secondary batteries can also be referred to as an assembled battery.

An in-vehicle secondary battery includes a service plug or a circuit breaker that can cut off high voltage without the use of equipment in order to cut off electric power from a plurality of secondary batteries. The first battery 1301a is provided with such a service plug or a circuit breaker.

Electric power from the first batteries 1301a and 1301b is mainly used to rotate the motor 1304 and is also supplied to in-vehicle parts for 42 V (such as an electric power steering 1307, a heater 1308, and a defogger 1309) through a DC-DC circuit 1306. In the case where there is a rear motor 1317 for the rear wheels, the first battery 1301a is used to rotate the rear motor 1317.

The second battery 1311 supplies electric power to in-vehicle parts for 14 V (such as an audio 1313, power windows 1314, and lamps 1315) through a DC-DC circuit 1310.

The first battery 1301a will be described with reference to FIG. 22A.

FIG. 22A shows an example in which nine rectangular secondary batteries 1300 form one battery pack 1415. The nine rectangular secondary batteries 1300 are connected in series; one electrode of each battery is fixed by a fixing portion 1413 made of an insulator, and the other electrode of each battery is fixed by a fixing portion 1414 made of an insulator. Although this embodiment shows the example in which the secondary batteries are fixed by the fixing portions 1413 and 1414, they may be stored in a battery container box (also referred to as a housing). Since a vibration or a jolt is assumed to be given to the vehicle from the outside (e.g., a road surface), the plurality of secondary batteries are preferably fixed by the fixing portions 1413 and 1414 and a battery container box, for example. Furthermore, the one electrode of each battery is electrically connected to a control circuit portion 1320 through a wiring 1421. The other electrode of each battery is electrically connected to the control circuit portion 1320 through a wiring 1422.

The control circuit portion 1320 may include a memory circuit including a transistor using an oxide semiconductor. A charge control circuit or a battery control system that includes a memory circuit including a transistor using an oxide semiconductor may be referred to as a BTOS (Battery operating system or Battery oxide semiconductor).

A metal oxide functioning as an oxide semiconductor is preferably used. For example, as the oxide, a metal oxide such as an In-M-Zn oxide (the element Mis one or more selected from aluminum, gallium, yttrium, copper, vanadium, beryllium, boron, titanium, iron, nickel, germanium, zirconium, molybdenum, lanthanum, cerium, neodymium, hafnium, tantalum, tungsten, magnesium, and the like) is preferably used. In particular, the In-M-Zn oxide that can be used as the oxide is preferably a CAAC-OS (C-AxIs Aligned Crystal Oxide Semiconductor) or a CAC-OS (Cloud-Aligned Composite Oxide Semiconductor). Alternatively, an In—Ga oxide or an In—Zn oxide may be used as the oxide. The CAAC-OS is an oxide semiconductor that has a plurality of crystal regions each of which has c-axis alignment in a particular direction. Note that the particular direction refers to the thickness direction of a CAAC-OS film, the normal direction of the surface where the CAAC-OS film is formed, or the normal direction of the surface of the CAAC-OS film. The crystal region refers to a region having a periodic atomic arrangement. When an atomic arrangement is regarded as a lattice arrangement, the crystal region also refers to a region with a uniform lattice arrangement. The CAAC-OS has a region where a plurality of crystal regions are connected in the a-b plane direction, and the region has distortion in some cases. Note that distortion refers to a portion where the direction of a lattice arrangement changes between a region with a uniform lattice arrangement and another region with a uniform lattice arrangement in a region where a plurality of crystal regions are connected. That is, the CAAC-OS is an oxide semiconductor having c-axis alignment and having no clear alignment in the a-b plane direction. In addition, the CAC-OS refers to one composition of a material in which elements constituting a metal oxide are unevenly distributed with a size greater than or equal to 0.5 nm and less than or equal to 10 nm, preferably greater than or equal to 1 nm and less than or equal to 3 nm, or a similar size, for example. Note that a state in which one or more metal elements are unevenly distributed and regions including the metal element(s) are mixed with a size greater than or equal to 0.5 nm and less than or equal to 10 nm, preferably greater than or equal to 1 nm and less than or equal to 3 nm, or a similar size in a metal oxide is hereinafter referred to as a mosaic pattern or a patch-like pattern.

In addition, the CAC-OS has a composition in which materials are separated into a first region and a second region to form a mosaic pattern, and the first regions are distributed in the film (this composition is hereinafter also referred to as a cloud-like composition). That is, the CAC-OS is a composite metal oxide having a composition in which the first regions and the second regions are mixed.

Here, the ratios of the numbers of In, Ga, and Zn atoms to the metal elements contained in the CAC-OS in an In—Ga—Zn oxide are denoted by [In], [Ga], and [Zn], respectively. For example, the first region in the CAC-OS in the In—Ga—Zn oxide has [In] higher than [In] in the composition of the CAC-OS film. Moreover, the second region has [Ga] higher than [Ga] in the composition of the CAC-OS film. Alternatively, for example, the first region has [In] higher than [In] in the second region and [Ga] lower than [Ga] in the second region. Moreover, the second region has [Ga] higher than [Ga] in the first region and [In] lower than [In] in the first region.

Specifically, the first region is a region including indium oxide, indium zinc oxide, or the like as its main component. The second region is a region including gallium oxide, gallium zinc oxide, or the like as its main component. That is, the first region can be referred to as a region containing In as its main component. The second region can be referred to as a region containing Ga as its main component.

Note that a clear boundary between the first region and the second region cannot be observed in some cases.

For example, in EDX mapping obtained by energy dispersive X-ray spectroscopy (EDX), it is confirmed that the CAC-OS in the In—Ga—Zn oxide has a structure in which the region containing In as its main component (the first region) and the region containing Ga as its main component (the second region) are unevenly distributed and mixed.

In the case where the CAC-OS is used for a transistor, a switching function (on/off switching function) can be given to the CAC-OS owing to the complementary action of the conductivity derived from the first region and the insulating property derived from the second region. That is, the CAC-OS has a conducting function in part of the material and has an insulating function in another part of the material; as a whole, the CAC-OS has a function of a semiconductor. Separation of the conducting function and the insulating function can maximize each function. Thus, when the CAC-OS is used for a transistor, high on-state current (Iₒₙ), high field-effect mobility (μ), and favorable switching operation can be achieved.

An oxide semiconductor has various structures with different properties. Two or more kinds among the amorphous oxide semiconductor, the polycrystalline oxide semiconductor, the a-like OS, the CAC-OS, the nc-OS, and the CAAC-OS may be included in an oxide semiconductor of one embodiment of the present invention.

The control circuit portion 1320 preferably uses a transistor using an oxide semiconductor because the transistor using an oxide semiconductor can be used in a high-temperature environment. For the process simplicity, the control circuit portion 1320 may be formed using transistors of the same conductivity type. A transistor using an oxide semiconductor in its semiconductor layer has an operating ambient temperature range of −40° C. to 150° C. inclusive, which is wider than that of a single crystal Si transistor, and thus shows a smaller change in characteristics than the single crystal Si transistor when the secondary battery is heated. The off-state current of the transistor using an oxide semiconductor is lower than or equal to the lower measurement limit even at 150° C. regardless of the temperature. On the other hand, the off-state current characteristics of the single crystal Si transistor largely depend on the temperature. For example, at 150° C., the off-state current of the single crystal Si transistor increases, and a sufficiently high current on/off ratio cannot be obtained. The control circuit portion 1320 can improve the degree of safety. When the control circuit portion 1320 is used in combination with a secondary battery including a positive electrode using the positive electrode active material 100 obtained in Embodiment 1, the synergy on safety can be obtained.

The control circuit portion 1320 that uses a memory circuit including a transistor using an oxide semiconductor can also function as an automatic control device for the secondary battery to resolve ten items of causes of instability, such as a micro-short circuit. Examples of functions of resolving the ten items of causes of instability include prevention of overcharging, prevention of overcurrent, control of overheating during charging, maintenance of cell balance of an assembled battery, prevention of overdischarging, a battery indicator, automatic control of charge voltage and current amount according to temperature, control of the amount of charge current according to the degree of deterioration, abnormal behavior detection for a micro-short circuit, and anomaly prediction regarding a micro-short circuit. The control circuit portion 1320 has one or more selected from these functions. Furthermore, the automatic control device for the secondary battery can be extremely small in size.

A micro-short circuit refers to a minute short circuit caused in a secondary battery. A micro-short circuit refers to not a state where the positive electrode and the negative electrode of a secondary battery are short-circuited so that charging and discharging are impossible, but a phenomenon in which a slight short-circuit current flows through a minute short-circuit portion. Since a large voltage change is caused even when a micro-short circuit occurs in a relatively short time in a minute area, the abnormal voltage value might adversely affect estimation to be performed subsequently.

A cause of a micro-short circuit is a plurality of charging and discharging; an uneven distribution of positive electrode active materials leads to local concentration of current in part of the positive electrode and the negative electrode; and then part of a separator stops functioning or a by-product is generated by a side reaction, which is thought to generate a micro short-circuit.

It can be said that the control circuit portion 1320 not only detects a micro-short circuit but also senses a terminal voltage of the secondary battery and controls the charge and discharge state of the secondary battery. For example, to prevent overcharging, the control circuit portion 1320 can turn off an output transistor of a charging circuit and an interruption switch substantially at the same time.

FIG. 22B is an example of a block diagram of the battery pack 1415 illustrated in FIG. 22A.

The control circuit portion 1320 includes a switch portion 1324 that includes at least a switch for preventing overcharging and a switch for preventing overdischarging, a control circuit 1322 for controlling the switch portion 1324, and a portion for measuring the voltage of the first battery 1301a. The control circuit portion 1320 is set to have the upper limit voltage and the lower limit voltage of the secondary battery used, and controls the upper limit of current from the outside, the upper limit of output current to the outside, or the like. The range from the lower limit voltage to the upper limit voltage of the secondary battery is a recommended voltage range, and when a voltage is out of the range, the switch portion 1324 operates and functions as a protection circuit. The control circuit portion 1320 can also be referred to as a protection circuit because it controls the switch portion 1324 to prevent overdischarging and overcharging. For example, when the control circuit 1322 detects a voltage that is likely to cause overcharging, current is interrupted by turning off the switch in the switch portion 1324. Furthermore, a function of interrupting current in accordance with a temperature rise may be set by providing a PTC element in the charge and discharge path. The control circuit portion 1320 includes an external terminal 1325 (+IN) and an external terminal 1326 (−IN).

The switch portion 1324 can be formed by a combination of an n-channel transistor and a p-channel transistor. The switch portion 1324 is not limited to including a switch having a Si transistor using single crystal silicon; the switch portion 1324 may be formed using a power transistor containing Ge (germanium), SiGe (silicon germanium), GaAs (gallium arsenide), GaAlAs (gallium aluminum arsenide), InP (indium phosphide), SiC (silicon carbide), ZnSe (zinc selenide), GaN (gallium nitride), GaO, (gallium oxide; x is a real number greater than 0), or the like. A memory element using an OS transistor can be freely placed by being stacked over a circuit using a Si transistor, for example; hence, integration can be easy. Furthermore, an OS transistor can be manufactured with a manufacturing apparatus similar to that for a Si transistor and thus can be manufactured at low cost. That is, the control circuit portion 1320 using OS transistors can be stacked over the switch portion 1324 so that they can be integrated into one chip. Since the area occupied by the control circuit portion 1320 can be reduced, a reduction in size is possible.

The first batteries 1301a and 1301b mainly supply electric power to in-vehicle parts for 42 V (for a high-voltage system), and the second battery 1311 supplies electric power to in-vehicle parts for 14 V (for a low-voltage system). Lead batteries are usually used for the second battery 1311 due to cost advantage. Lead batteries have disadvantages compared with lithium-ion secondary batteries in that they have a larger amount of self-discharge and are more likely to degrade due to a phenomenon called sulfation. There is an advantage that the second battery 1311 can be maintenance-free when it uses a lithium-ion secondary battery; however, in the case of long-term use, for example three years or more, anomalous occurrence that cannot be determined at the time of manufacturing might occur. In particular, when the second battery 1311 that starts the inverter becomes inoperative, the motor cannot be started even when the first batteries 1301a and 1301b have remaining capacity; thus, in order to prevent this, in the case where the second battery 1311 is a lead storage battery, the second battery is supplied with electric power from the first battery to constantly maintain a fully-charged state.

In this embodiment, an example in which a lithium-ion secondary battery is used as each of the first battery 1301a and the second battery 1311 is described. As the second battery 1311, a lead storage battery, an all-solid-state battery, or an electric double layer capacitor may be used. For example, the all-solid-state battery in Embodiment 5 may be used. Using the all-solid-state battery in Embodiment 5 as the second battery 1311 achieves high capacity, a high degree of safety, reduction in size, and reduction in weight.

Regenerative energy generated by rolling of tires 1316 is transmitted to the motor 1304 through a gear 1305, and is stored in the second battery 1311 from a motor controller 1303 and a battery controller 1302 through a control circuit portion 1321. Alternatively, the regenerative energy is stored in the first battery 1301a from the battery controller 1302 through the control circuit portion 1320. Alternatively, the regenerative energy is stored in the first battery 1301b from the battery controller 1302 through the control circuit portion 1320. For efficient charging with regenerative energy, the first batteries 1301a and 1301b are preferably capable of fast charging.

The battery controller 1302 can set the charge voltage, charge current, and the like of the first batteries 1301a and 1301b. The battery controller 1302 can set charge conditions in accordance with charge characteristics of a secondary battery used, so that fast charging can be performed.

Although not illustrated, when the electric vehicle is connected to an external charger, a plug of the charger or a connection cable of the charger is electrically connected to the battery controller 1302. Electric power supplied from the external charger is stored in the first batteries 1301a and 1301b through the battery controller 1302. Some chargers are provided with a control circuit, in which case the function of the battery controller 1302 is not used; to prevent overcharging, the first batteries 1301a and 1301b are preferably charged through the control circuit portion 1320. In addition, a connection cable or a connection cable of the charger is sometimes provided with a control circuit. The control circuit portion 1320 is also referred to as an ECU (Electronic Control Unit). The ECU is connected to a CAN (Controller Area Network) provided in the electric vehicle. The CAN is a type of a serial communication standard used as an in-vehicle LAN. The ECU includes a microcomputer. Moreover, the ECU uses a CPU or a GPU.

External chargers installed at charging stations and the like have a 100 V outlet, a 200 V outlet, or a three-phase 200V outlet with 50 KW, for example. Furthermore, charging can be performed with electric power supplied from external charging equipment by a contactless power feeding system or the like.

For fast charging, secondary batteries that can withstand high-voltage charging have been desired to perform charging in a short time.

The above-described secondary battery in this embodiment includes the positive electrode active material 100 obtained in Embodiment 1. Moreover, it is possible to achieve a secondary battery in which graphene is used as a conductive material, the electrode layer is formed thick to increase the loading amount while suppressing a reduction in capacity, and the electrical characteristics are significantly improved in synergy with maintenance of high capacity. This secondary battery is particularly effectively used in a vehicle and can achieve a vehicle that has a long range, specifically a driving range per charge of 500 km or longer, without increasing the proportion of the weight of the secondary battery to the weight of the entire vehicle.

Specifically, in the above-described secondary battery in this embodiment, the use of the positive electrode active material 100 described in Embodiment 1 can increase the operating voltage of the secondary battery, and the increase in charge voltage can increase the available capacity. Moreover, using the positive electrode active material 100 described in Embodiment 1 in the positive electrode can provide an automotive secondary battery having excellent charge and discharge cycle performance.

Next, examples in which the secondary battery of one embodiment of the present invention is mounted on a vehicle, typically a transport vehicle, will be described.

Mounting the secondary battery illustrated in any of FIG. 13D, FIG. 15C, and FIG. 22A on vehicles can achieve next-generation clean energy vehicles such as hybrid vehicles (HVs), electric vehicles (EVs), and plug-in hybrid vehicles (PHVs). The secondary battery can also be mounted on transport vehicles such as agricultural machines, motorized bicycles including motor-assisted bicycles, motorcycles, electric wheelchairs, electric carts, boats and ships, submarines, aircraft such as fixed-wing aircraft and rotary-wing aircraft, rockets, artificial satellites, space probes, planetary probes, and spacecraft. The secondary battery of one embodiment of the present invention can be a secondary battery with high capacity. Thus, the secondary battery of one embodiment of the present invention is suitable for reduction in size and reduction in weight and is preferably used in transport vehicles.

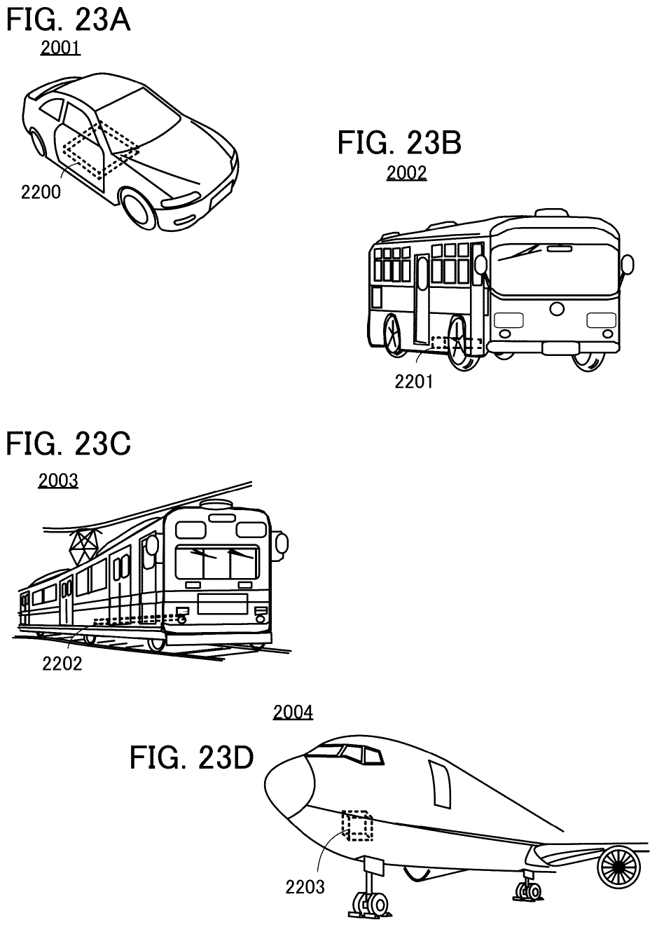

FIG. 23A to FIG. 23D show examples of transport vehicles using one embodiment of the present invention. An automobile 2001 illustrated in FIG. 23A is an electric vehicle that runs on an electric motor as a power source. Alternatively, the automobile 2001 is a hybrid electric vehicle that can appropriately select an electric motor or an engine as a driving power source. In the case where the secondary battery is mounted on the vehicle, an example of the secondary battery described in Embodiment 4 is provided at one position or several positions. The automobile 2001 illustrated in FIG. 23A includes a battery pack 2200, and the battery pack includes a secondary battery module in which a plurality of secondary batteries are connected to each other. Moreover, the battery pack preferably includes a charge control device that is electrically connected to the secondary battery module.

The automobile 2001 can be charged when the secondary battery of the automobile 2001 receives electric power from an external charging equipment through a plug-in system, a contactless charging system, or the like. In charging, a given method such as CHAdeMO (registered trademark) or Combined Charging System may be employed as a charging method, the standard of a connector, and the like as appropriate. The secondary battery may be a charging station provided in a commerce facility or a household power supply. For example, a plug-in technique enables an exterior power supply to charge a power storage device incorporated in the automobile 2001. Charging can be performed by converting AC power into DC power through a converter such as an ACDC converter.

Although not illustrated, the vehicle can include a power receiving device so as to be charged by being supplied with electric power from an above-ground power transmitting device in a contactless manner. For the contactless power feeding system, by fitting a power transmitting device in a road or an exterior wall, charging can be performed not only when the vehicle is stopped but also when driven. In addition, the contactless power feeding system may be utilized to perform transmission and reception of electric power between two vehicles. Furthermore, a solar cell may be provided in the exterior of the vehicle to charge the secondary battery when the vehicle stops or moves. To supply electric power in such a contactless manner, an electromagnetic induction method or a magnetic resonance method can be used.

FIG. 23B shows a large transporter 2002 having a motor controlled by electric power, as an example of a transport vehicle. The secondary battery module of the transporter 2002 has a cell unit of four secondary batteries with a nominal voltage of 3.0 V or higher and 5.0 V or lower, and 48 cells are connected in series to have 170 V as the maximum voltage. A battery pack 2201 has a function similar to that in FIG. 23A except, for example, the number of secondary batteries forming the secondary battery module of the battery pack 2201 or the like is different; thus the description is omitted.

FIG. 23C shows a large transport vehicle 2003 having a motor controlled by electricity as an example. The secondary battery module of the transport vehicle 2003 has 100 or more secondary batteries with a nominal voltage of 3.0 V or higher and 5.0 V or lower connected in series, and the maximum voltage is 600 V, for example. With the use of the positive electrode using the positive electrode active material 100 described in Embodiment 1, a secondary battery having favorable rate characteristics and charge and discharge cycle performance can be fabricated, which can contribute to higher performance and a longer life of the transport vehicle 2003. A battery pack 2202 has a function similar to that in FIG. 23A except that the number of secondary batteries forming the secondary battery module of the battery pack 2202 or the like is different; thus, the detailed description is omitted.

FIG. 23D shows an aircraft 2004 having a combustion engine as an example. The aircraft 2004 shown in FIG. 23D can be regarded as a portion of a transport vehicle since it is provided with wheels for takeoff and landing, and has a battery pack 2203 including a secondary battery module and a charging control device; the secondary battery module includes a plurality of connected secondary batteries.

The secondary battery module of the aircraft 2004 has eight 4 V secondary batteries connected in series, which has the maximum voltage of 32 V, for example. A battery pack 2203 has a function similar to that in FIG. 23A except, for example, the number of secondary batteries forming the secondary battery module of the battery pack 2203; thus the detailed description is omitted.

This embodiment can be implemented in appropriate combination with any of the other embodiments.

### Embodiment 7

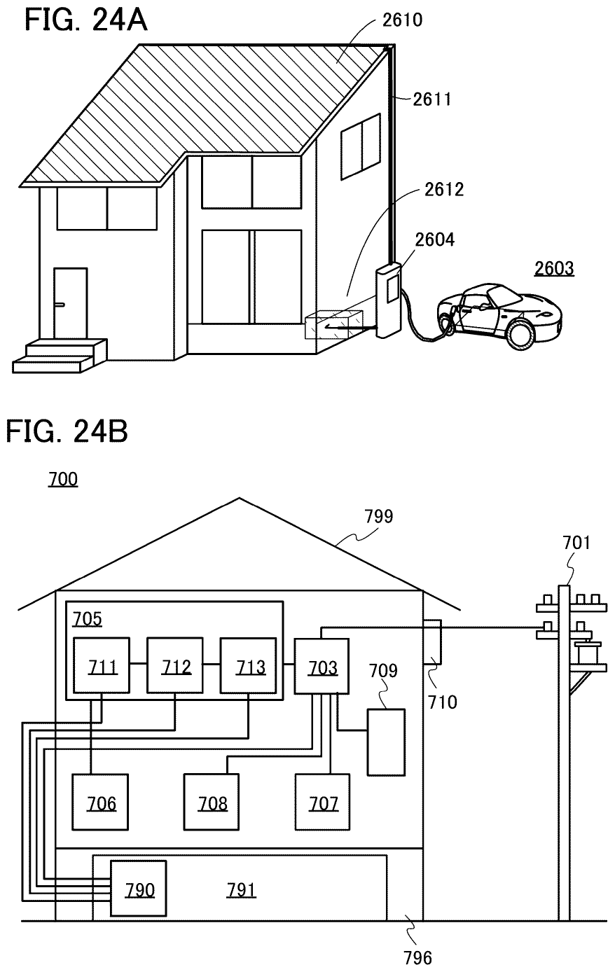

In this embodiment, examples in which the secondary battery of one embodiment of the present invention is mounted on a building will be described with reference to FIG. 24A and FIG. 24B.

A house illustrated in FIG. 24A includes a power storage device 2612 including the secondary battery which is one embodiment of the present invention and a solar panel 2610. The power storage device 2612 is electrically connected to the solar panel 2610 through a wiring 2611 or the like. The power storage device 2612 may be electrically connected to a ground-based charging equipment 2604. The power storage device 2612 can be charged with electric power generated by the solar panel 2610. The secondary battery included in the vehicle 2603 can be charged with the electric power stored in the power storage device 2612 through the charging equipment 2604. The power storage device 2612 is preferably provided in an underfloor space. The power storage device 2612 is provided in the underfloor space, in which case the space on the floor can be effectively used. Alternatively, the power storage device 2612 may be provided on the floor.

The electric power stored in the power storage device 2612 can also be supplied to other electronic devices in the house. Thus, with the use of the power storage device 2612 of one embodiment of the present invention as an uninterruptible power source, electronic devices can be used even when electric power cannot be supplied from a commercial power source due to power failure or the like.

FIG. 24B shows an example of a power storage device 700 of one embodiment of the present invention. As illustrated in FIG. 24B, a power storage device 791 of one embodiment of the present invention is provided in an underfloor space 796 of a building 799. The power storage device 791 may be provided with the control circuit described in Embodiment 6, and the use of a secondary battery including a positive electrode using the positive electrode active material 100 obtained in Embodiment 1 for the power storage device 791 enables the power storage device 791 to have a long lifetime.

The power storage device 791 is provided with a control device 790, and the control device 790 is electrically connected to a distribution board 703, a power storage controller (also referred to as control device) 705, an indicator 706, and a router 709 through wirings.

Electric power is transmitted from a commercial power source 701 to the distribution board 703 through a service wire mounting portion 710. Moreover, electric power is transmitted to the distribution board 703 from the power storage device 791 and the commercial power source 701, and the distribution board 703 supplies the transmitted electric power to a general load 707 and a power storage load 708 through outlets (not illustrated).

The general load 707 is, for example, an electronic device such as a TV or a personal computer. The power storage load 708 is, for example, an electronic device such as a microwave, a refrigerator, or an air conditioner.

The power storage controller 705 includes a measuring portion 711, a predicting portion 712, and a planning portion 713. The measuring portion 711 has a function of measuring the amount of electric power consumed by the general load 707 and the power storage load 708 during a day (e.g., from midnight to midnight). The measuring portion 711 may have a function of measuring the amount of electric power of the power storage device 791 and the amount of electric power supplied from the commercial power source 701. The predicting portion 712 has a function of predicting, on the basis of the amount of electric power consumed by the general load 707 and the power storage load 708 during a given day, the demand for electric power consumed by the general load 707 and the power storage load 708 during the next day. The planning portion 713 has a function of making a charge and discharge plan of the power storage device 791 on the basis of the demand for electric power predicted by the predicting portion 712.

The amount of electric power consumed by the general load 707 and the power storage load 708 and measured by the measuring portion 711 can be checked with the indicator 706. It can be checked with an electronic device such as a TV or a personal computer through the router 709. Furthermore, it can be checked with a portable electronic terminal such as a smartphone or a tablet through the router 709. With the indicator 706, the electronic device, or the portable electronic terminal, for example, the demand for electric power depending on a time period (or per hour) that is predicted by the predicting portion 712 can be checked.

This embodiment can be implemented in appropriate combination with any of the other embodiments.

### Embodiment 8

This embodiment will describe examples in which the power storage device of one embodiment of the present invention is mounted on a motorcycle and a bicycle.

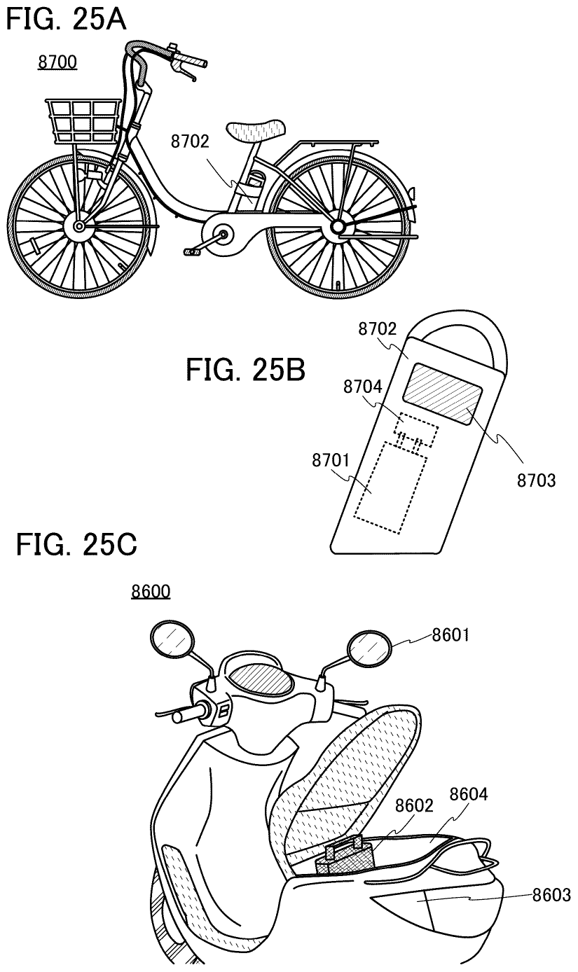

FIG. 25A shows an example of an electric bicycle using the power storage device of one embodiment of the present invention. The power storage device of one embodiment of the present invention can be used for an electric bicycle 8700 illustrated in FIG. 25A. The power storage device of one embodiment of the present invention includes a plurality of storage batteries and a protection circuit, for example.

The electric bicycle 8700 includes a power storage device 8702. The power storage device 8702 can supply electricity to a motor that assists a rider. The power storage device 8702 is portable, and FIG. 25B illustrates the state where the power storage device 8702 is detached from the bicycle. A plurality of storage batteries 8701 included in the power storage device of one embodiment of the present invention are incorporated in the power storage device 8702, and the remaining battery capacity and the like can be displayed on a display portion 8703. The power storage device 8702 includes a control circuit 8704 capable of charge control or anomaly detection for the secondary battery, which is exemplified in Embodiment 6. The control circuit 8704 is electrically connected to a positive electrode and a negative electrode of the storage battery 8701. The control circuit 8704 may include the small solid-state secondary battery illustrated in FIG. 21A and FIG. 21B. When the small solid-state secondary battery illustrated in FIG. 21A and FIG. 21B is provided in the control circuit 8704, electric power can be supplied to store data in a memory circuit included in the control circuit 8704 for a long time. When the control circuit 8704 is used in combination with a secondary battery including a positive electrode using the positive electrode active material 100 obtained in Embodiment 1, the synergy on safety can be obtained. The secondary battery including the positive electrode using the positive electrode active material 100 obtained in Embodiment 1 and the control circuit 8704 can contribute greatly to elimination of accidents due to secondary batteries, such as fires.

FIG. 25C shows an example of a motorcycle using the power storage device of one embodiment of the present invention. A motor scooter 8600 illustrated in FIG. 25C includes a power storage device 8602, side mirrors 8601, and indicator lights 8603. The power storage device 8602 can supply electricity to the indicator lights 8603. The power storage device 8602 including a plurality of secondary batteries including a positive electrode using the positive electrode active material 100 obtained in Embodiment 1 can have high capacity and contribute to a reduction in size.

In the motor scooter 8600 illustrated in FIG. 25C, the power storage device 8602 can be stored in an under-seat storage unit 8604. The power storage device 8602 can be stored in the under-seat storage unit 8604 even with a small size.

### Embodiment 9

In this embodiment, examples of electronic devices each including the secondary battery of one embodiment of the present invention will be described. Examples of the electronic device including the secondary battery include a television device (also referred to as a television or a television receiver), a monitor of a computer and the like, a digital camera, a digital video camera, a digital photo frame, a mobile phone (also referred to as a cellular phone or a mobile phone device), a portable game console, a portable information terminal, an audio reproducing device, and a large-sized game machine such as a pachinko machine. Examples of the portable information terminal include a laptop personal computer, a tablet terminal, an e-book terminal, and a mobile phone.

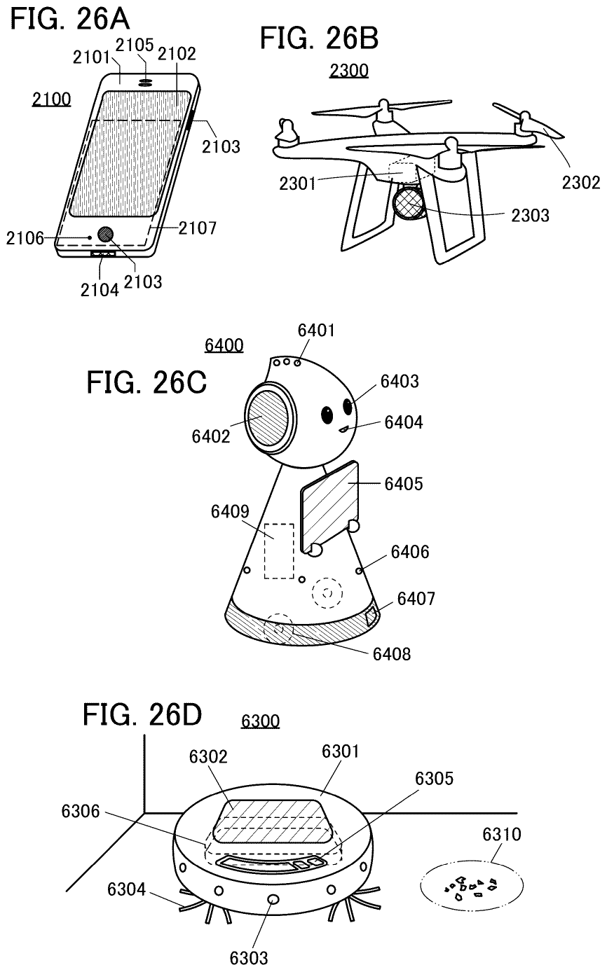

FIG. 26A shows an example of a mobile phone. A mobile phone 2100 includes a housing 2101 in which a display portion 2102 is incorporated, an operation button 2103, an external connection port 2104, a speaker 2105, a microphone 2106, and the like. The mobile phone 2100 includes a secondary battery 2107. The use of the secondary battery 2107 having a positive electrode using the positive electrode active material 100 described in Embodiment 1 achieves high capacity and a structure that accommodates space saving due to a reduction in size of the housing.

The mobile phone 2100 is capable of executing a variety of applications such as mobile phone calls, e-mailing, viewing and editing texts, music reproduction, Internet communication, and a computer game.

With the operation button 2103, a variety of functions such as time setting, power on/off, on/off of wireless communication, setting and cancellation of a silent mode, and setting and cancellation of a power saving mode can be performed. For example, the functions of the operation button 2103 can be set freely by the operating system incorporated in the mobile phone 2100.

The mobile phone 2100 can employ near field communication based on an existing communication standard. For example, mutual communication between the mobile phone 2100 and a headset capable of wireless communication can be performed, and thus hands-free calling is possible.

Moreover, the mobile phone 2100 includes the external connection port 2104, and data can be directly transmitted to and received from another information terminal via a connector. In addition, charging can be performed via the external connection port 2104. Note that the charging operation may be performed by wireless power feeding without using the external connection port 2104.

The mobile phone 2100 preferably includes a sensor. As the sensor, a human body sensor such as a fingerprint sensor, a pulse sensor, or a temperature sensor, a touch sensor, a pressure sensitive sensor, or an acceleration sensor is preferably mounted, for example.

FIG. 26B illustrates an unmanned aircraft 2300 including a plurality of rotors 2302. The unmanned aircraft 2300 is also referred to as a drone. The unmanned aircraft 2300 includes a secondary battery 2301 of one embodiment of the present invention, a camera 2303, and an antenna (not illustrated). The unmanned aircraft 2300 can be remotely controlled through the antenna. A secondary battery including a positive electrode using the positive electrode active material 100 obtained in Embodiment 1 has high energy density and a high degree of safety, and thus can be used safely for a long time over a long period of time and is preferable as the secondary battery included in the unmanned aircraft 2300.

FIG. 26C shows an example of a robot. A robot 6400 illustrated in FIG. 26C includes a secondary battery 6409, an illuminance sensor 6401, a microphone 6402, an upper camera 6403, a speaker 6404, a display portion 6405, a lower camera 6406, an obstacle sensor 6407, a moving mechanism 6408, an arithmetic device, and the like.

The microphone 6402 has a function of detecting a speaking voice of a user, an environmental sound, and the like. The speaker 6404 has a function of outputting sound. The robot 6400 can communicate with the user using the microphone 6402 and the speaker 6404.

The display portion 6405 has a function of displaying various kinds of information. The robot 6400 can display information desired by the user on the display portion 6405. The display portion 6405 may be provided with a touch panel. Moreover, the display portion 6405 may be a detachable information terminal, in which case charging and data communication can be performed when the display portion 6405 is set at the home position of the robot 6400.

The upper camera 6403 and the lower camera 6406 each have a function of taking an image of the surroundings of the robot 6400. The obstacle sensor 6407 can detect an obstacle in the direction where the robot 6400 advances with the moving mechanism 6408. The robot 6400 can move safely by recognizing the surroundings with the upper camera 6403, the lower camera 6406, and the obstacle sensor 6407.

The robot 6400 further includes, in its inner region, the secondary battery 6409 of one embodiment of the present invention and a semiconductor device or an electronic component. A secondary battery including a positive electrode using the positive electrode active material 100 obtained in Embodiment 1 has high energy density and a high degree of safety, and thus can be used safely for a long time over a long period of time and is preferable as the secondary battery 6409 included in the robot 6400.

FIG. 26D shows an example of a cleaning robot. A cleaning robot 6300 includes a display portion 6302 placed on the top surface of a housing 6301, a plurality of cameras 6303 placed on the side surface of the housing 6301, a brush 6304, operation buttons 6305, a secondary battery 6306, a variety of sensors, and the like. Although not illustrated, the cleaning robot 6300 is provided with a tire, an inlet, and the like. The cleaning robot 6300 is self-propelled, detects dust 6310, and sucks up the dust through the inlet provided on the bottom surface.

For example, the cleaning robot 6300 can determine whether there is an obstacle such as a wall, furniture, or a step by analyzing images taken by the cameras 6303. In the case where the cleaning robot 6300 detects an object, such as a wire, that is likely to be caught in the brush 6304 by image analysis, the rotation of the brush 6304 can be stopped. The cleaning robot 6300 includes, in its inner region, the secondary battery 6306 of one embodiment of the present invention and a semiconductor device or an electronic component. A secondary battery including a positive electrode using the positive electrode active material 100 obtained in Embodiment 1 has high energy density and a high degree of safety, and thus can be used safely for a long time over a long period of time and is preferable as the secondary battery 6306 included in the cleaning robot 6300.

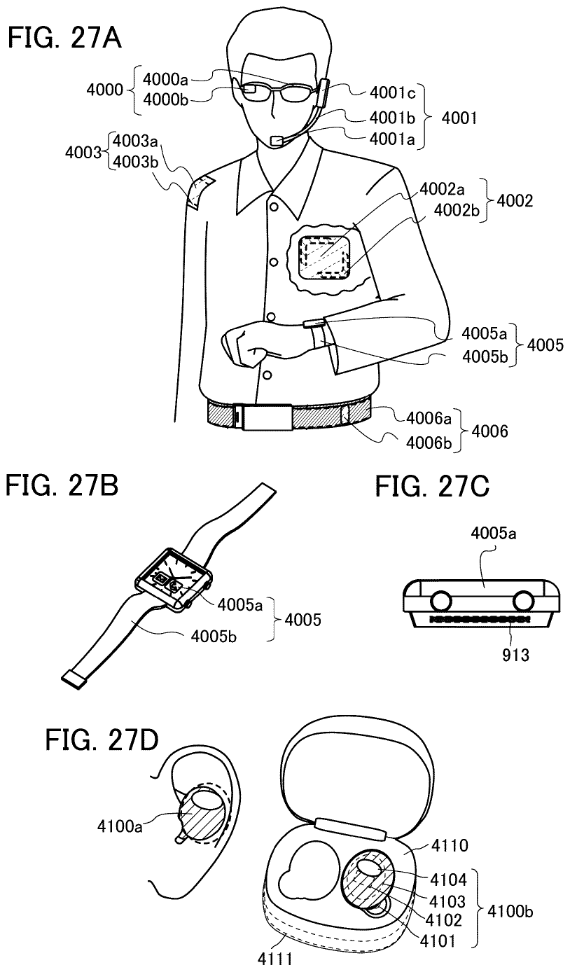

FIG. 27A shows examples of wearable devices. A secondary battery is used as a power source of a wearable device. To have improved splash resistance, water resistance, or dust resistance in daily use or outdoor use by a user, a wearable device is desirably capable of being charged with and without a wire whose connector portion for connection is exposed.

For example, the secondary battery of one embodiment of the present invention can be provided in a glasses-type device 4000 illustrated in FIG. 27A. The glasses-type device 4000 includes a frame 4000a and a display portion 4000b. The secondary battery is provided in a temple of the frame 4000a having a curved shape, whereby the glasses-type device 4000 can be lightweight, can have a well-balanced weight, and can be used continuously for a long time. A secondary battery including a positive electrode using the positive electrode active material 100 obtained in Embodiment 1 has high energy density and achieves a structure that accommodates space saving due to a reduction in size of the housing.

The secondary battery of one embodiment of the present invention can be provided in a headset-type device 4001. The headset-type device 4001 includes at least a microphone part 4001a, a flexible pipe 4001b, and an earphone portion 4001c. The secondary battery can be provided in the flexible pipe 4001b or the earphone portion 4001c. A secondary battery including a positive electrode using the positive electrode active material 100 obtained in Embodiment 1 has high energy density and achieves a structure that accommodates space saving due to a reduction in size of the housing.

The secondary battery of one embodiment of the present invention can be provided in a device 4002 that can be attached directly to a body. A secondary battery 4002b can be provided in a thin housing 4002a of the device 4002. A secondary battery including a positive electrode using the positive electrode active material 100 obtained in Embodiment 1 has high energy density and achieves a structure that accommodates space saving due to a reduction in size of the housing.

The secondary battery of one embodiment of the present invention can be provided in a device 4003 that can be attached to clothes. A secondary battery 4003b can be provided in a thin housing 4003a of the device 4003. A secondary battery including a positive electrode using the positive electrode active material 100 obtained in Embodiment 1 has high energy density and achieves a structure that accommodates space saving due to a reduction in size of the housing.

The secondary battery of one embodiment of the present invention can be provided in a belt-type device 4006. The belt-type device 4006 includes a belt portion 4006a and a wireless power feeding and receiving portion 4006b, and the secondary battery can be provided in the inner region of the belt portion 4006a. A secondary battery including a positive electrode using the positive electrode active material 100 obtained in Embodiment 1 has high energy density and achieves a structure that accommodates space saving due to a reduction in size of the housing.

The secondary battery of one embodiment of the present invention can be provided in a watch-type device 4005. The watch-type device 4005 includes a display portion 4005a and a belt portion 4005b, and the secondary battery can be provided in the display portion 4005a or the belt portion 4005b. A secondary battery including a positive electrode using the positive electrode active material 100 obtained in Embodiment 1 has high energy density and achieves a structure that accommodates space saving due to a reduction in size of the housing.

The display portion 4005a can display various kinds of information such as time and reception information of an e-mail and an incoming call.

The watch-type device 4005 is a wearable device that is wound around an arm directly; thus, a sensor that measures the pulse, the blood pressure, or the like of the user may be incorporated therein. Data on the exercise quantity and health of the user can be stored to be used for health maintenance.

FIG. 27B is a perspective view of the watch-type device 4005 that is detached from an arm.

FIG. 27C is a side view. FIG. 27C illustrates a state where the secondary battery 913 is incorporated in the inner region. The secondary battery 913 is the secondary battery described in Embodiment 4. The secondary battery 913 is provided to overlap the display portion 4005a, can have high density and high capacity, and is small and lightweight.

Since the secondary battery in the watch-type device 4005 is required to be small and lightweight, the use of the positive electrode active material 100 obtained in Embodiment 1 in the positive electrode of the secondary battery 913 enables the secondary battery 913 to have high energy density and a small size.

FIG. 27D shows an example of wireless earphones. The wireless earphones shown as an example consist of, but not limited to, a pair of earphone bodies 4100a and 4100b.

Each of the earphone bodies 4100a and 4100b includes a driver unit 4101, an antenna 4102, and a secondary battery 4103. Each of the earphone bodies 4100a and 4100b may also include a display portion 4104. Moreover, each of the earphone bodies 4100a and 4100b preferably includes a substrate where a circuit such as a wireless IC is provided, a terminal for charge, and the like. Each of the earphone bodies 4100a and 4100b may also include a microphone.

A case 4110 includes a secondary battery 4111. Moreover, the case 4110 preferably include a substrate where a circuit such as a wireless IC or a charge control IC is provided, and a terminal for charge. The case 4110 may also include a display portion, a button, and the like.

The earphone bodies 4100a and 4100b can communicate wirelessly with another electronic device such as a smartphone. Thus, sound data and the like transmitted from another electronic device can be played through the earphone bodies 4100a and 4100b. When the earphone bodies 4100a and 4100b include a microphone, sound captured by the microphone is transmitted to another electronic device, and sound data obtained by processing with the electronic device can be transmitted to and played through the earphone bodies 4100a and 4100b. Hence, the wireless earphones can be used as a translator, for example.

The secondary battery 4103 included in the earphone body 4100a can be charged by the secondary battery 4111 included in the case 4110. As the secondary battery 4111 and the secondary battery 4103, the coin-type secondary battery or the cylindrical secondary battery of the foregoing embodiment, for example, can be used. A secondary battery whose positive electrode includes the positive electrode active material 100 obtained in Embodiment 1 has a high energy density; thus, with the use of the secondary battery as the secondary battery 4103 and the secondary battery 4111, space saving required with downsizing of the wireless earphones can be achieved.

This embodiment can be implemented in appropriate combination with the other embodiments.

### Example 1

In this example, a composite oxide including zirconium and yttrium was formed, and its crystal structure was evaluated.

### <Manufacturing Method>

Tetraisopropoxy zirconium and isopropoxy yttrium were measured to weigh 0.2 g in total. The mole fractions of yttrium to the sum of zirconium and yttrium were set such that Y/(Zr+Y)×100=0.5 for Sample 1, Y/(Zr+Y)×100=5.4 for Sample 2, and Y/(Zr+Y)×100=15 for Sample 3. According to the phase diagram in Non-Patent Document 2, these mole fractions indicate that the samples are within the ranges as follows: at 850° C., Sample 1 becomes a monoclinic crystal, Sample 2 becomes a tetragonal crystal, and Sample 3 becomes a cubic crystal.

To weighed tetraisopropoxy zirconium and isopropoxy yttrium was put 10 mL of 2-propanol. A lid was put thereon and dissolution was achieved by stirring for 10 hours or more.

Next, stirring was performed without a lid for approximately 40 hours to cause a reaction with water included in the atmosphere, whereby a sol-gel reaction occurs.

Then, alcohol was evaporated in a forced-air dryer at 75° C., so that the residue was collected.

The collected residue was put on an alumina crucible, followed by heating at a muffle furnace at 850° C. for 2 hours. The atmosphere was an oxygen atmosphere. After the heating, the resulting substance was ground in a mortar.

### <XRD>

The samples ground were sprinkled on a reflection-free silicon plate coated with grease, and then subjected to XRD measurement. A D8 ADVANCE manufactured by Bruker AXS was used. The measurement range was from 15° to 90°, the increment was 0.01°/step, and the scan rate was 0.2 sec/step.

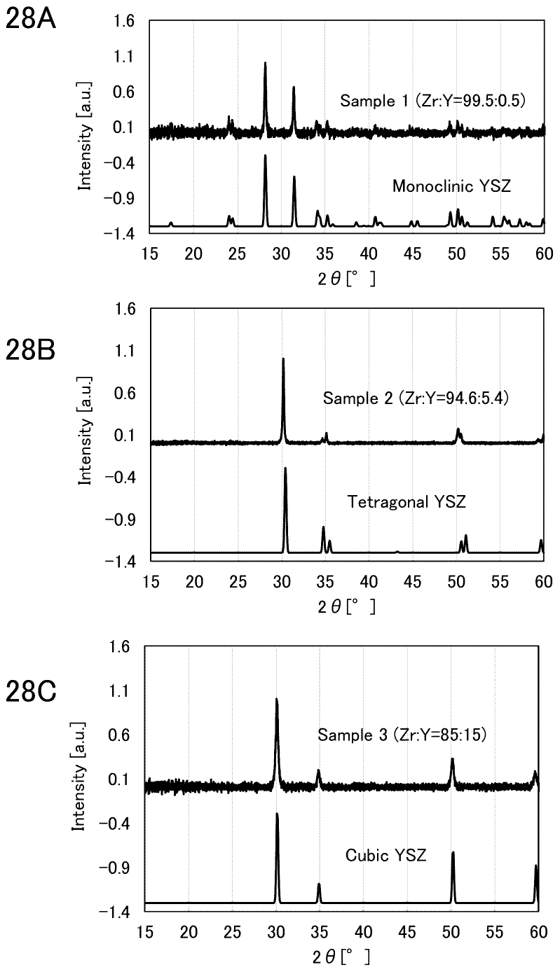

FIG. 28A shows an XRD pattern of Sample 1, FIG. 28B shows an XRD pattern of Sample 2, and FIG. 28C A shows an XRD pattern of Sample 3. Monoclinic, tetragonal, and cubic patterns of yttria-stabilized zirconium (YSZ) obtained by ICSD are also shown for comparison. The vertical axis represents intensity (Intensity).

It was confirmed that Sample 1 was YSZ with a monoclinic crystal, Sample 2 was YSZ with a tetragonal crystal, and Sample 3 was YSZ with a cubic crystal. Table 1 lists formation conditions and crystal structures of the samples.

TABLE 1

| | Y/(Zr + Y)*100 | | |
|---|---|---|---|
| | (atomic ratio) | Heating | Crystal structure |
| Sample 1 | 0.5 | 850° C., 2 hr | Monoclinic crystal |
| Sample 2 | 5.4 | 850° C., 2 hr | Tetragonal crystal |
| Sample 3 | 15 | 850° C., 2 hr | Cubic crystal |

The above revealed that, with the zirconium/yttrium ratios determined based on the phase diagram, yttria-stabilized zirconium having the intended crystal structures was able to be obtained by a sol-gel method.

### Example 2

In this example, a projection of a composite oxide containing zirconium and yttrium was provided on the surface of a positive electrode active material, and characteristics of the positive electrode active material and the composite oxide were evaluated.

### <Manufacture of Positive Electrode Active Material and Composite Oxide>

Samples formed in this example are described with reference to the manufacturing method illustrated in FIG. 10.

As LiMO₂ in Step S14, with the use of cobalt as the transition metal M, commercially available lithium cobalt oxide (Cellseed C-10N produced by NIPPON CHEMICAL INDUSTRIAL CO., LTD.) not containing any additive element was prepared. Lithium fluoride and magnesium fluoride were mixed therewith by a solid phase method, as in Step S21 to Step S24. Lithium fluoride and magnesium fluoride were added such that the number of moles of lithium fluoride was 0.33 and the number of moles of magnesium fluoride was 1 with the number of moles of lithium cobalt oxide assumed as 100. The mixture here is the mixture 903.

Next, heating was performed in a manner similar to that of Step S33. In a square-shaped alumina container, 30 g of the mixture 903 was placed, a lid was put on the container, and heating was performed in a muffle furnace. The atmosphere in the furnace was purged and an oxygen gas was introduced; the oxygen flow was stopped during the heating. The annealing temperature was 900° C., and the annealing time was 20 hours.

To the composite oxide 904 that had been heated, nickel hydroxide and aluminum hydroxide were added and mixed, as in Step S41 to Step S44. Lithium fluoride and magnesium fluoride were added such that the number of moles of nickel hydroxide was 0.5 and the number of moles of aluminum hydroxide was 0.5 with the number of moles of lithium cobalt oxide assumed as 100. The mixture here is the mixture 905.

Next, heating was performed in a manner similar to that of Step S45. In a square-shaped alumina container, 27.5 g of the mixture 903 was placed, a lid was put on the container, and heating was performed in a muffle furnace. The flow rate of oxygen gas was 10 L/min. The heating was performed at a temperature of 850° C. for 10 hour. The mixture here is the mixture 906.

Next, as in Step S51 to Step S53, tetraisopropoxy zirconium and isopropoxy yttrium were dissolved in 2-propanol. The mole fractions of yttrium to the sum of zirconium and yttrium were set such that Y/(Zr+Y)×100=0.5 for Sample 11, Y/(Zr+Y)×100=5.4 for Sample 12, and Y/(Zr+Y)×100=15 for Sample 13.

The composite oxide 906 was mixed into the solution, and stirring was performed without a lid for approximately 60 hours to cause a reaction with water included in the atmosphere, whereby a sol-gel reaction occurs.

Then, alcohol was evaporated in a forced-air dryer at 95° C., so that the residue was collected.

The collected residue was put on an alumina crucible, followed by heating at a muffle furnace at 850° C. for 2 hours. The atmosphere was an oxygen atmosphere. After the heating, the resulting substance was ground in a mortar.

Sample 10 containing neither zirconium nor yttrium was formed without undergoing Step S51 to Step S55. For Sample 10, heating in Step S33 was performed at 900° C. for 10 hours. In Step S45, after heating at 920° C. for 10 hours, an operation of grinding in a mortar was repeated three times in total. The other formation conditions are similar to those of the above composite oxide 906.

Table 2 lists the additive elements contained in Sample 10 to Sample 13 and the zirconium/yttrium ratios.

TABLE 2

| | | | Y/(Zr + Y)*100 |
|---|---|---|---|
| | LiMO₂ | Additive element | (mole fraction) |
| Sample 10 | LiCoO₂ | Mg, F, Ni, Al | — |
| Sample 11 | | Mg, F, Ni, Al, | 0.5 |
| Sample 12 | | Zr, Y | 5.4 |
| Sample 13 | | | 15 |

### <SEM>

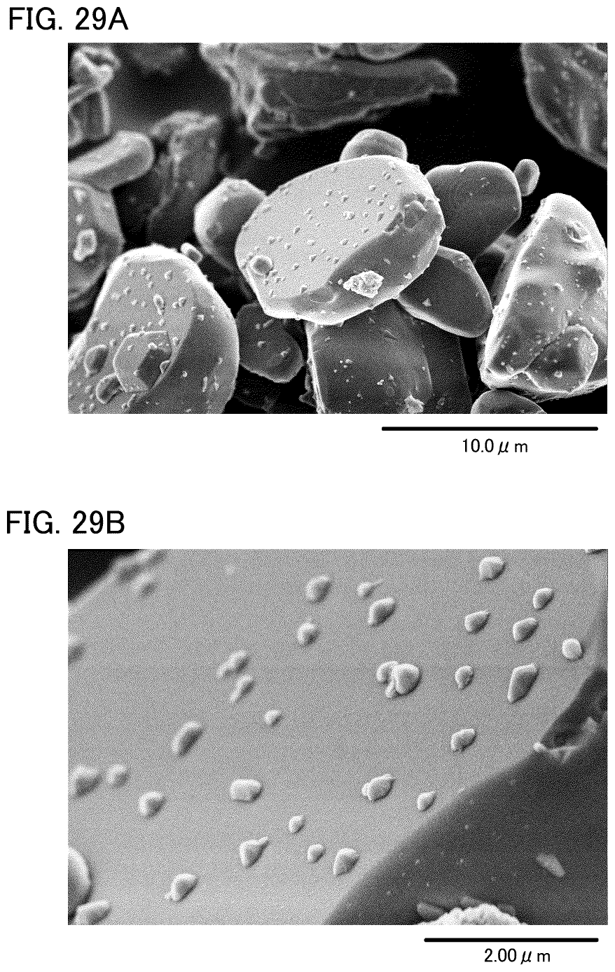

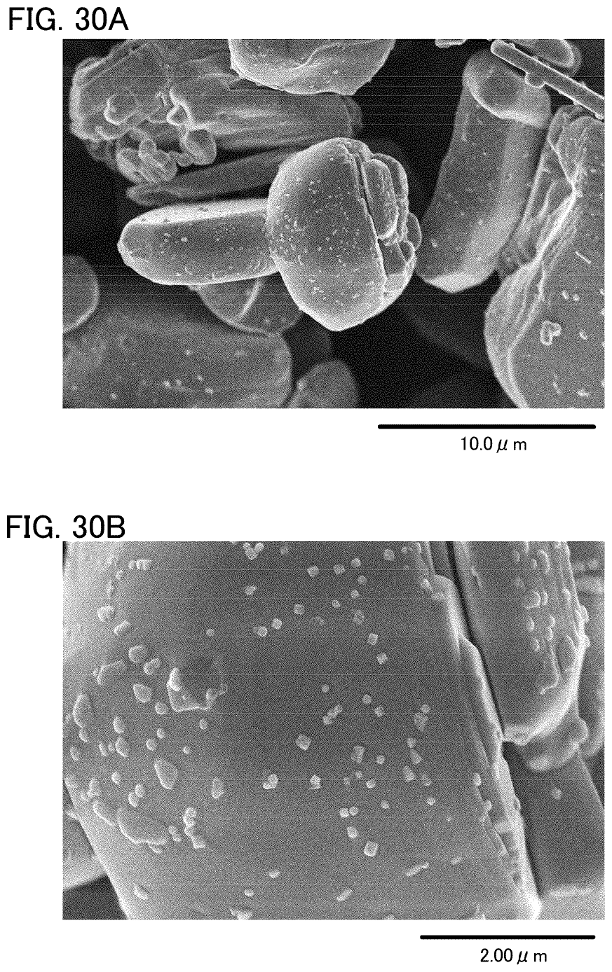

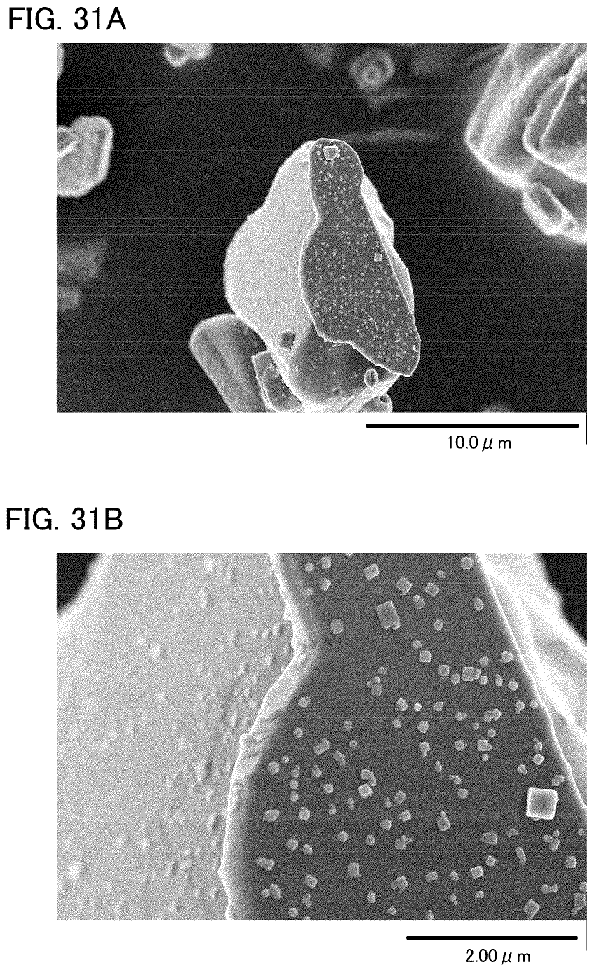

FIG. 29A and FIG. 29B show surface SEM images of Sample 11. FIG. 30A and FIG. 30B show surface SEM images of Sample 12. FIG. 31A and FIG. 31B show surface SEM images of Sample 13.

The projection provided on the smooth surface of the positive electrode active material is observed in any of Sample 11 to Sample 13. Especially in Sample 12 and Sample 13, the shape of part of the projection is part of a rectangular solid.

### <STEM-EDX>

Next, Sample 11 to Sample 13 were analyzed by STEM-EDX.

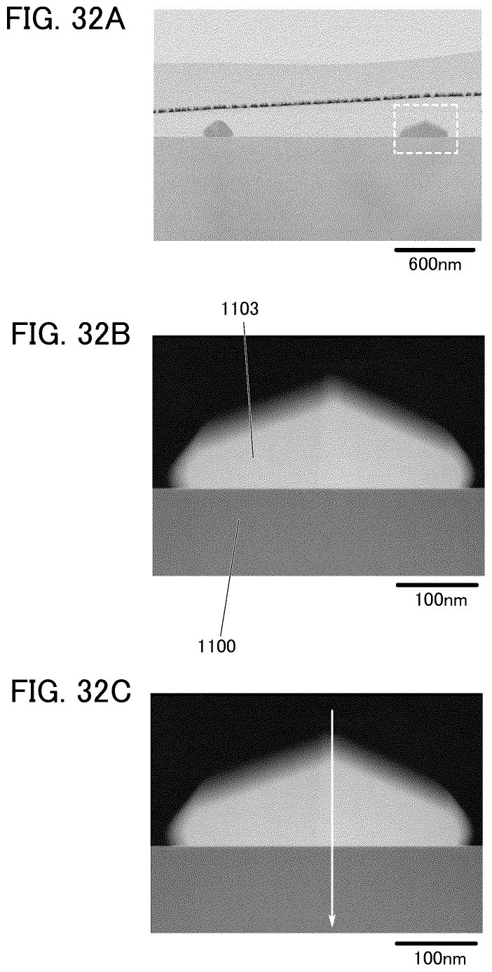

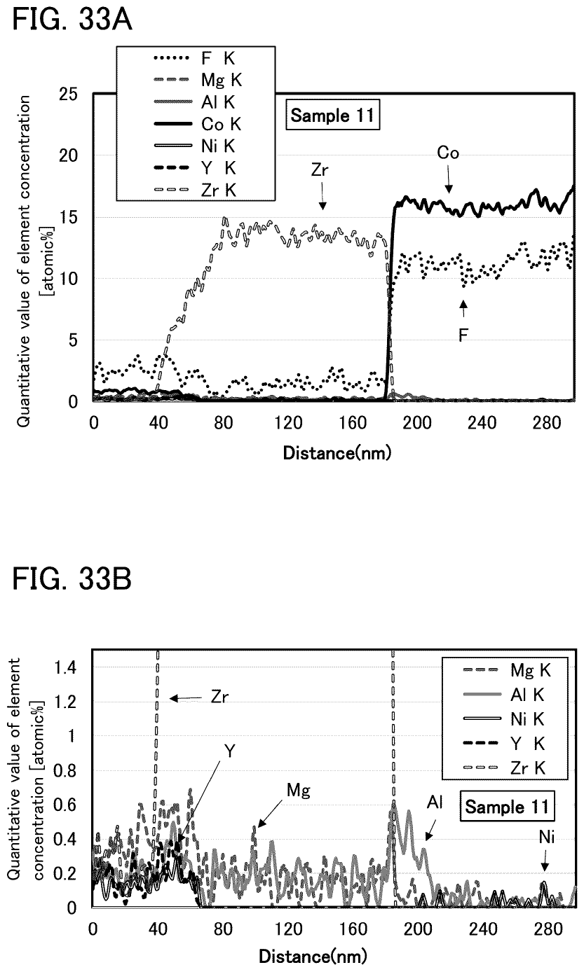

FIG. 32A is a cross-sectional STEM image of a positive electrode active material 1100 and a projection 1103 of Sample 11. A ZC image of the region denoted by the white broken line in FIG. 32A is shown in FIG. 32B. The linear EDX analysis results of the portion denoted by the white arrow in FIG. 32C is shown in FIG. 33A. In FIG. 33B, Mg, Al, Ni, Y, and Zr are extracted and a region with 1.5 atom % or less is enlarged. Each horizontal axis represents a distance (Distance).

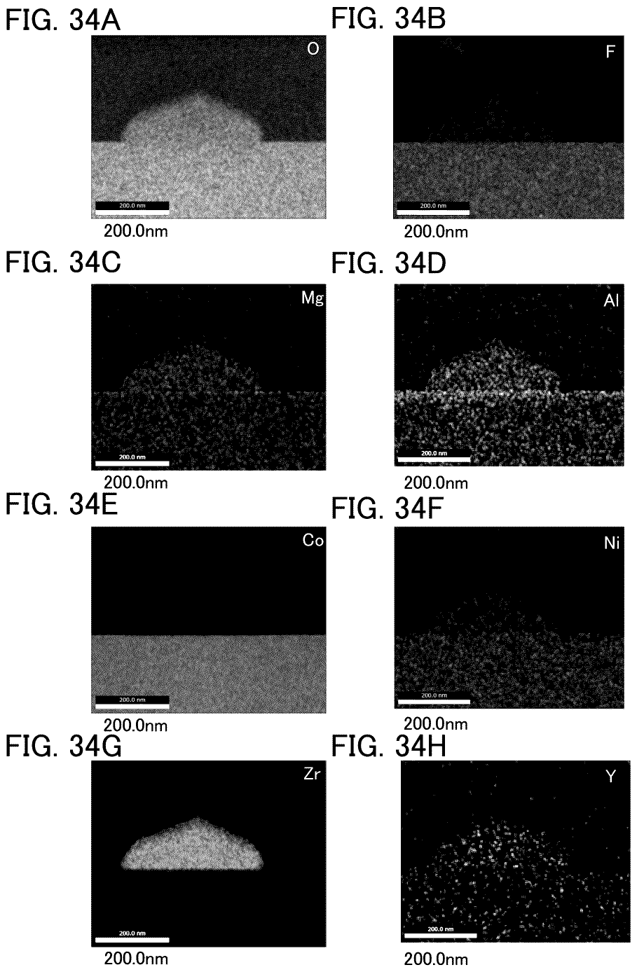

FIG. 34A to FIG. 34H are EDX mapping images of the positive electrode active material 1100 and the projection 1103 of the region that is the same as that in FIG. 32B. FIG. 34A, FIG. 34B, FIG. 34C, FIG. 34D, FIG. 34E, FIG. 34F, FIG. 34G, and FIG. 34H are mapping images of oxygen, fluorine, magnesium, aluminum, cobalt, nickel, zirconium, and yttrium, respectively. In each image, the color of the area with higher concentration is closer to white.

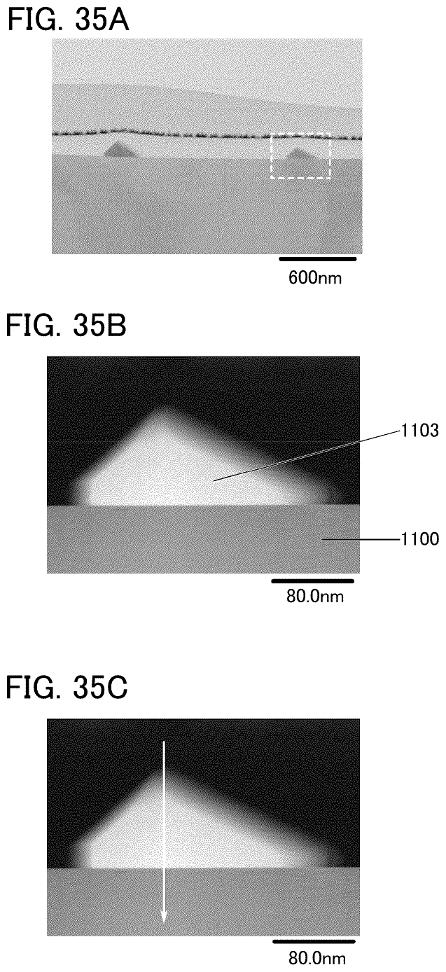

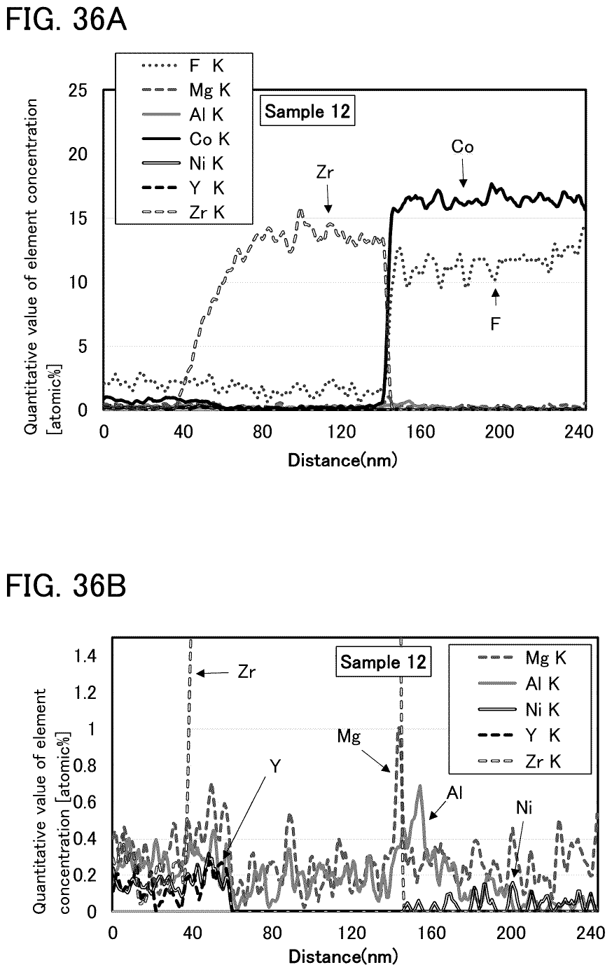

FIG. 35A is a cross-sectional STEM image of a positive electrode active material 1100 and a projection 1103 of Sample 12. A ZC image of the region denoted by the white broken line in FIG. 35A is shown in FIG. 35B. The linear EDX analysis results of the portion denoted by the white arrow in FIG. 35C is shown in FIG. 36A. In FIG. 36B, Mg, Al, Ni, Y, and Zr are extracted and a region with 1.5 atom % or less is enlarged. Each horizontal axis represents a distance (Distance).

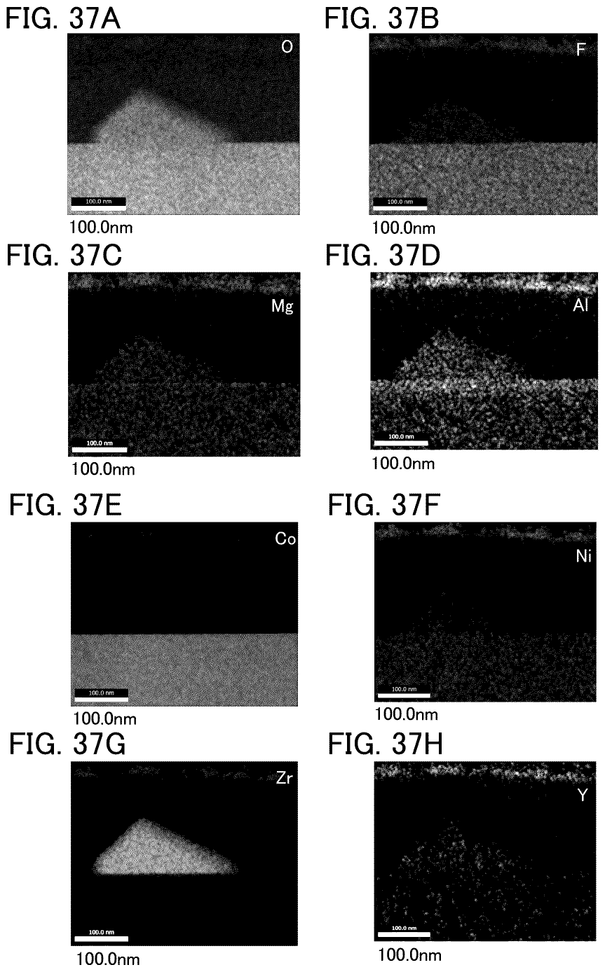

FIG. 37A to FIG. 37H are EDX mapping images of the positive electrode active material 1100 and the projection 1103 of the region that is the same as that in FIG. 35B. FIG. 37A, FIG. 37B, FIG. 37C, FIG. 37D, FIG. 37E, FIG. 37F, FIG. 37G, and FIG. 37H are mapping images of oxygen, fluorine, magnesium, aluminum, cobalt, nickel, zirconium, and yttrium, respectively.

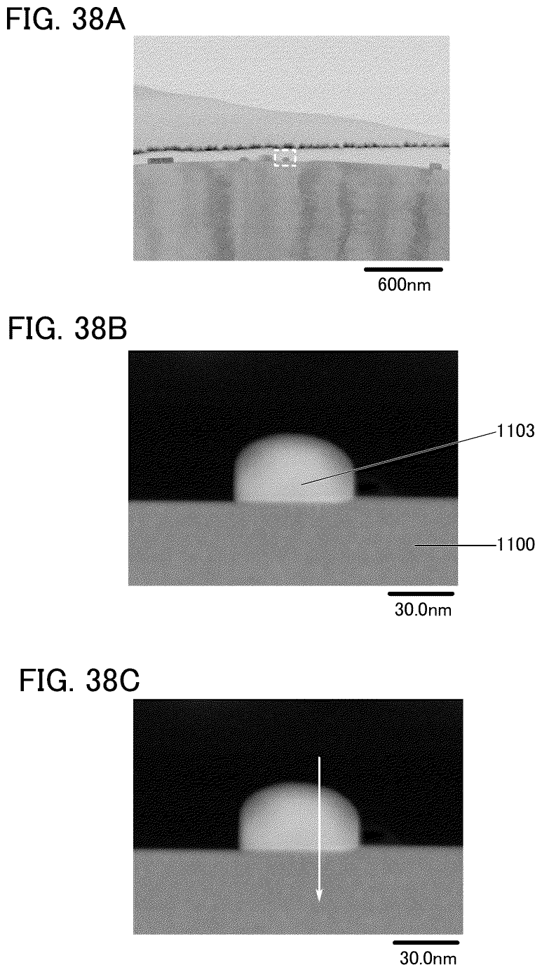

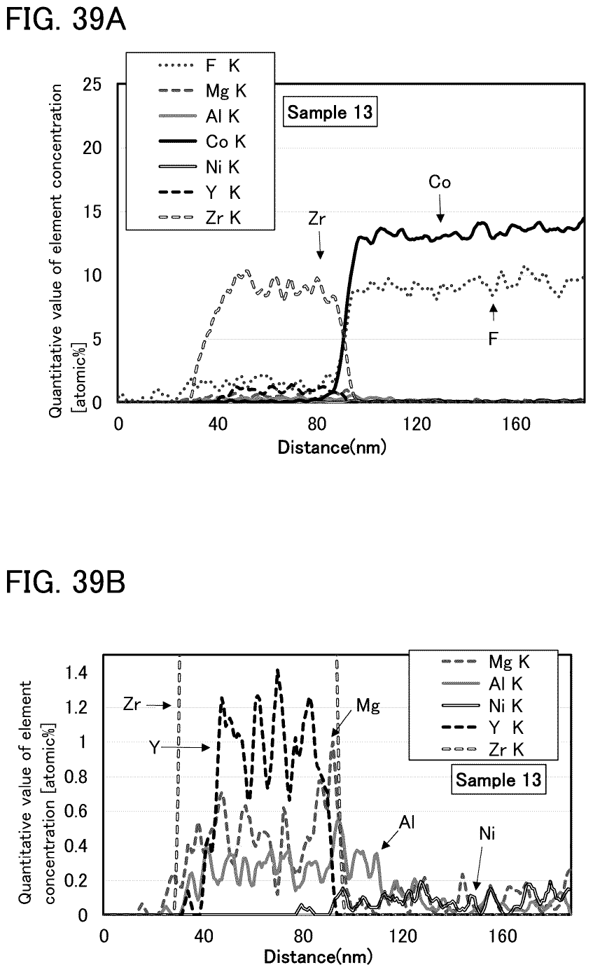

FIG. 38A is a cross-sectional STEM image of a positive electrode active material 1100 and a projection 1103 of Sample 13. A ZC image of the region denoted by the white broken line in FIG. 38A is shown in FIG. 38B. The linear EDX analysis results of the portion denoted by the white arrow in FIG. 38C is shown in FIG. 39A. In FIG. 39B, Mg, Al, Ni, Y, and Zr are extracted and a region with 1.5 atom % or less is enlarged. Each horizontal axis represents a distance (Distance).

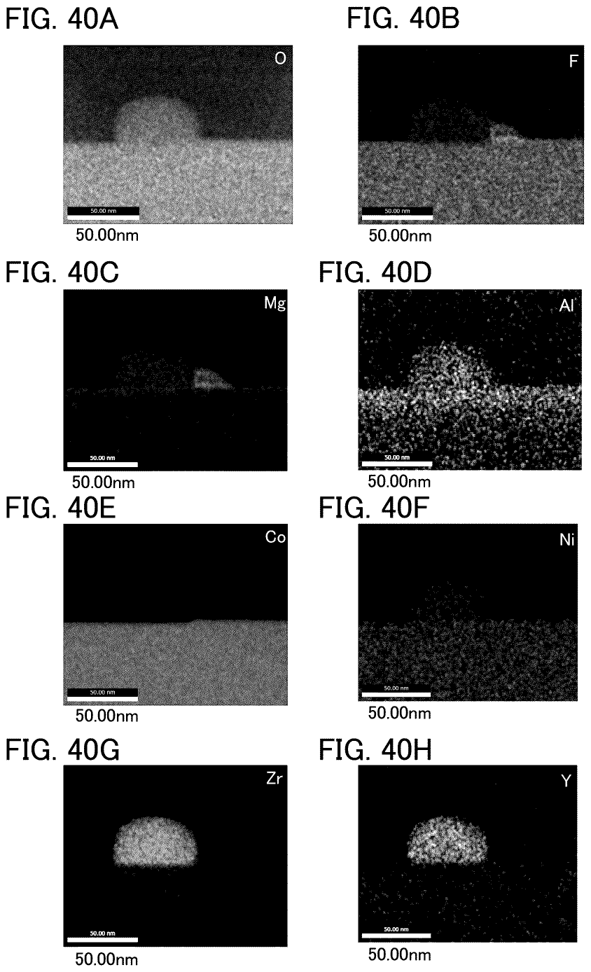

FIG. 40A to FIG. 40H are EDX mapping images of the positive electrode active material 1100 and the projection 1103 of the region that is the same as that in FIG. 38B. FIG. 40A, FIG. 40B, FIG. 40C, FIG. 40D, FIG. 40E, FIG. 40F, FIG. 40G, and FIG. 40H are mapping images of oxygen, fluorine, magnesium, aluminum, cobalt, nickel, zirconium, and yttrium, respectively.

In Sample 11 to Sample 13, oxygen was present in both the positive electrode active material 1100 and the projection 1103.

Fluorine was present in the positive electrode active material 1100 and was not much detected from the projection 1103. However, peaks of fluorine and cobalt are close to each other in EDX and therefore there is a possibility that the accuracy of information as to the presence and distribution of fluorine and the like is low.

Magnesium was present in both the positive electrode active material 1100 and the projection 1103. The concentration in the surface portion was higher than that in the inner portion in the positive electrode active material 1100.

Aluminum was present in both the positive electrode active material 1100 and the projection 1103. The concentration in the surface portion was higher than that in the inner portion in the positive electrode active material 1100.

Cobalt was present in the positive electrode active material 1100 and was not much detected from the projection 1103.

Nickel was present in both the positive electrode active material 1100 and the projection 1103. Note that the concentration in the projection 1103 was lower than the concentration in the positive electrode active material 1100.

Zirconium was present in the projection and not detected from the positive electrode active material 1100.

Yttrium was present in the projection and little detected from the positive electrode active material 1100.

The above results revealed that the projection 1103 was a composite oxide containing zirconium and yttrium.

### <Electron Diffraction>

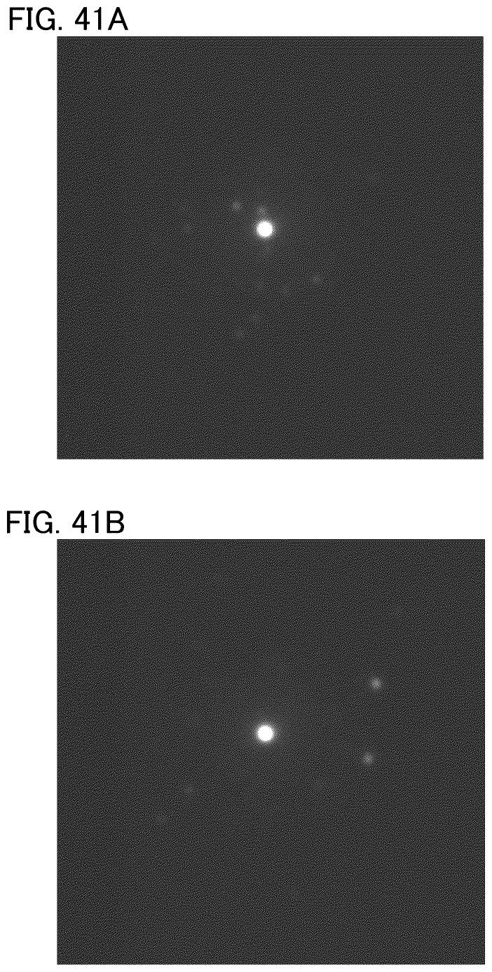

Next, electron diffraction patterns of Sample 11 to Sample 13 were obtained. FIG. 41A shows the electron diffraction pattern of the projection 1103 in Sample 11, and FIG. 41B shows the electron diffraction pattern of the positive electrode active material 1100 in Sample 11.

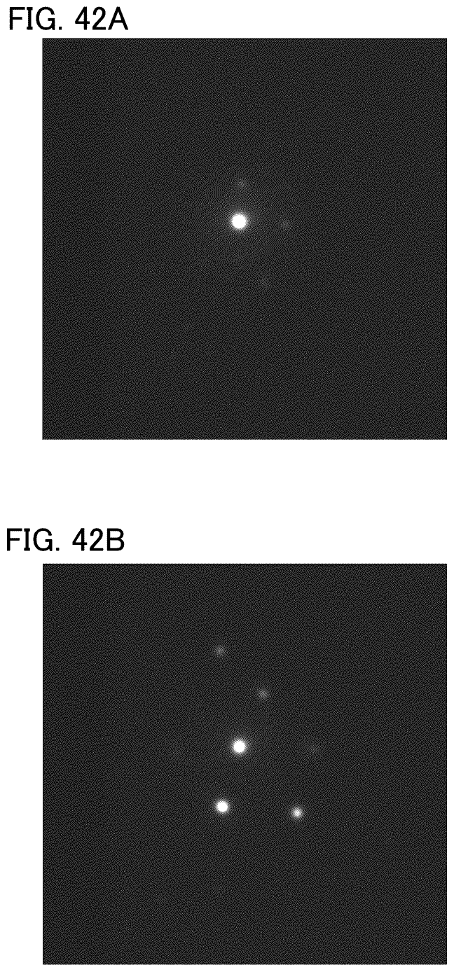

FIG. 42A shows the electron diffraction pattern of the projection 1103 in Sample 12, and FIG. 42B shows the electron diffraction pattern of the positive electrode active material 1100 in Sample 12.

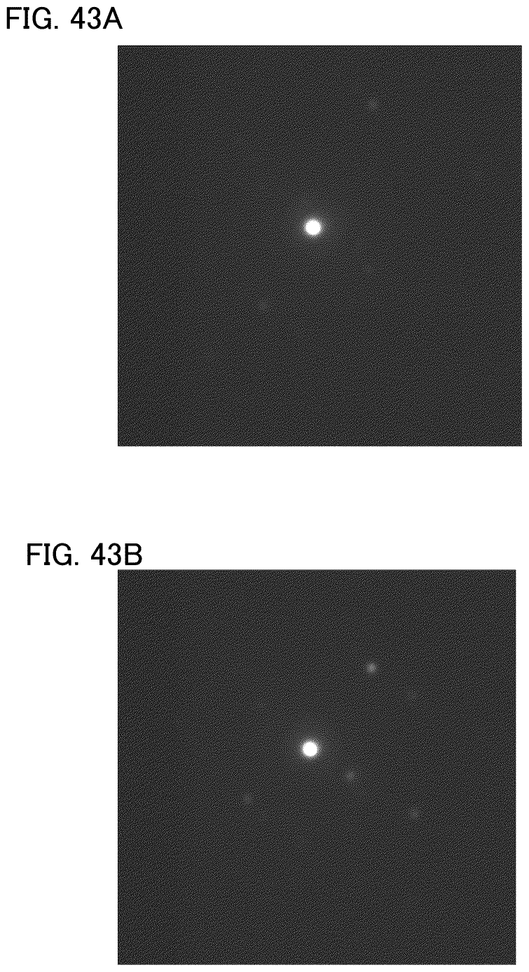

FIG. 43A shows the electron diffraction pattern of the projection 1103 in Sample 12, and FIG. 43B shows the electron diffraction pattern of the positive electrode active material 1100 in

### Sample 12.

It was confirmed that the projection 1103 and the positive electrode active material 1100 in Sample 11 to Sample 13 had crystallinity.

### <Charge and Discharge Cycle Performance>

Secondary batteries were formed using the positive electrode active materials of Sample 10 to Sample 13 formed as described above, and the charge and discharge cycle performance was evaluated.

First, the positive electrode active material, AB, and PVDF were weighed so that the active material: AB:PVDF=95:3:2 (weight ratio). Then, PVDF and AB were mixed. Next, addition of the positive electrode active material and further mixing were followed by addition of PVDF, mixing, and addition of NMP, whereby a slurry was formed. A current collector of aluminum was coated with the slurry.

After the slurry was applied onto the current collector, a solvent was volatilized. After that, pressure was applied at 210 kN/m, and then pressure was applied at 1467 kN/m. Through the above process, the positive electrode was obtained. The loading amount of the positive electrode was approximately 7 mg/cm². The density was 3.8 g/cc or higher.

Using the formed positive electrodes, CR2032 type coin-type battery cells (a diameter of 20 mm, a height of 3.2 mm) were fabricated.

A lithium metal was used for a counter electrode.

As an electrolyte contained in an electrolyte solution, 1 mol/L lithium hexafluorophosphate (LiPF₆) can be used. As the electrolyte solution, a solution in which ethylene carbonate (EC) and diethyl carbonate (DEC) at EC:DEC=3:7 (volume ratio) and vinylene carbonate (VC) at 2 wt % are mixed can be used.

As a separator, 25-μm-thick polypropylene was used.

A positive electrode can and a negative electrode can that were formed using stainless steel (SUS) were used.

In the evaluation of cycle performance, the charge voltage was 4.65 V or 4.70 V. The temperature of measurement environment was set to 25° C. CC/CV charging (0.5 C, each voltage, 0.05 C cut) and CC discharging (0.5 C, 2.5 V cut) were performed, and a 10-minute break was taken before each of the charge and discharge. Note that 1 C was 200 mA/g in this example and the like.

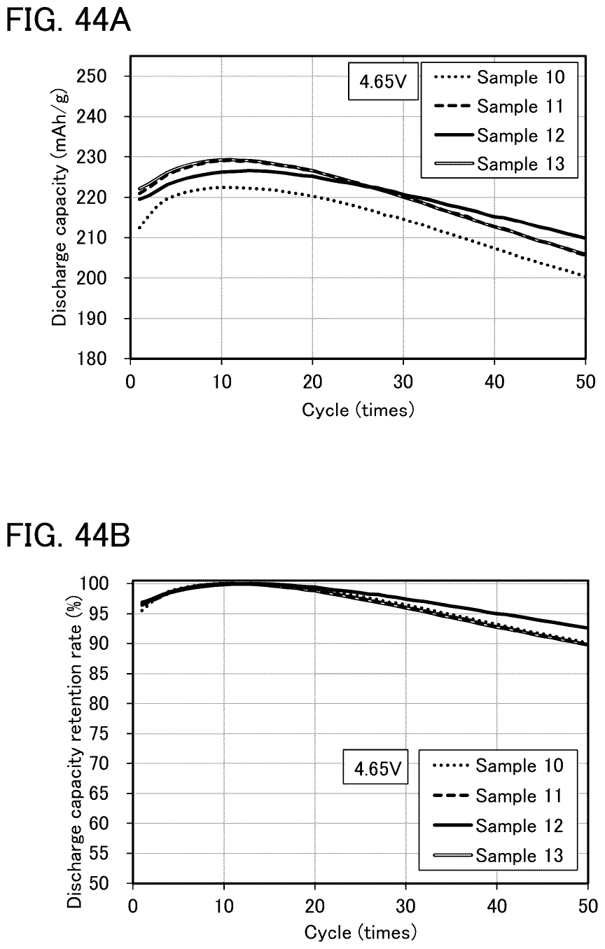

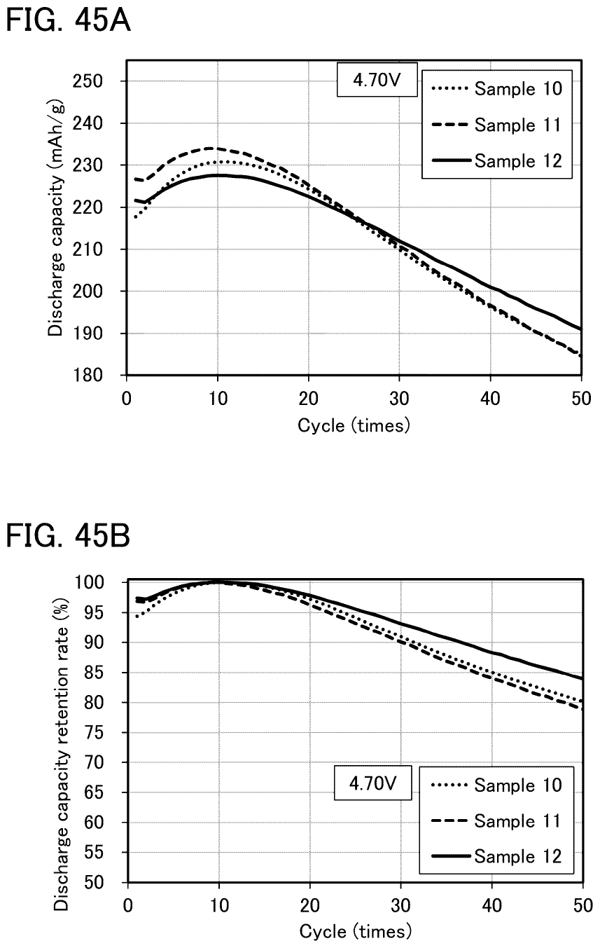

FIG. 44A and FIG. 44B show charge and discharge cycle performance of the secondary batteries using Sample 10 to Sample 13 at a charge voltage of 4.65 V. FIG. 45A and FIG. 45B show charge and discharge cycle performance of the secondary batteries using Sample 10 to Sample 12 at a charge voltage of 4.70 V. The discharge capacity is shown by the graphs in (A) and the discharge capacity retention rate is shown by the graphs in (B).

The samples each exhibited favorable charge and discharge cycle performance. At a charge voltage of 4.65 V, the graphs of Sample 11 and Sample 13 almost overlap with each other. In particular, Sample 12 with a zirconium/yttrium ratio in the range of Y/(Zr+Y)×100=x (3.9≤x<14.5) exhibits extremely favorable charge and discharge cycle performance at a charge voltage of each of 4.65 V and 4.70 V.

As can be clearly seen from above, when the surface of the positive electrode active material includes the projection containing zirconium and yttrium, the charge and discharge cycle performance is improved. It is found that the performance is especially improved when the zirconium/yttrium ratio is in the range where Y/(Zr+Y)×100=x (3.9≤x<14.5).

### REFERENCE NUMERALS

100: positive electrode active material, 100a: surface portion, 100b: inner portion, 101: crystal grain boundary, 102: crack, 103: projection, 103a: projection, 1100: positive electrode active material, 1103: projection

What is claimed is:

1. A method of manufacturing a positive electrode active material, comprising:
forming a first composite oxide by mixing a lithium source and a cobalt source and performing first heating;
forming a second composite oxide by mixing the first composite oxide, a magnesium source, and a fluorine source and performing second heating;
forming a third composite oxide by mixing the second composite oxide, a nickel source, and an aluminum source and performing third heating; and
forming a positive electrode active material by mixing the third composite oxide, a zirconium source, and an yttrium source with use of alcohol as a solvent, and performing fourth heating,
wherein each of the second heating, the third heating, and the fourth heating is performed at a heating temperature higher than or equal to 720° C. and lower than or equal to 950° C. for longer than or equal to 2 hours and shorter than or equal to 10 hours.

2. The method of manufacturing a positive electrode active material, according to claim 1,
wherein each of the zirconium source and the yttrium source is an alkoxide.

3. A method of manufacturing a positive electrode active material, comprising:
forming a first composite oxide by mixing lithium cobalt oxide, a magnesium source, and a fluorine source and performing first heating;
forming a second composite oxide by mixing the first composite oxide, a nickel source, and an aluminum source and performing second heating; and
forming a positive electrode active material by mixing the second composite oxide, a zirconium source, and an yttrium source with use of alcohol as a solvent, and performing third heating,
wherein the third heating is performed at a heating temperature higher than or equal to 720° C. and lower than or equal to 950° C.
